(19) United States
(12) Patent Application Publication
(10) Pub. No.: US 2023/0297089 A1
(43) Pub. Date: Sep. 21, 2023

(54) RESOURCE-TASK NETWORK (RTN)-BASED TEMPLATED PRODUCTION SCHEDULE OPTIMIZATION (PSO) FRAMEWORK

(71) Applicant: C3.ai, Inc., Redwood City, CA (US)

(72) Inventors: Zhaoyang Jin, San Mateo, CA (US); Robert S. Young, San Francisco, CA (US); Gabriele Boncoraglio, Redwood City, CA (US); Yimin Liu, Redwood City, CA (US); Bhavya Kaushik, Redwood City, CA (US); Akshay Punhani, San Francisco, CA (US); Alex Amato, San Francisco, CA (US); Pauline M. Brunet, San Francisco, CA (US); Zhaoxi Zhang, Palo Alto, CA (US)

(21) Appl. No.: 18/162,587

(22) Filed: Jan. 31, 2023

Related U.S. Application Data
(60) Provisional application No. 63/306,970, filed on Feb. 4, 2022.

(51) Int. Cl. G05B 19/418

(52) U.S. Cl. CPC G05B 19/41865; G05B 19/41885; G05B 2219/23448

(57) ABSTRACT

A method includes using templates to identify constraints and terms of at least one objective function associated with at least a portion of one or more processing targets At least one of the templates is based on a resource-task network (RTN) representation of resource nodes and task nodes associated with at least the portion of the one or more processing targets. The method also includes generating one or more optimization problems, where the constraints and the at least one objective function represent at least part of the one or more optimization problems. The method further includes generating at least one candidate production schedule for at least the portion of the one or more processing targets using the one or more optimization problems.

### CROSS-REFERENCE TO RELATED APPLICATION AND PRIORITY CLAIM

This application claims priority under 35 U.S.C. § 119(e) to U.S. Provisional Pat. Application No. 63/306,970 filed on Feb. 4, 2022. This provisional application is hereby incorporated by reference in its entirety.

### TECHNICAL FIELD

This disclosure is generally directed to production scheduling systems. More specifically, this disclosure is directed to a resource-task network (RTN)-based templated production schedule optimization (PSO) framework.

### BACKGROUND

Production scheduling generally refers to the process of determining how processing units in a processing or manufacturing plant will be used to produce one or more materials or other products. The processing units typically represent equipment that can be used to perform specific processing functions on one or more materials. For example, production scheduling may involve determining how equipment in a chemical manufacturing plant will be used to produce chemical products or how equipment in a food processing factory will be used to produce food products. Production scheduling for a plant or a portion thereof typically involves dictating the production schedule (such as by defining one or more products to be produced, quantities of the one or more products to be produced, and timing of the one or more products to be produced) for the processing units contained in the plant or the portion thereof over a forward-looking scheduling horizon.

### SUMMARY

This disclosure relates to a resource-task network (RTN)-based templated production schedule optimization (PSO) framework.

In a first embodiment, a method includes using templates to identify constraints and terms of at least one objective function associated with at least a portion of one or more processing targets. At least one of the templates is based on an RTN representation of resource nodes and task nodes associated with at least the portion of the one or more processing targets. The method also includes generating one or more optimization problems, where the constraints and the at least one objective function represent at least part of the one or more optimization problems. The method further includes generating at least one candidate production schedule for at least the portion of the one or more processing targets using the one or more optimization problems.

In a second embodiment, an apparatus includes at least one processing device configured to use templates to identify constraints and terms of at least one objective function associated with at least a portion of one or more processing targets. At least one of the templates is based on an RTN representation of resource nodes and task nodes associated with at least the portion of the one or more processing targets. The at least one processing device is also configured to generate one or more optimization problems, where the constraints and the at least one objective function represent at least part of the one or more optimization problems. The at least one processing device is further configured to generate at least one candidate production schedule for at least the portion of the one or more processing targets using the one or more optimization problems.

In a third embodiment, a non-transitory computer readable medium stores computer readable program code that, when executed by one or more processors, causes the one or more processors to use templates to identify constraints and terms of at least one objective function associated with at least a portion of one or more processing targets. At least one of the templates is based on an RTN representation of resource nodes and task nodes associated with at least the portion of the one or more processing targets. The non-transitory computer readable medium also stores computer readable program code that, when executed by the one or more processors, causes the one or more processors to generate one or more optimization problems, where the constraints and the at least one objective function represent at least part of the one or more optimization problems. The non-transitory computer readable medium further stores computer readable program code that, when executed by the one or more processors, causes the one or more processors to generate at least one candidate production schedule for at least the portion of the one or more processing targets using the one or more optimization problems.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting a resource-task network (RTN)-based templated production schedule optimization (PSO) framework according to this disclosure;

FIG. 2 illustrates an example device supporting an RTN-based templated PSO framework according to this disclosure;

FIGS. 3A through 3D illustrate an example production graph, an example resource-task network associated with one or more processing or manufacturing plants, and associated details according to this disclosure;

FIGS. 4A and 4B illustrate example arrangement of constraint and objective term templates that may be embodied in multiple domains according to this disclosure;

FIG. 5 illustrates an example material balance constraint with a discrete-time formulation in a specified domain according to this disclosure;

FIG. 6 illustrates an example visualization of an expiration rule according to this disclosure;

FIG. 7 illustrates an example expiration constraint with a discrete-time formulation in a specified domain according to this disclosure;

FIG. 8 illustrates an example dependency graph according to this disclosure;

FIG. 9 illustrates a specific example of a low-level component dependency graph according to this disclosure;

FIG. 10 illustrates an example network decomposition for a single facility according to this disclosure;

FIG. 11 illustrates example sub-problems derived by time-based decomposition with different resolution requirements according to this disclosure;

FIG. 12 illustrates an example arrangement of interconnected facilities according to this disclosure;

FIGS. 13A through 13D illustrate an example two-stage process for performing production scheduling optimization and related details according to this disclosure;

FIGS. 14A and 14B illustrate examples of various statuses defined for materials to support transportation considerations in the RTN-based templated PSO framework according to this disclosure;

FIG. 15 illustrates an example setup showing how additional transportation tasks can be added and connected to “dummy” materials during production schedule optimization according to this disclosure;

FIG. 16 illustrates an example setup showing how additional transportation tasks can be added and connected to “dummy” materials during production schedule optimization when considering stock transportation between production facilities according to this disclosure;

FIGS. 17A through 17D illustrate an example application of an RTN-based templated PSO framework according to this disclosure;

FIG. 18 illustrates an example architecture of an RTN-based templated PSO framework according to this disclosure;

FIG. 19 illustrates an example overview of a usage of an RTN-based templated PSO framework according to this disclosure;

FIGS. 20 through 24 illustrate example graphical user interfaces associated with an RTN-based templated PSO framework according to this disclosure; and

FIG. 25 illustrates an example method for production schedule optimization using an RTN-based templated PSO framework according to this disclosure.

### DETAILED DESCRIPTION

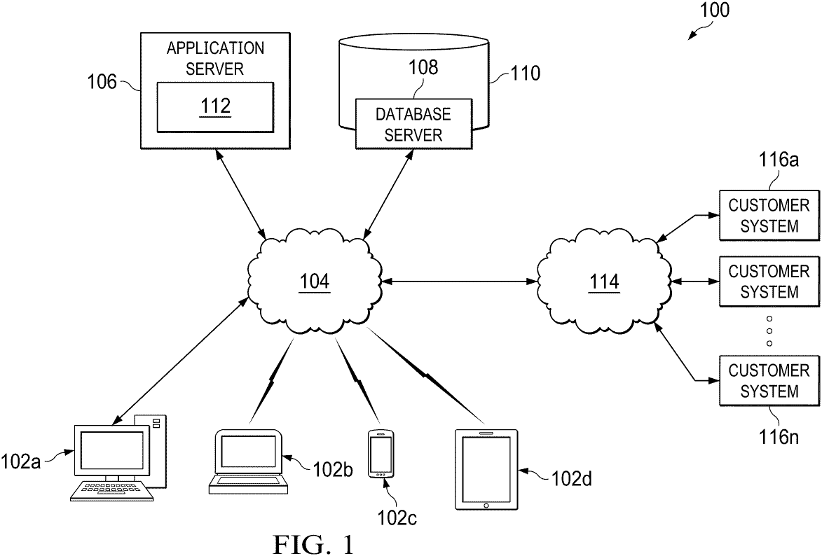

FIGS. 1 through 25, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, production scheduling generally refers to the process of determining how processing units in a processing or manufacturing plant will be used to produce one or more materials or other products. The processing units typically represent equipment that can be used to perform specific processing functions on one or more materials. For example, production scheduling may involve determining how equipment in a chemical manufacturing plant will be used to produce chemical products or how equipment in a food processing factory will be used to produce food products. Production scheduling for a plant or a portion thereof typically involves dictating the production schedule (such as by defining one or more products to be produced, quantities of the one or more products to be produced, and timing of the one or more products to be produced) for the processing units contained in the plant or the portion thereof over a forward-looking scheduling horizon.

Unfortunately, production schedule optimization (PSO) typically involves a custom formulation for each new industrial use case. For example, prior PSO approaches typically use detailed optimization formulations and algorithms for specific facilities or use cases, such as specific chemical plants or specific food processing factories. As a result, these approaches tend to focus only on a specific industry, and these approaches are relatively rigid and lack extensibility and adaptability to new use cases. Moreover, this can make it labor-intensive, time-consuming, and costly to implement production schedule optimization for a new use case, which can delay or prevent the use of production schedule optimization for the new use case.

This disclosure provides an apparatus, method, and computer readable medium supporting a resource-task network (RTN)-based templated PSO framework. As described in more detail below, a templated PSO framework that supports the use of a resource-task network is disclosed. The RTN-based templated PSO framework can be used to formulate a production schedule optimization problem based on a resource-task network, which can be industry- or use case-agnostic. As a result, the RTN-based templated PSO framework can be abstracted and can support a “plug-and-play” type of functionality, which allows the RTN-based templated PSO framework to be used for production schedule optimization across a wide range of industries. In other words, the RTN-based templated PSO framework is not limited to a specific optimization procedure or use case. Also, the RTN-based templated PSO framework can provide plug-and-play templates of constraints, variables, and objective functions, and the RTN-based templated PSO framework can be configured to optimize the framework for large-scale problems (such as those involving multiple interconnected facilities) using techniques like model decomposition and simplification that preserve accuracy. Because of this, the RTN-based templated PSO framework can ease the process of providing accurate results across various organizations, including complex organizations such as those with interconnected networks of facilities. Further, the RTN-based templated PSO framework is not limited to any specific optimization procedure (such as multiple-stage, two-stage, or single-stage approaches), thereby supporting use in a wide range of applications. In addition, the RTN-based templated PSO framework can integrate with state-of-the-art custom or standard optimization solvers.

Overall, these approaches allow different RTN-based templated PSO frameworks to be customized for use with different industries or use cases much faster compared to prior approaches. Moreover, the RTN-based templated PSO framework handles the optimization of production scheduling in a generic way so that it is generally applicable to various settings under different business constraints across different industries. In addition, the RTN-based templated PSO framework allows users to formulate optimization problems to their business settings with minimal effort.

Example embodiments of an RTN-based templated PSO framework are described below. Note that the specific details provided below are for illustration only and can vary as needed or desired. For instance, specific equations and use cases are provided below, and these equations and use cases may be modified as needed or desired. As a particular example, while use in the food processing industry may be described below, the RTN-based templated PSO framework may be used in any other suitable application. Also note that while the RTN-based templated PSO framework may be described as being used for production scheduling involving processing units in a plant or across multiple plants, the RTN-based templated PSO framework may be used for production scheduling involving any suitable subset of processing units in one or more plants

### Example System and Device

FIG. 1 illustrates an example system 100 supporting an RTN-based templated PSO framework according to this disclosure For example, the system 100 shown here can be used to support production schedule optimization using the RTN-based templated PSO framework described below. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100 For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 may represent an internal or private network used by an owner or operator of one or more processing or manufacturing plants

The application server 106 is coupled to the network 104 and is coupled to or otherwise communicates with the database server 108. The application server 106 supports the use of the RTN-based templated PSO framework described below. For example, the application server 106 may execute one or more applications 112 that use data from the database 110 to perform production schedule optimization using the RTN-based templated PSO framework. Note that the database server 108 may also be used within the application server 106 to store information, in which case the application server 106 may store the information itself used to perform production schedule optimization.

The database server 108 operates to store and facilitate retrieval of various information used, generated, or collected by the application server 106 and the user devices 102a-102d in the database 110. For example, the database server 108 may store various information related to customer product orders and other information used during production schedule optimization. The database server 108 may also store results produced during the production schedule optimization.

In this example, at least some of the information used by the application server 106 and/or stored in the database 110 may be received over at least one additional network 114 from one or more customer systems 116a-116n. For example, the network 114 may represent a public data network (such as the Internet) or other network that allows the one or more customer systems 116a-116n to provide information to and receive information from the owner or operator of one or more processing or manufacturing plants. As a particular example, the one or more customer systems 116a-116n may be used by customers to provide order information or other information to the owner or operator of the processing or manufacturing plant(s), where that information can be used by the application server 106 to perform production schedule optimization.

A determined production schedule produced by the application server 106 may be used in any suitable manner. For example, the determined production schedule may be presented to one or more users, such as via one or more of the user devices 102a-102d The one or more users may review the determined production schedule, make changes to the determined production schedule, or perform other actions using the determined production schedule. The determined production schedule may also or alternatively be used by the application server 106 or other device to automatically schedule operations to be performed to produce one or more products or control operations being performed to produce one or more products. In general, one or more production schedules may be used in any suitable manner with or without user interaction.

Although FIG. 1 illustrates one example of a system 100 supporting an RTN-based templated PSO framework, various changes may be made to FIG. 1. For example, the system 100 may include any suitable number of user devices 102a-102d, networks 104, 114, application servers 106, database servers 108, databases 110, and customer systems 116a-116n. Also, these components may be located in any suitable location(s) and might be distributed over a large area. In addition, while FIG. 1 illustrates one example operational environment in which an RTN-based templated PSO framework may be used, this functionality may be used in any other suitable system.

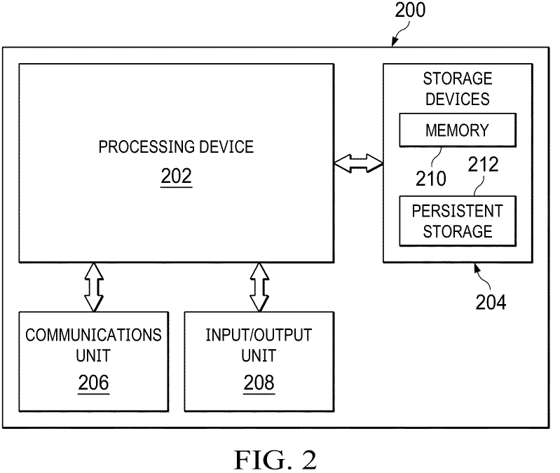

FIG. 2 illustrates an example device 200 supporting an RTN-based templated PSO framework according to this disclosure One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, or customer system 116a-116n in FIG. 1 However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), ASICs, field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104 or 114. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting an RTN-based templated PSO framework, various changes may be made to FIG. 2. For example, computing and communication devices and systems come in a wide variety of configurations, and FIG. 2 does not limit this disclosure to any particular computing or communication device or system.

### Example Production Graph and Resource-Task Network

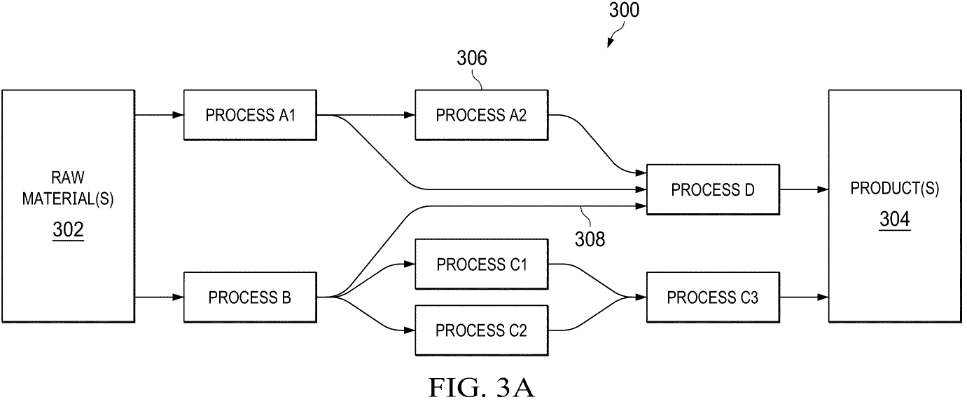

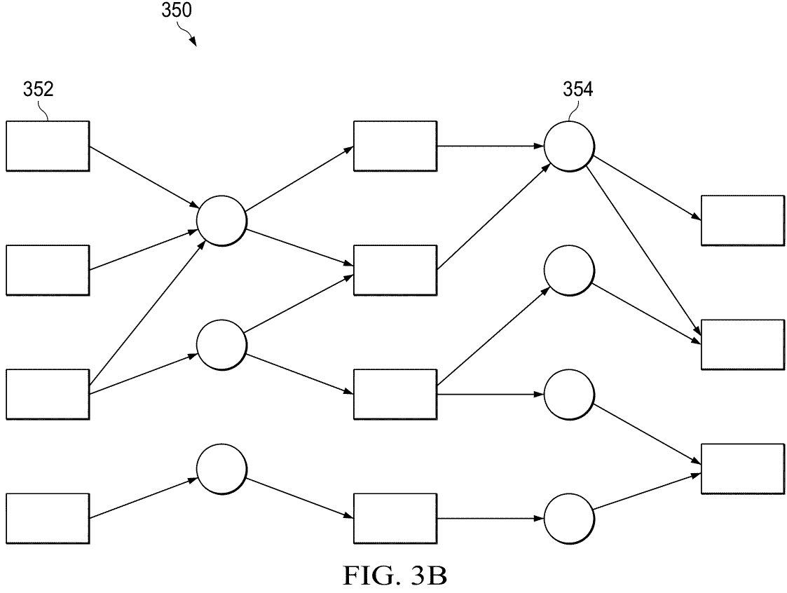

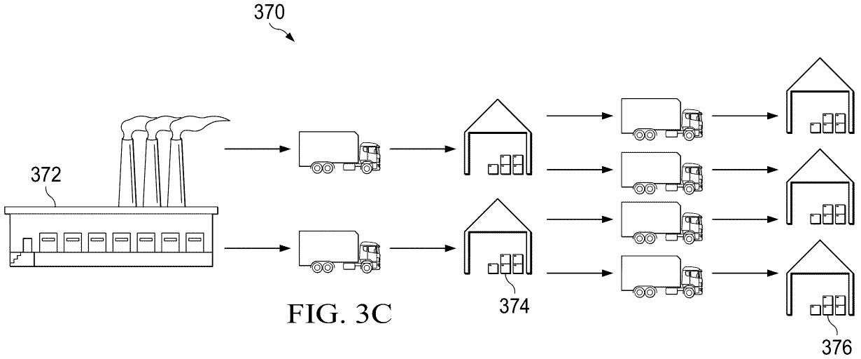

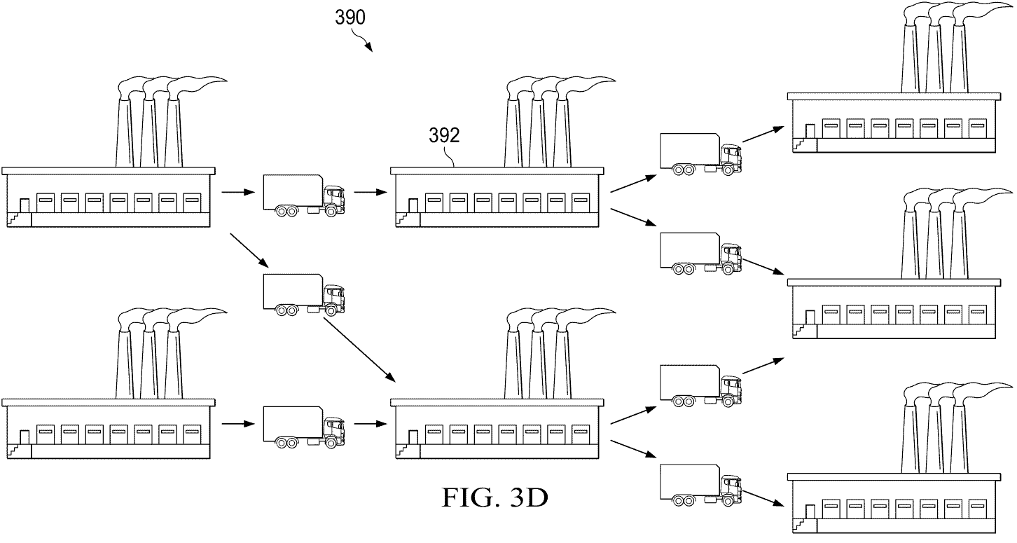

FIGS. 3A through 3D illustrate an example production graph 300, an example resource-task network 350 associated with one or more processing or manufacturing plants, and associated details according to this disclosure. For example, the production graph 300 and resource-task network 350 may be associated with one or more processing or manufacturing plants (or one or more portions thereof) for which the RTN-based templated PSO framework is used to perform production schedule optimization. However, production schedule optimization may be performed for any other suitable processing or manufacturing plants or portions thereof that perform any other suitable processing or manufacturing operations.

As shown in FIG. 3A, the production graph 300 is associated with an intake of one or more raw materials 302 and an output of one or more products 304. The one or more raw materials 302 represent any suitable material or materials that are processed or otherwise used by one or more processing or manufacturing plants (or one or more portions thereof) to produce the one or more products 304 The one or more products 304 represent any suitable material(s) or other product(s) that are provided by the one or more processing or manufacturing plants (or one or more portions thereof). The one or more products 304 may represent one or more finished products (such as those that are provided for delivery to retailers or other parties for sale or delivery to customers), one or more intermediate products (such as those that are further processed prior to or during creation of finished products), or any other suitable products.

Within the one or more processing or manufacturing plants (or one or more portions thereof), various processing units 306 can be used to process the one or more raw materials 302 or the one or more intermediate products. Each processing unit 306 represents equipment or other assets that can be used to manufacture or process one or more materials in order to perform one or more tasks In some cases, one or more processing units 306 may be used to represent one or more tasks performed by human personnel, such as when one or more employees or other people perform one or more tasks manually (which may or may not involve the use of monitored or other equipment). The task or tasks performed by each processing unit 306 can vary depending on the application. Flows of various intermediate or work-in-progress (WIP) materials 308 are also shown in FIG. 3. The WIP materials 308 represent one or more materials that have been partially but not fully manufactured or processed, which means that the WIP materials 308 are awaiting processing by one or more processing units 306 prior to being completed. Here, the WIP materials 308 can represent one or more intermediate products that may still need to be processed using one or more processing units 306 in order to form one or more products 304.

Scheduling problems are often solved by transforming the scheduling problems into optimization formulations. For example, a resource-task network (RTN) proposed in Pantelides, “Unified Frameworks for Optimal Process Planning and Scheduling,” Proceedings of the Second International Conference on Foundations of Computer-Aided Process Operations, July 18-23, 1993, pages 253-274 (which is hereby incorporated by reference in its entirety) represents a general scheduling problem in multi-purpose facilities using a connected graph with resource nodes and task nodes. The resource-task network 350 shown in FIG. 3B is an example RTN-based representation of a processing or manufacturing plant (or a portion thereof). As shown in FIG. 3B, the resource-task network 350 includes a number of resource nodes 352 (represented by rectangles) and task nodes 354 (represented by circles). In this type of network representation, materials (such as the raw materials 302 and WIP materials 308), statuses, utilities, etc. are viewed as resource nodes 352 that are consumed or produced by the task nodes 354. The task nodes 354 represent tasks that can be performed on the materials using processing units (such as the processing units 306).

Resource-task networks can be defined for any suitable arrangement of resources and tasks associated with a single facility or multiple facilities. Also, the resource-task networks may or may not include tasks related to transportation between facilities. For example, in some embodiments, a resource-task network may be defined for an arrangement 370 as shown in FIG. 3C, where a single production facility 372 has transportation lanes to one or more layers of distribution centers 374, 376. As described below, the framework can be used to optimize production by the production facility 372 and to facilitate transport of the products to the distribution centers 374, 376 via the transportation lanes. If there are multiple production facilities 372, each production facility 372 may be optimized independently. In other embodiments, a resource-task network may be defined for an arrangement 390 as shown in FIG. 3D, where a collection of various production facilities 392 can be used to perform various processing tasks. As described below, the framework can be used to optimize production by the collection of production facilities 392 and to facilitate transport of the products to/from/between the production facilities 392 via the transportation lanes, which might occur by solving an optimization problem for all facilities 392 or by solving and reconciling different optimization problems for different facilities 392.

Although FIGS. 3A through 3D illustrate one example of a production graph 300, one example of a resource-task network 350 associated with one or more processing or manufacturing plants, and associated details, various changes may be made to FIGS. 3A through 3D. For example, the number of processing units 306 and the flows of materials to, from, and between the processing units 306 can easily vary depending on the specific processing or manufacturing plant(s) being modeled. Also, the resource-task network 350 may identify any suitable number of materials and any suitable number of tasks that can be performed by any suitable number of processing units 306. Further, the production graph 300 and the resource-task network 350 may be used to represent or relate to one or more independent production lines, one or more interconnected production networks, or any other suitable processing or manufacturing plant(s). In addition, the example arrangements shown in FIGS. 3C and 3D are for illustration only. The actual facility or facilities and any transportation lanes associated with the facility or facilities can easily vary depending on the use case.

As noted above with respect to FIG. 3B, the resource-task network 350 can be used to represent resource nodes 352 and task nodes 354 associated with one or more processing or manufacturing plants (or one or more portions thereof). This uniform description of resources and tasks eases the transformation of a scheduling problem into a typical optimization formulation, which includes objective functions, constraints, and variables. Individual formulations have been developed based on resource-task networks across a variety of domains, such as the chemical industry, pharmaceutical industry, oil refineries, pipeline systems, food industries, dairy industry, consumer good industry, manufacturing industry, steel industry, paper industry, etc. However, those formulations are specific within each of these domains, and the rules, goals, constraints, and objectives developed for a specific domain cannot be transferred to a similar problem in another domain without significant reformulation efforts. This makes it difficult or impossible to expand existing optimization procedures and solution techniques to different users across domains. Among other things, one example goal of the RTN-based templated PSO framework provided in this disclosure is to create templates for basic physical or business rules and goals that are agnostic across multiple industries so that less or little effort is needed to materialize those rules and goals into specific constraints and objective terms in the context of each domain.

### Example Template Creation

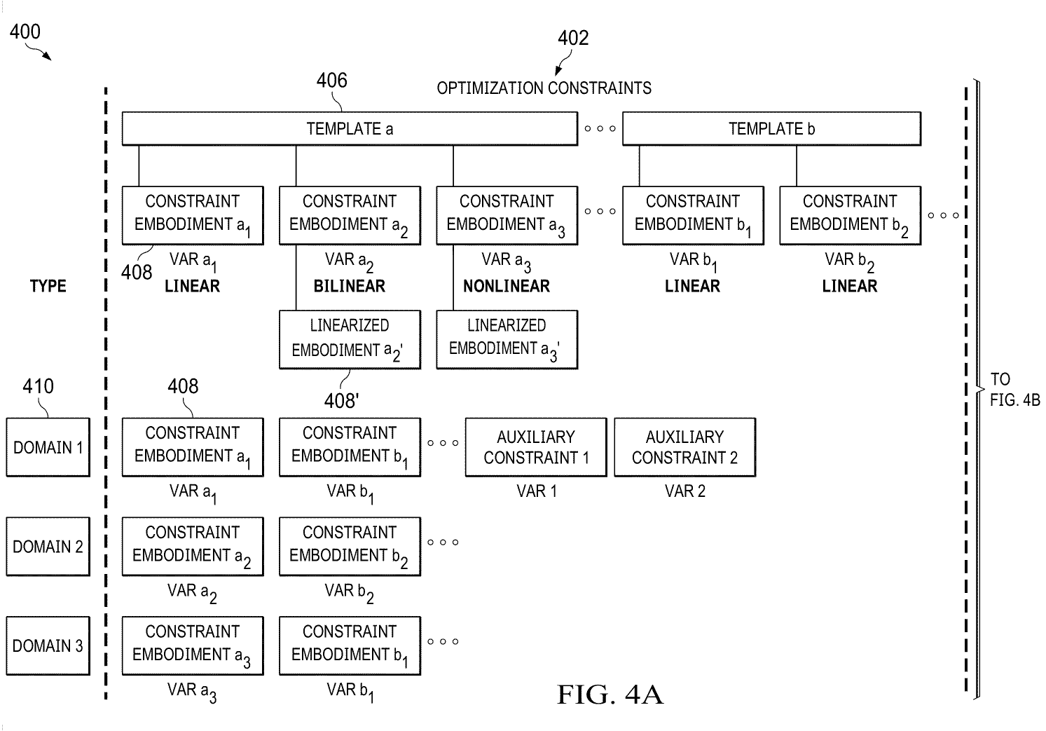

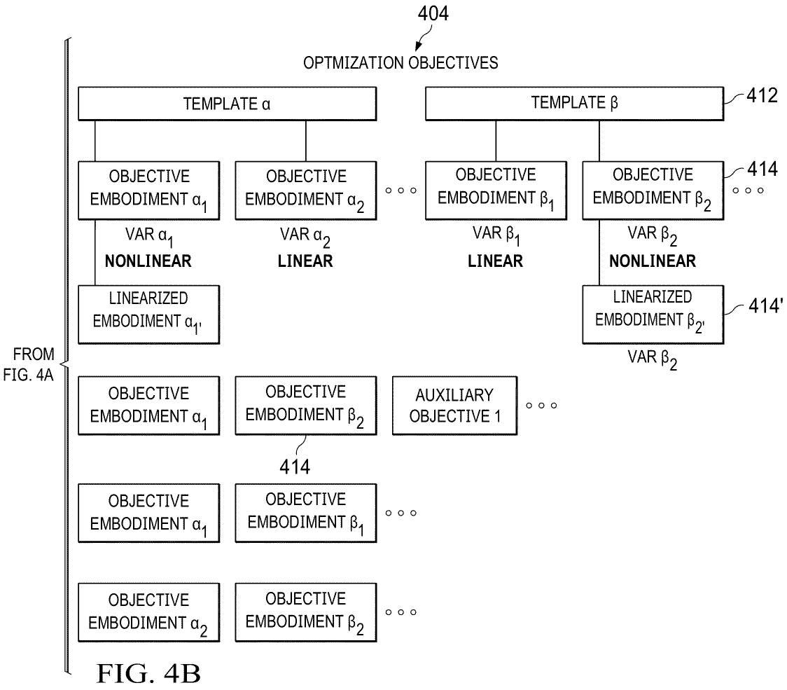

FIGS. 4A and 4B illustrate example arrangement 392 of constraint and objective term templates that may be embodied in multiple domains according to this disclosure. As shown in FIGS. 4A and 4B, the arrangement 392 is generally divided into an optimization constraints section 402 and an optimization objectives (also known as terms) section 404. As can be seen here, the optimization constraints section 402 allows constraints to be expressed using one or more constraint templates 406, which can be created based on agnostic physical or business rules observed and can be linked to specific components (such as all nodes, a subset of nodes, a specific category of nodes, or a set of edges) in a resource-task network. In some cases, constraint templates 406 may relate to or include (but are not limited to) material balances, energy balances, other resource rules (such as utility balances, manpower balances, expiration rules, etc.), status balances, and time balances.

Each constraint template 406 may be expressed in any of a variety of formats, such as discrete-time, continuous-time, two-phase, one-phase, soft or hard, etc. Hard constraints represent constraints that cannot be violated, while soft constraints represent constraints that may be violated (but the extent of the violation is treated as a cost in an objective function). Each constraint template 406 can be used to create various embodiments 408 of that constraint template 406. Different embodiments 408 of the same constraint template 406 may implement the same underlying constraint and can be interchanged based on implementation needs, such as when different embodiments 408 of a constraint template 406 are associated with different domains 410. The domains 410 may represent different use cases or applications, such as when the domains 410 are associated with chemical, pharmaceutical, oil, pipeline, food, dairy, consumer good, manufacturing, steel, paper, and/or other industries. Note that when physical or business rules are embodied into specific constraints (via the embodiments 408 of the constraint templates 406) for each domain 410, variables associated with those constraints can also be generated dynamically. Moreover, the embodiments 408 of the constraint templates 406 can be compatible with additional auxiliary constraints in each domain 410. This indicates that not all constraints in a final formulation need to come from constraint templates 406, and users can have the flexibility to choose which of the constraints come from constraint templates 406 (more generality and less implementation effort) and which ones of the constraints are domain-specific (more flexibility and more implementation effort).

In this particular example, two constraint templates 406 are provided, which are referred to as template a and template b. Each constraint template 406 may be embodied into one or more constraint embodiments 408, which in this example include constraint embodiments a₁, a₂, a₃ and constraint embodiments b₁, b₂, b₃, respectively. Each constraint embodiment 408 has associated variables, which in this example are denoted as variable sets a₁, a₂, a₃ and variable sets b₁, b₂, b₃, respectively. Note that the same constraint template 406 could result in different types of constraint embodiments 408, such as linear, bilinear, quadratic, or integer constraint embodiments 408. For each nonlinear constraint embodiment 408 (such as bilinear, quadratic, or integer constraint embodiments 408), there could be an extended embodiment 408′ (which in this example are denoted as a₂′ and a₃′) that simplifies the original embodiment 408. The simplifications represented by the extended embodiments 408′ may be useful when discussing decomposition or simplification techniques that this disclosure enables.

For the terms in the objective function, a similar process can be applied. For example, the optimization objectives section 404 allows objective terms to be expressed using one or more objective templates 412. Any suitable objective templates 412 may be used here, such as objective templates related to revenue, cost, customer satisfaction, environmental footprint, etc. Note that each of these objective templates 412 need not simply be used to look up values for these objectives but may instead include one or more complex dynamic elements, instructions, or functions (such as an equation) that can be used for a domain or an optimization objective. Multiple terms can be generated using multiple objective templates 412 and appended to an objective function in order to handle multi-objective optimization problems. Each objective template 412 can be linked to a specific subset of components (such as nodes and edges) in a resource-task network, such as when revenue is linked to a subset of resource nodes that represent sellable products Embodiments 414 of the objective templates 412 define exact formulations that convert the objective templates 412 into objective terms. Variables associated with each term in the objective function can be generated at the same time. In the specific example shown in FIGS. 4A and 4B, two objective templates 412 (which are denoted a and β) are provided and can be used to respectively generate objective embodiments 408 (terms) of α₁, α₂ and β₁, β₂ with associated variable sets. One or more extended embodiments 414′ may be used to simplify one or more original embodiments 414.

For a specific domain 410, embodiments 408 and 414 of the constraints and terms in the objective function can be selected to generate a final formulation of an objective function for that specific domain 410. For example, in a first domain 410 (such as a food industry with a discrete-time formulation and a two-stage procedure), constraint embodiments a₁ and b₁ may be selected, along with two domain-specific constraints called “auxiliary constraint 1” and “auxiliary constraint 2” in this example. Also, objective term embodiments α₁ and β₂ may be included in the objective function, along with a domain-specific term called “auxiliary objective 1.” Finally, the variable sets associated with the constraints and objective terms can be reconciled (as described below) to ensure that each variable is constrained by a set of constraints and there are no conflicts between variables, which leads to the generation of a final set of variables. Note that the templates 406 and 412 for constraints and terms in the objective function described above are formulation- or procedure-agnostic, which means that their embodiments 408 and 414 can be applied across time-continuous formulations, time-discrete formulations, single-phase procedures, multiple-phase procedures, etc.

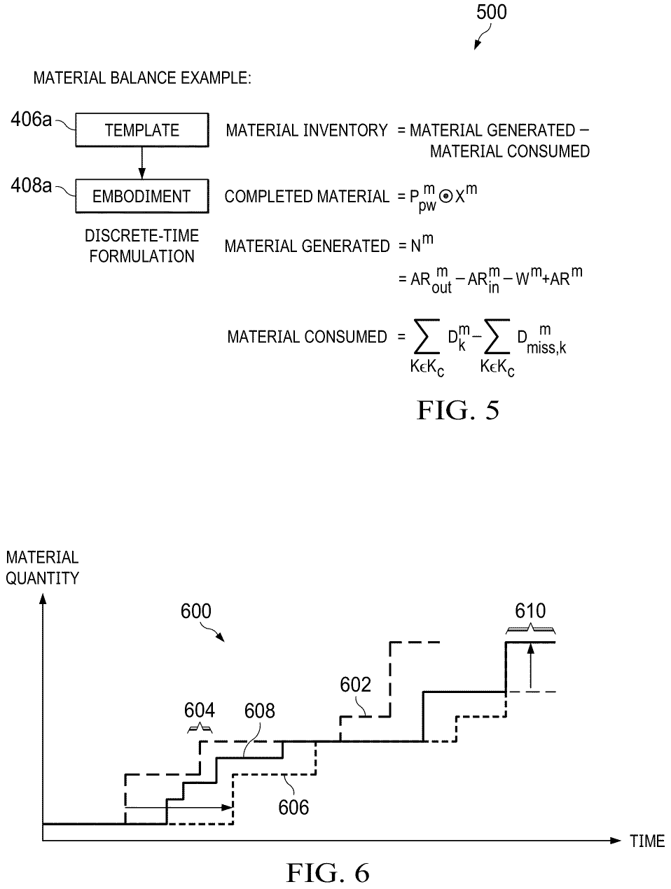

The following provides two examples of how physical or business rules may be used as templates and how those templates may be embodied into specific constraints. The first example is a material balance template, and the second example is an expiration template. FIG. 5 illustrates an example material balance constraint 500 with a discrete-time formulation in a specified domain according to this disclosure. More specifically, FIG. 5 demonstrates how an embodiment 408a of a material balance constraint in the domain 410 of a food industry with a discrete-time formulation may be generated. As shown in FIG. 5, a material balance template 406a may originate from a resource-task network and can be represented by a simple equation, such as “change in material inventory equals material generated minus material consumed” (for consumable resources) The template 406a only needs to define an equality constraint and a generic subtraction operation. A specific embodiment 408a of the template 406a can be generated for the specific application. Here, each term in the equation is embodied in the context of the food processing industry with a discrete-time formulation.

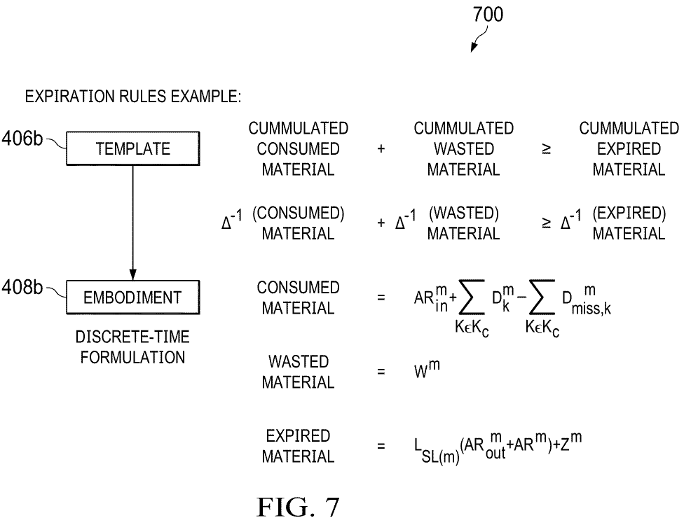

FIG. 6 illustrates an example visualization 600 of an expiration rule according to this disclosure, and FIG. 7 illustrates an example expiration constraint 700 with a discrete-time formulation in a specified domain according to this disclosure Before going through the process of creating an embodiment of an expiration rule from a template, the following first explains how an expiration rule can be represented graphically by a diagram FIG. 6 illustrates how an expiration rule guides a material balance of perishable goods. As shown in FIG. 6, a cumulative production line 602 shows the cumulative production of a particular material over time. Each vertical “cliff” 604 in the cumulative production line 602 indicates that there is production happening on that date A cumulative expiration line 606 represents the cumulative expiration of the material. Since it is assumed that the shelf life of the material is a constant number in this example (although this need not be the case), the cumulative expiration line 606 is a simple shift of the cumulative production line 602 towards the right. A cumulative consumption line 608 depicts the cumulative consumption of the material, which includes regular consumption (such as consumption used to produce one or more downstream materials or directly satisfy demand) as well as a free variable called “waste.” Ideally, cumulative consumption is always greater than cumulative expiration at any moment in time. If cumulative consumption falls below cumulative expiration (such as is shown to occur during a time period 610), this indicates that some of the material is at risk of expiring, which would lead to waste. Whenever the cumulative consumption falls below the cumulative expiration, an expiration mechanism can be applied to lift the cumulative consumption line to be as high as the cumulative expiration line, such as by increasing the value of the free variable “waste.” The quantity being lifted is the wasted quantity.

Based on this, an expiration rule can be represented by an inequality that keeps cumulative consumption always above cumulative expiration (ideally for all consumable resources in a resource-task network) FIG. 7 demonstrates how an embodiment 408b of an expiration constraint in the domain 410 of the food industry with the discrete-time formulation may be generated using a template 406b of the expiration constraint.

Note that in the examples shown in FIGS. 5 and 7, operators embedded in physical or business rules (such as the cumulative operator and the inequality operator) are treated in the templates 406a-406b. One only needs to fill the correct terms into each equation to produce the desired constraint embodiments 408a-408b, which greatly simplifies the process of extending a common constraint to a variety of domains 410.

As can be seen here, it is possible for users to define a complete optimization formulation by defining one or more embodiments 408 of one or more constraint templates 406 and by defining one or more embodiments 414 of one or more objective templates 412. As particular examples of the one or more embodiments 408 of the one or more constraint templates 406, a user may define one or more material constraints and one or more capacity constraints. Each material constraint is associated with one or more resource nodes 352 and could be defined using an associated constraint template 406. One example of a material constraint is a raw material balance constraint. Each capacity constraint is associated with one or more task nodes 354 and could be defined using an associated constraint template 406. One example of a capacity constraint may define operating hours during which the one or more associated task nodes 354 may operate. As particular examples of the one or more embodiments 414 of the one or more objective templates 412, a user may define one or more cost terms and one or more value terms Each cost term is associated with one or more task nodes 354 and could be defined using an associated objective template 412. Examples of cost terms could include production costs, labor costs, changeover costs (costs associated with switching from producing one product to another product), and/or utility costs. Each value term is associated with one or more resource nodes 352 and could be defined using an associated objective template 412. Examples of value terms could include revenue, margin, profit, sales value of production (SVOP), and/or fill rate. Thus, it may be relatively easy for users to define complete optimization formulations using a limited number of embodiments 408, 414 for a limited number of constraint templates 406 and objective templates 412.

Note that, in some embodiments, the constraint templates 406 can represent processing unit-level templates, such as when the constraint templates 406 are associated with processing units 306 Also, different templates 406 can be associated with different types of processing units 306. In these embodiments, the templates 406 may be highly disparate since the processing units 306 may be distinctly different. Even in these cases, however, the same template 406 or templates 406 may be used multiple times, such as to create multiple embodiments 408 of the same template 406 or templates 406 in different domains 410.

Although FIGS. 4A and 4B illustrate one example of an arrangement 392 of constraint and objective term templates that may be embodied in multiple domains 410, various changes may be made to FIGS. 4A and 4B. For example, any specific implementation of this approach may include any suitable number of constraint templates and any suitable number of objective templates, and each template may be used to produce any suitable number of embodiments (with or without extended embodiments). This includes use of the described approach for a single domain 410. Although FIGS. 5 through 7 illustrate examples of material balance and expiration constraints, various changes may be made to FIGS. 5 through 7 For instance, these specific material balance and expiration constraints are for illustration only, and any other suitable material balance and expiration constraints may be defined and used Also, other or additional types of constraints may be defined in the same or similar manner and used, such as batch production templates, time balance templates, storage capacity templates, and lock production templates In addition, the mapping process from templates to embodiments could be accomplished using a variety of techniques, such as by using dictionary look-ups or a machine learning classification model.

### Example Reconciliation

After all embodiments of constraints, terms, and variables associated with an objective function are generated, conflicts and redundancies in the variables can be automatically reconciled in order to produce a complete optimization formulation. In some cases, this allows the complete optimization formulation to be solved by an off-the-shelf optimization solver or other optimization solver. The reconciliation of conflicts can extend naturally from the use of objectives, constraints, and variables to their dependencies on input data. Conflict and dependency reconciliation can be very useful or important in helping to ease the use of an RTN-based templated PSO framework in a particular use case, since it enables rapid resolution of any issues during the generation of the optimization formulation for that particular use case.

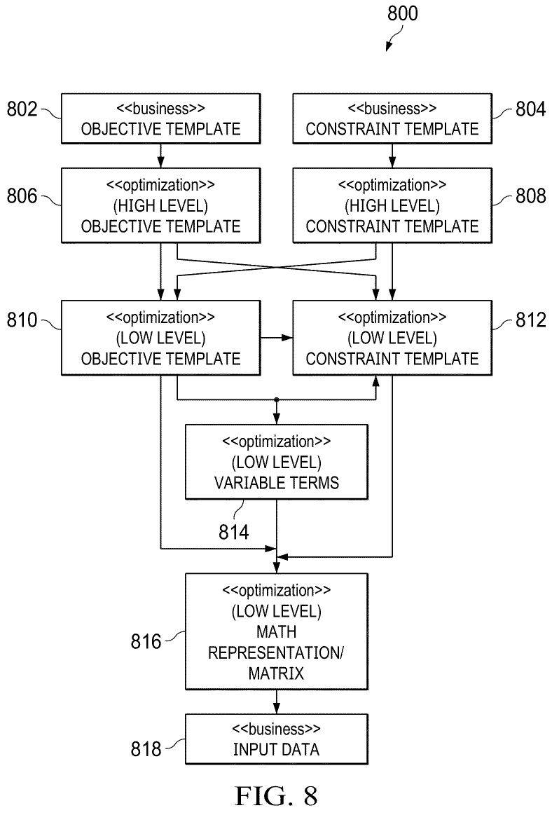

FIG. 8 illustrates an example dependency graph 800 according to this disclosure. In the context of production scheduling, an optimization technique (such as linear programming or mixed integer linear programming) can be used to find the optimal ordering of producing materials to minimize missed demand while ensuring constraints (such as material balance constraints) are satisfied. The design of an optimization approach often starts from a few business-level objective templates 802 and constraint templates 804, and each business-level objective template 802 or constraint template 804 is translated into a high-level description of optimization objective templates 806 and constraint templates 808. Those high-level optimization descriptions can be converted into lower-level optimization terms like objective term templates 810, constraint term templates 812, variable terms 814, and lower-level mathematical representations or matrices 816. At least some of these items can be used to define input data 818 that will be needed in order to perform the desired production schedule optimization operations.

In the past, despite large similarities among optimization problems across many different industries, no framework enabled a shared optimization-building process. As a result, a large amount of effort was often required to duplicate the same optimization-building procedures from one problem to another. Considerable development effort was needed to refactor an existing code base or redevelop a new solution from scratch. The approaches described above help to abstract the building of a complete optimization formulation based on the use of constraint and optimization templates. Moreover, a dependency management framework can be provided that allows developers or other users to select the desired templates and assemble them into a new solution for a new application or use case. Dependency management is performed to help ensure that selected templates are compatible and that all supporting mathematical components (such as matrices, variables, constraints, and objectives) are automatically generated. This approach can reduce the development time required for solving a new optimization problem.

In some embodiments, to improve the scalability and generalizability of optimization approaches, the constraint and optimization templates described above can be used with a dependency graph The dependency graph can be used to allow for reusing of existing optimization approaches, which can free developers from translating business objectives to formulation details repetitively The dependency graph can also enable automatic dependency building and help to ensure that component dependencies are introduced into the optimization formulation. In addition, the dependency graph can allow automatic dependency reconciliation, which helps to ensure that there are no conflicting optimization objectives or constraints.

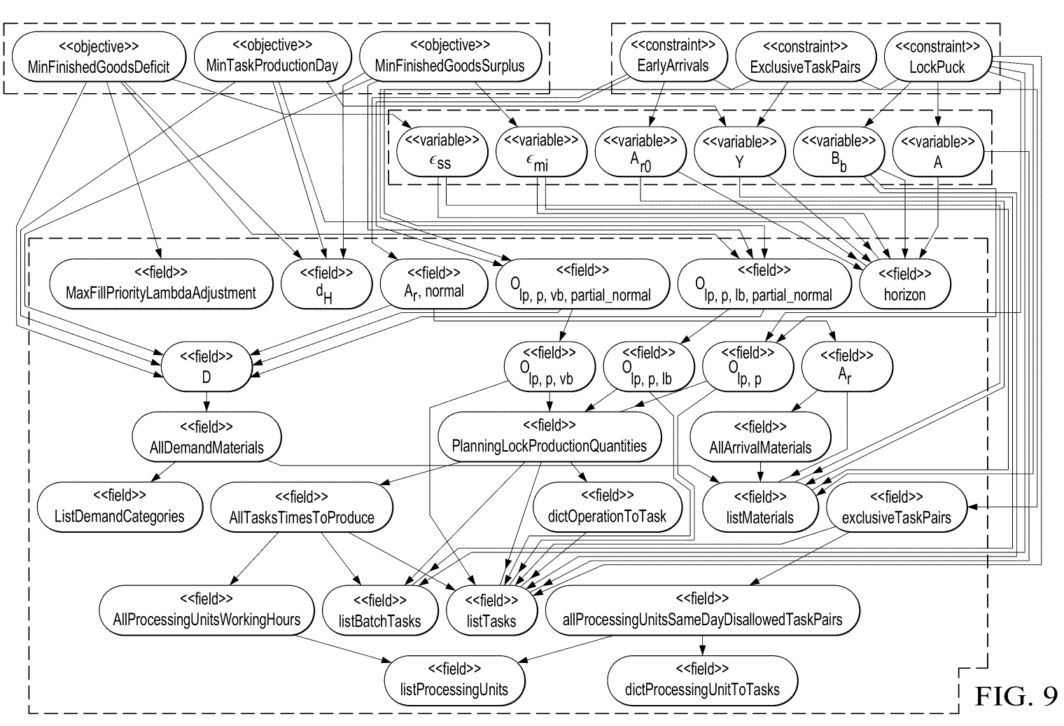

In the example shown in FIG. 8, the blocks of the dependency graph 800 are arranged hierarchically, and each block of the dependency graph 800 can include or be associated with dependency information, and necessary dependencies can be automatically built if any dependency information is missing. As a result of this approach, the dependency graph 800 can be used to connect to the source input data (input data 818) upon which the lower-level mathematical representations or matrices 816 directly depend. One example result of this approach is shown in FIG. 9, which illustrates a specific example of a low-level component dependency graph 900 according to this disclosure. By obtaining high-level objectives and constraints, the framework can automatically generate required variables and matrices

As a particular example of this functionality, due to the use of templates, a user may only be required to partially fill in the contents of a template (such as by filling in about half of the template). Because of dependencies, the system may be able to auto-complete the remaining portion of the template (such as by automatically filling in the other half of the template). The system can also determine dependency relations and reconcile any conflicts in those dependency relations. For instance, assume that multiple templated constraints include energy balance constraints that depend on the same variable(s) or input data. A conflict might exist if a user defines the same variable in different ways, such as by defining a mass variable differently for different energy balance constraints. The use of the dependency graphs as described above can allow the system to automatically determine that mass refers to the same input data 818 in both templates, so mass in both templates can be directed to the proper (common) variable. This same type of approach may be used with all input data 818 that is applied to constraints or objectives.

Although FIG. 8 illustrates one example of a dependency graph 800 and FIG. 9 illustrates a specific example of a low-level component dependency graph 900, various changes may be made to FIGS. 8 and 9. For example, the dependency graph 800 in FIG. 8 may have any other suitable arrangement of information. Also, the specific example of the dependency graph 900 in FIG. 9 is based on one particular scenario and does not limit the scope of this disclosure to that particular scenario.

### Example Sub-Network Generation

Referring again to FIG. 3B, the resource-task network 350 represents a directed network, where rectangles represent resource nodes 352 and circles represent task nodes 354. The task nodes 354 represent processing operations, each of which can receive one or multiple types of material(s) as input and which can generate one or multiple types of material(s) as output. The various types of materials are represented by the resource nodes 352. Arrows show directed connections between materials and processing operations, thereby indicating how each material is produced and consumed. Based on the generation of a resource-task network 350, various applications or functions can be designed and performed using the RTN-based templated PSO framework. Examples of the applications or functions that can be performed may include (i) the detection of weak connections in a resource-task network 350 in order to divide an original optimization problem into multiple smaller optimization problems; (ii) generating predictions, explanations, and validations along edges of a resource-task network 350 (where each prediction, explanation, or validation can propagate from a task node 354 to a resource node 352 or vice versa); and (iii) estimating and propagating uncertainties along a resource-task network 350. The RTN-based templated PSO framework enables deployment of all of these applications or functions more efficiently.

With respect to detecting weak connections in a resource-task network 350 in order to divide an original optimization problem into multiple smaller optimization problems, this may also be referred to as network decomposition. During network decomposition, a resource-task network 350 representing a single facility (such as a single processing or manufacturing plant) or multiple interconnected facilities can be decomposed based on the network structure and other information. In some embodiments, for example, the decomposition can be performed based on graph-based decomposition, time-based decomposition, other business rule-based decomposition, or other decomposition approach.

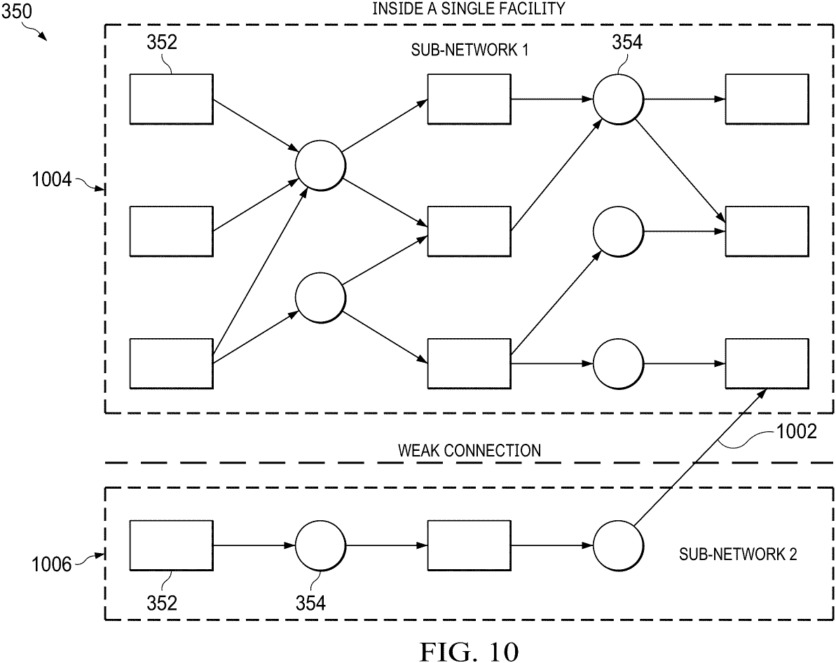

FIG. 10 illustrates an example network decomposition for a single facility according to this disclosure. Starting from the resource-task network 350 as shown in FIG. 3B, a standard or other algorithm may be used to detect weak connections between groups or “sub-networks” of nodes 352-354 in the resource-task network 350. In the example shown in FIG. 10, one weak connection 1002 is identified. Based on the detected weak connection 1002, the resource-task network 350 can be separated into two or more smaller sub-networks 1004 and 1006. Here, the weak connection 1002 can be identified since there is a single or limited number of connections between the sub-networks 1004 and 1006.

An optimization problem can therefore be defined for each of the sub-networks 1004 and 1006. Any conflicts on the boundary between two sub-networks can be reconciled, such as by using one or more iterative mathematical techniques (examples of which may include Bender’s decomposition, Lagrangian decomposition, Dantzig-Wolfe decomposition, etc.). The RTN-based templated PSO framework of this disclosure enables users to quickly replicate similar but different constraints to different optimizations in multiple sub-networks 1004 and 1006 In some specific use cases, original constraints and objective terms in a sub-problem may be replaced with a linearized (simplified) variation to achieve a less-granular or less-accurate solution for better performance. In those scenarios, the RTN-based templated PSO framework helps to create those linearized variations with much less effort, such as by supporting the use of the extended embodiments 408′, 414′

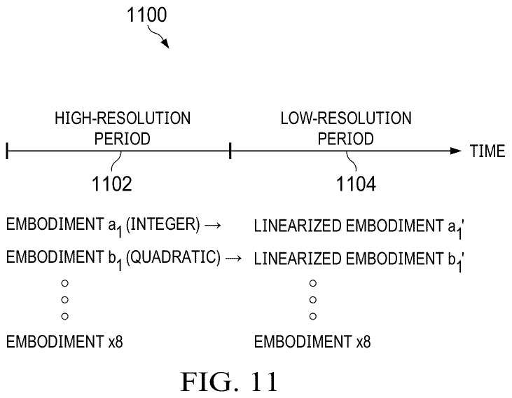

For time-based decomposition, a similar advantage can be achieved via the RTN-based templated PSO framework. FIG. 11 illustrates example sub-problems derived by time-based decomposition 1100 with different resolution requirements according to this disclosure. More specifically, FIG. 11 shows how the RTN-based templated PSO framework may help simplify the deployment to two sub-problems with different resolution requirements. As shown in FIG. 11, two line segments 1102 and 1104 collectively represent a time horizon. There is a period on the left-hand side with a high (full) resolution requirement, which means the optimization solution for that period needs to be very accurate. On the right-hand side, there is a period with a lower resolution requirement. Constraints associated with the high-resolution period include a₁ (which is an embodiment of the constraint template a in FIG. 4A), b₁ (which is an embodiment of the constraint template b in FIG. 4A), and so on for eight constraints. Note that embodiments a₁ and b₁ here are nonlinear constraints In the low-resolution period, those embodiments a₁ and b₁ can be replaced with linearized (extended) embodiments a₁′ and b₁′, which can be quickly generated based on the templates. The linearized embodiments may enable an optimization solution to be generated faster but in a less accurate manner

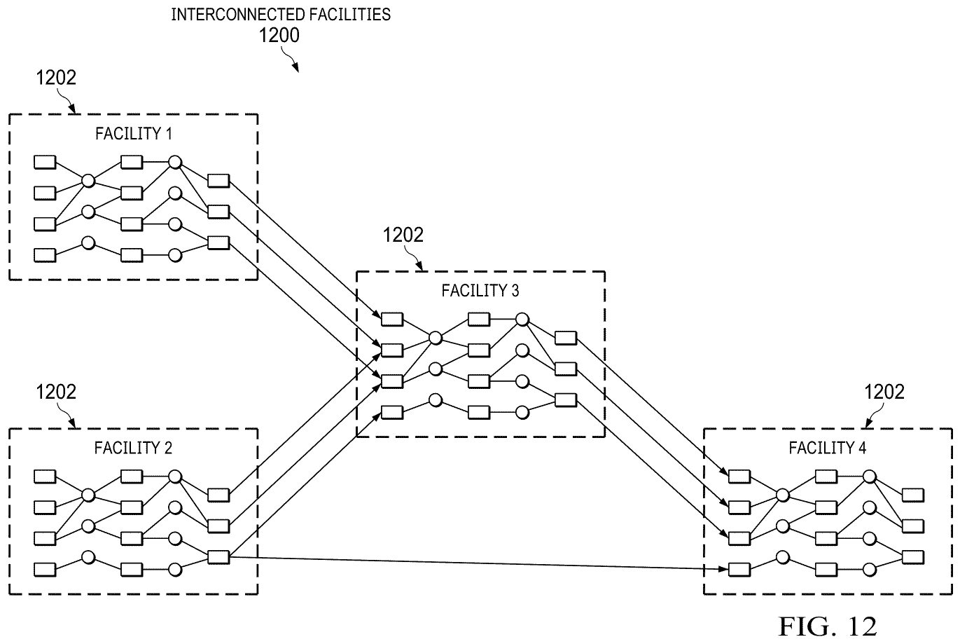

Network decomposition can also have a broader use case for interconnected facilities. FIG. 12 illustrates an example arrangement 1200 of interconnected facilities 1202 according to this disclosure. For consistency with other figures, rectangular nodes inside each facility 1202 represent materials (resource nodes 352), and circular nodes inside each facility 1202 represent processing operations (task nodes 354). As can be seen here, output materials for some of the facilities 1202 become input materials for other facilities 1202 In some cases, the whole optimization problem for the entire arrangement 1200 may be decomposed into optimization problems for individual facilities 1202 (or portions thereof), and the solutions for the sub-problems can be reconciled iteratively. Also, the facilities 1202 could have similar but different constraints or objective terms. The RTN-based templated PSO framework enables the fast replacement of constraints in the iterations, making it easier to manage dynamically-changing facility assets or topologies between facilities 1202.

In cases where a resource-task network 350 representing a single plant or multiple interconnected plants can be decomposed into multiple sub-networks, each sub-network can be associated with a subset of the resource nodes 352 and task nodes 354 of the resource-task network 350. Also, different embodiments 408, 414 of the same template 406, 412 or templates 406, 412 may be used for different ones of the sub-networks. Further, the optimization problems that are created for the sub-networks may be solved independently or combined and solved as a single optimization problem. In addition, it is possible to easily scale the described approaches to any desired level of granularity, such as by providing templates and performing optimizations at the processing unit-level, for groups of processing units, for an entire plant, or for a collection of plants.

Although FIGS. 10 through 12 illustrate examples of network decomposition for a single facility, sub-problems derived by time-based decomposition with different resolution requirements, and arrangement of interconnected facilities, various changes may be made to FIGS. 10 through 12. For example, a resource-task network 350 may have any other suitable arrangement of nodes 352 and 354, so there may be any number of weak connections detected and therefore any number of ways to decompose the resource-task network 350 into two or more sub-networks. Similarly, there may be any number of ways to perform time-based decomposition depending on the resolution level(s) needed at any given time In addition, production schedule optimization may be performed for any individual facility or any suitable arrangement of interconnected facilities.

### Example Process for Production Scheduling Optimization

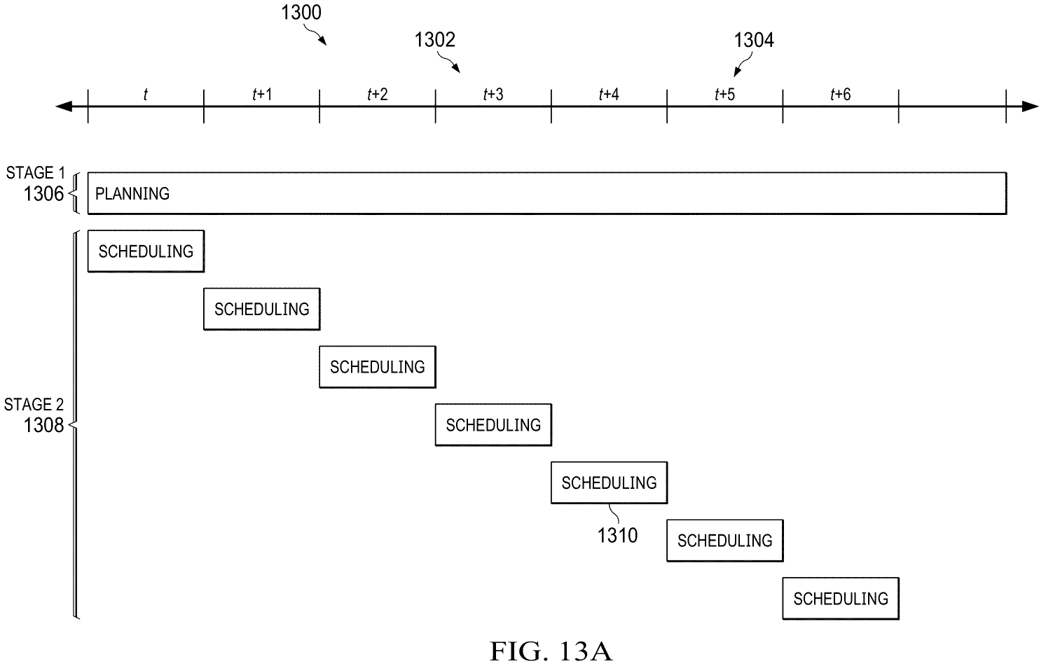

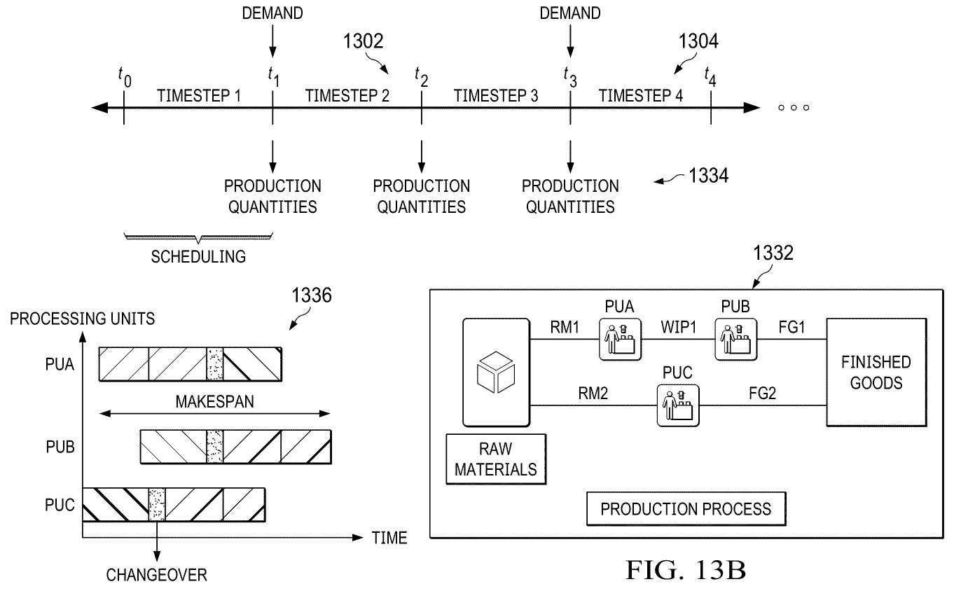

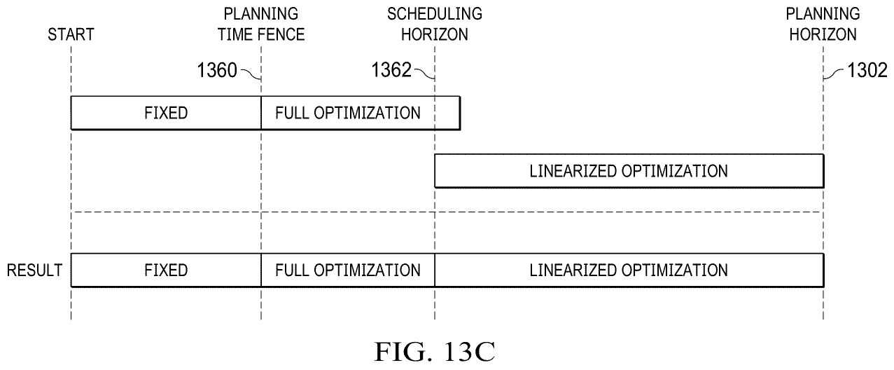

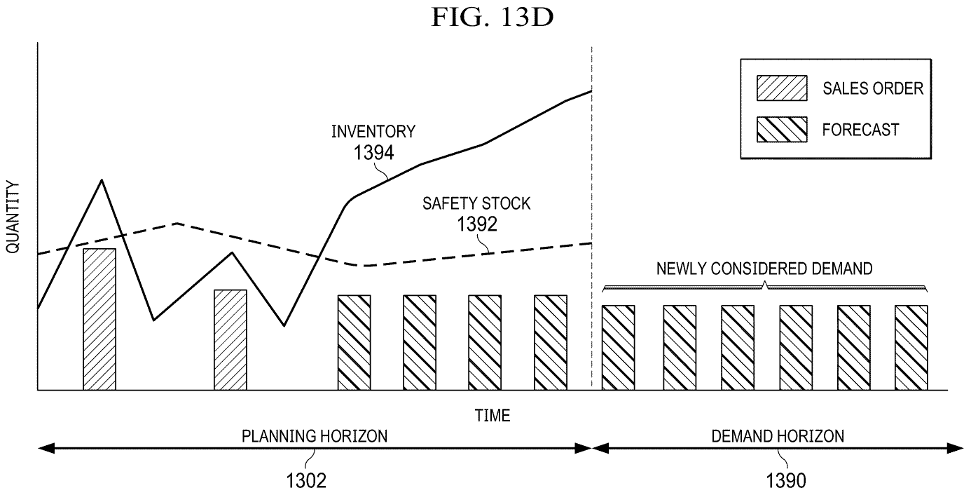

FIGS. 13A through 13D illustrate an example two-stage process 1300 for performing production scheduling optimization and related details according to this disclosure. The two-stage process 1300 may, for instance, represent one example of an efficient approach for performing production scheduling optimization as used by the RTN-based templated PSO framework. As shown in FIG. 13A, production scheduling optimization can be performed over a planning horizon 1302, which is divided into multiple timesteps 1304 The horizon 1302 can span any desired length of time, such as one or more years, although other lengths of time may be used for the horizon 1302. Each timestep 1304 can also span any desired length of time within the horizon 1302. In some cases, each timestep 1304 may represent one day, although other lengths of time may be used for each timestep 1304.

In this example, the RTN-based templated PSO framework can be used to perform various operations during a planning stage 1306 and a scheduling stage 1308. During the planning stage 1306, the RTN-based templated PSO framework can process various data in order to generate a production schedule for part or all of the horizon 1302. Often times, the production schedule produced during the planning stage 1306 can identify specific products to be produced in specific quantities during specific timesteps 1304. While this gives a general idea of the production schedule for one or more facilities during at least part of the horizon 1302, it does not indicate how specific tasks are to be performed during each timestep 1304. Thus, during the scheduling stage 1308, the RTN-based templated PSO framework can process various data in order to generate a production schedule for each of at least some of the timesteps 1304 (such as individual days within at least part of the horizon 1302). The production schedule for an individual timestep 1304 can identify tasks to be performed, when or the order in which the tasks are to be performed, which processing units are to be used when performing the tasks, and what materials are to be processed using the processing units.

As can be seen in this example, the scheduling stage 1308 can be divided into a set of sub-processes 1310, where different sub-processes 1310 can be used to generate production schedules for different timesteps 1304. As a result, it is possible to determine a schedule of production tasks within an individual timestep 1304, and this can be done for multiple timesteps 1304 using outputs of the planning stage 1306. In some cases, at least some of the sub-processes 1310 can be performed in parallel, which can help to greatly reduce the amount of time needed to perform the scheduling stage 1308.

Overall, the planning stage 1306 may be performed for planning purposes on a day-by-day basis or other basis over the planning horizon 1302, which may typically span months or years. One goal of the planning stage 1306 may be to identify optimal production quantities for each day or other timestep 1304 within the horizon 1302 An objective function may be used during the planning stage 1306 to minimize an amount of missed demand for products to be produced. In some embodiments, the objective function may be used to achieve a number of objectives, such as minimizing an amount of missed demand for products to be produced, minimizing a number of products produced during each timestep 1304, minimizing use of expensive raw materials, minimizing an amount of wasted raw materials, minimizing an amount of worker overtime, maximizing a number of makeahead days, minimizing an amount of wasted finished goods, and minimizing an amount of wasted byproducts. The planning stage 1306 can involve the use of various constraints, one or more of which may represent embodiments 408 defined using constraint templates 406 (although this is not necessarily required). Examples of definitional constraints that may be used include raw material inventory (which can be defined as starting inventory plus arrivals minus waste minus consumption), finished product/good inventory (which can be defined as starting inventory plus production minus usage), and Yᵢ (which can be defined as a binary form of production). Other constraints may indicate that byproduct consumption needs to be less than production, each raw material expires after its shelf life, each finished product/good expires after its shelf life, processing unit runtime is limited to a specific number of hours per day plus overtime (up to a maximum number of hours per day total), and physical quantities need to be non-negative and less than maximum physically possible values. Note that these constraints are for illustration and explanation only.

The scheduling stage 1308 may be performed for planning purposes on a day-by-day basis or other basis over a shorter period of time, such as one or several weeks within the planning horizon 1302 (this shorter period of time is referred to as a scheduling horizon below). One goal of the scheduling stage 1308 may be to identify an optimal sequencing of tasks to be performed on each processing unit. An objective function may be used during the scheduling stage 1308 to minimize a total time (also referred to as a makespan) spent on production and changeovers. The scheduling stage 1308 can involve the use of various constraints, one or more of which can represent embodiments 408 defined using constraint templates 406. Examples of constraints that may be used include production time being defined as production quantity multiplied by time per quantity, start times for production needing to occur before end times for production, the start and end times for production needing to be within the makespan, some products requiring changeover times, byproduct balance being defined as cumulative production of byproducts minus cumulative consumption of byproducts at each timestep, byproduct balances not being allowed to drop below zero, and the makespan being less than or equal to regular production time plus overtime. Again, note that these constraints are for illustration and explanation only.

This approach results in the generation of a production schedule (such as a production schedule defining scheduled operations by processing unit and by shift) for a given length of time (such as a fourteen-day period) for all production lines. FIG. 13B illustrates example results that may be obtained using this approach. In FIG. 13B, a specific processing facility 1332 includes three processing units (denoted PUA, PUB, and PUC). The planning stage 1306 is used to generate a production schedule 1334 that identifies quantities of one or more products to be produced during each day or other timestep 1304 within at least part of the horizon 1302. The scheduling stage 1308 is used to generate a production schedule 1336 for at least some of the timesteps 1304, where the production schedule 1336 can identify when the processing units of the processing facility 1332 are used, which materials are processed by the processing units of the processing facility 1332, and when changeovers occur. Changeovers represent instances where a processing unit stops performing one task or processing one material and switches to performing another task or processing another material.

This type of approach can result in various benefits or advantages depending on the implementation. Among other things, this type of approach allows production schedules to be generated that improve the ability of manufacturing or processing plants to satisfy customer demands. Moreover, this can be accomplished while reducing the number of product changeovers, which can provide significant time and cost savings and possibly reduce the amount of unusable products produced during the changeovers. Further, the effort needed to generate production schedules can be reduced significantly, such as by decreasing manual effort up to 96% or more. In addition, since actual constraints can be implemented as embodiments 408 of templates 406 and objectives can be implemented as embodiments 414 of templates 412, users can easily initiate multiple production optimization operations by altering constraints and terms of one or more objective functions to generate multiple potential production schedules. This allows users to compare potential production schedules, select desired production schedules, or perform other operations based on changes to constraints and terms of objective functions associated with production scheduling.

FIG. 13C illustrates how the two-stage process 1300 may optionally use the embodiments 408, 414 and extended embodiments 408′, 414′ of constraints and optimization objectives described above. In FIG. 13C, production between a current time and a planning time fence 1360 can be fixed. This period of time may represent time where production tasks have already begun or are otherwise not modifiable. Full production schedule optimization may occur between the planning time fence 1360 and somewhat beyond a scheduling horizon 1362. The process 1300 can perform the scheduling stage 1308 to generate production schedules for the timesteps 1304 between the planning time fence 1360 and the scheduling horizon 1362. The full production schedule optimization generally involves using the embodiments 408, 414 of the templates 406, 412, which can represent more accurate embodiments of the constraints and optimization objectives. Linearized production schedule optimization may occur between the scheduling horizon 1362 and the end of the planning horizon 1302. The linearized production schedule optimization generally involves using one or more extended embodiments 408′, 414′ of one or more templates 406, 412, which can represent one or more less accurate embodiments of one or more constraints or optimization objectives. This can simplify the calculations performed as part of the linearized production schedule optimization. As a result, this allows full production schedule optimization to occur for those timesteps 1304 where the scheduling stage 1308 will generate actual production schedules, while the linearized production schedule optimization can be used for timesteps 1304 after that.

In some cases, the two-stage process 1300 can consider product demands that may arise after the planning horizon 1302. An example of this is shown in FIG. 13D, where the planning horizon 1302 is shown along with a demand horizon 1390. The demand horizon 1390 represents a future time period during which demand for one or more products can be estimated, such as based on actual or estimated product orders, historical demand information, or other information. In this example, a line 1392 represents an estimated safety stock level, where the safety stock level represents an amount of product that should be maintained to mitigate the risk of a stockout A line 1394 represents an estimated inventory level for the product, which is based on the production schedule generated by the process 1300. By considering demand past the planning horizon 1302, production scheduling within the planning horizon 1302 can be used to incentivize building-up of the inventory level represented by the line 1394 by the end of the planning horizon 1302. This can be done in order to meet the future demands, as long as the future demands are within the product’s shelf life.

Although FIGS. 13A through 13D illustrate one example of a two-stage process 1300 for performing production scheduling optimization and related details, various changes may be made to FIGS. 13A through 13D. For example, the two-stage process 1300 may perform the scheduling stage 1308 without division into the sub-processes 1310. Also, the results shown in FIG. 13B are examples only and could easily vary depending on the implementation In addition, the use of full and linear optimization and the consideration of demand beyond a planning horizon are optional features.

### Specific Example Implementation of Rtn-based PSO

The following now describes a specific embodiment of an RTN-based templated formulation in the context of a food processing industry. This embodiment uses a discrete-time formulation and is solved using a two-stage procedure, namely a planning stage 1306 and a scheduling stage 1308. Note that the constraints and the terms in objective functions below may, in some embodiments, be defined using constraint templates 406 and objective templates 412 as described above (although this is not necessarily required). To connect the templated framework introduced above with the constraints used in the specific embodiment described below, the templates used in the planning stage (the first stage) 1306 include material balance templates (Equations (1b), (1c), (1d), (1g), and (1h) below), an expiration template (Equation (1e) below), batch production templates (Equations (1i), (1j), (1k), (1l), (1m), (1n), and (2c) below), time balance templates (Equations (1p) and (1q) below), storage capacity templates (Equations (2h), (2i), and (2j) below), and lock production templates (Equations (2d) and (2e) below). The templates used in the scheduling stage (the second stage) 1308 include time balance templates (Equations (30b), (30c), (30d), (30e), (30f), (30g), (30h), (30f), (30m), and (30n) below) and lock production templates (Equations (30j) and (30k) below).

Note that while the following discussion may involve a food industry example, the same or similar approach may be used for optimizing a production schedule for any other suitable processing or manufacturing industry and in some cases may be aimed at a facility with relationships between processing lines that can be defined using a production graph within the facility This approach can accommodate products with limited shelf lives. Also, the facility can have down-steam interconnections to one or more distribution centers, such as when a production facility is associated with multiple distribution centers To this end, the production schedule optimization can be broken into two stages, namely the planning stage and the scheduling stage as noted above. During the planning stage, the total quantity of each production task to be performed each day or other timestep can be determined. During the scheduling stage, the ordering of each production task within a single day or other timestep can be determined, and this may be performed in parallel for all days or other timesteps using the outputs of the planning stage.

### Nomenclature

In the discussion below, the scheduling problem is considered for production facilities with generalized production graphs, which means the scheduling problem can involve independent production lines or a production graph. Referring back to FIG. 3A, assume that a facility produces a set of products 304 denoted prod. The set of raw materials 302 used to produce those products 304 can be denoted raw. The union of prod and raw is denoted mat, meaning mat = raw U prod. The prod set can also be divided into a set of WIP materials (wip), which could include any by-products, and a set of finished goods (fg or FG), which can include the products 304 With this formulation, prod = fg ∪ wip. A material m could represent any value in the set mat.

Each processing unit 306 is denoted j and can perform a single task i or multiple tasks i’s. All of the processing units 306 can be represented by a set unit, and all of the tasks performed by the processing units 306 can be represented by a set task. In some cases, if the same task can be performed using different processing units 306, the task as performed using the different processing units 306 may be treated as different tasks and may have distinct task identifiers. Tasks are also known as production versions, and processing units are also known as lines. The task notation can be used to represent all tasks under consideration.

The sets fg, wip, and task can be divided into subsets (such as fg_{std}, fgₛₜₖ, wip_{std}, wipₛₜₖ, task_{prod}, and task_{shad}) below to accommodate a stock transport requisition (STR) formulation. In general, the stk and std subscripts for each material category represent “stocked” and “standard” subsets of the material category, respectively. The prod and shad subscripts for the task category represent “production” and “shadow” subsets of the task category, respectively. As a convention, the expression |set| can be used to denote the number of elements in the set. For example, |task| would denote the total number of tasks under consideration. For some facilities, there may not be raw material arrival constraints, and the inventory or expiration of raw materials may not be considered (due to on-demand order for the raw materials). However, as will be shown below, arrivals can be included in the formulation to make the formulation itself generally applicable to all cases. The formulation introduced below supports production schedule optimization while considering stock transport requisitions of downstream distribution centers (DCs).

The production of material with task i follows an input recipe matrix Rᵢₙ ∈ ℝ^{|task|×|mat|} (which defines how much of each input material is consumed by each task) and an output recipe matrix Rₒᵤₜ ∈ ℝ^{|task|×|mat|} (which defines how much of each type of product is generated by each task). Under these definitions, element Rᵢₙ[i, l] represents the amount of an input material l that is needed for a task i. The notations

$${R}_{i n}^{m} , {R}_{o u t}^{m} ∈ {ℝ}^{\left|t a s k\right|}$$

represent the m^{th} columns of Rᵢₙ, and Rₒᵤₜ, respectively. Note that the quantity of the task i performed is usually measured by the quantity of its primary output. Let a time cost matrix for all tasks be denoted as C ∈ ℝ^{H×|task|×|unit|}, where element C[d, i, j] denotes the time it takes on the date d to produce one unit of the primary output of the task i on the processing unit j. Note that the task i could include multiple operations, each of which might take place on a different line. Therefore, multiple entries in C[d, i, :] may be non-zero While the formulation below is limited to a single operation per task for convenience, other embodiments may support multiple operations per task

The following additional notations are used in the discussion below and have the following meanings.

exclusiveset – An exclusive task set, where only one task in the set of tasks can be performed on any given day.

in(m) – A set of tasks that take an input material m as an input.

K_{c} – A set that includes demand from a variety of categories, including from different customers, of different types, etc.

MTS (subscript) – A specific category of tasks related to “make to stock” products.

λ₁, ..., λ₁₂ – Penalties to be applied as part of an optimization.

ξ – A number of work shifts.

Ω ∈ {0, 1}^{η×H|task|} – A shift-combination variable indicating whether time consumption on a task should be considered for a processing unit time constraint.

Ω₀ – A shift combination matrix.

Π ∈ 0, 1^{|task|×|exclusiveset|} – An assignment of tasks to an exclusive set.

Φ ∈ {0, 1}^{H×|task|} – Configurable product planning rules, where Φ[d, i] = 1 if a task i cannot be planned on a day d.

c_{D,k} ∈ ℝ^{|mat|} – A cost of missing a demand for each type of material if the material belongs to a category k. The dimension of c_{D,k} can be extended to be consistent with a matrix Dₖ (described below), but essentially

$${c}_{D , k}^{m} = 0 , ∀ m ∈ w i p ∪ r a w ∪ r a w ∪ f {g}_{s t d}$$

since there is no explicit customer demand for raw materials, WIPs, or standard finished goods

cₒₜ ∈ ℝ^{ξ×H×|unit|} – A fixed operation cost for overtime production (such as over the weekends), where non-zero elements are used only for work shifts with zero regular working hours.

cₚ – A penalty applied to low-priority tasks.

c_{w} ∈ ℝ^{|mat|} – A cost of wasted material.

C ∈ ℝ^{H×|task|×|unit|} – A processing time for each task on each processing unit. C^{v} and C^{f} are the same as C and represent unit time spent for variable-duration and fixed-duration operations, respectively. In some cases, the processing time can be measured by the hours it takes for producing one unit (such as a specified number of pounds) of the primary output for each task on each processing unit.

C_{md} ∈ ℝ^{|task|×|unit|} – A required time (such as in days) for multi-day processes. If task i is a single-day process, C_{md}[d, i, j] = 0. On the other hand, if task i is a multi-day process,

$$C \left[d , i , j\right] = {1}_{ξ}^{T} {n}^{s} \left[: ζ , d , j\right] , ∀ d .$$

d_{H} ∈ ℝ^{H} – A discount factor over time such that costs closer to the start of a planning period are given greater weights than costs later in the planning period.

$${E}_{p}^{j} ∈ {\left\{0 , 1\right\}}^{\left|t a s k\right| \times \left|{I}_{j}\right|} -$$

A mapping matrix that maps all tasks to tasks that can be performed on the processing unit j.

G – A total number of processing unit groups defined.

$${I}_{\text{ss}}^{m} , {I}_{\text{mi}}^{m} ∈ {ℝ}^{\text{H}} -$$

A safety stock and a maximum inventory level for a specific material m, which are valid only if m belongs to the MTS category (represented by the set prod_{MTS}).

$${M}_{\text{max}}^{f} , {M}_{\text{min}}^{f} ∈ {ℝ}^{\text{H} \times \left|t a s k\right| \times \left|u n i t\right|} -$$

A maximum quantity and a minimum quantity, respectively, for one leg in fixed-duration operations (each of which can be ignored if the associated element is zero).

$${M}_{max}^{v} ∈ {ℝ}^{\text{H} \times \left|t a s k\right| \times \left|u n i t\right|} -$$

A maximum quantity for one leg in variable-duration operations (which can be ignored if the associated element is zero).

M – A large positive scalar value.

n^{s}, n^{max} ∈ ℝ^{η×H×|unit|} – A maximum number of timesteps of production for each shift combination in each day for each processing unit without and with overtime, respectively.

O_{lp,p} ∈ ℝ^{H×|mat|} – Pre-specified “lock puck” quantities.

$${O}_{l p , p}^{v} \text{and} {O}_{l p , p}^{f} -$$

Pre-specified lock puck quantities and legs for variable-duration and fixed-duration processes, respectively.

$${O}_{l p , m}^{m} ∈ {ℝ}^{H \times \left|m a t\right|} -$$

An amount of locked puck input material balance slack. For each locked puck, there is a chance that it is impossible to produce enough input material for the action, so an optimizer can use this slack variable for those specific materials on specific days that the locked action would consume those materials (BOM lead time offset included). The amount of slack possible can be limited by the maximum amount of consumption the lock puck would ever need (see Equation (2f) below). The total amount of the slack used can be penalized and, in general, the penalty multiplier can be strictly greater than the penalty for missed demand, avoiding abuse of this material balance slack when unnecessary.

P_{lp,p} ∈ℝ^{H×|mat|} – A matrix defining the lock puck for the planning stage.

$${P}_{\text{pw}}^{m} ∈ {\left\{0 , 1\right\}}^{H}$$

A procurement window for a material m. An element in

$${P}_{\text{pw}}^{m}$$

can be equal to one if the corresponding date and the material m are within the procurement window. Note that, in general,

$${P}_{\text{pw}}^{m} = 1 , ∀ m ∈ f g ∪ w i p ,$$

which means only raw materials are affected by the procurement window.

P_{oco} ∈ {0, 1}^{H×|punits|} – An overnight changeover penalty for each processing unit for each day, indicating that two tasks incur an overnight changeover penalty if the processing unit performed one task on one day and another task on the following day

P_{pd} and P_{pd, max} ∈ ℝ^{η×H×|unit|} – A total amount of planned downtime aggregated on a given shift combination for each date within a working hour and for a maximum working hour (with overtime) on each processing unit, respectively.

V, U ∈ ℝ^{H×|task|} – Matrices representing minimum and maximum lot sizes, respectively (where a corresponding constraint can be ignored if the associated element in a matrix is zero).

1_{d} ∈ ℝ^{d} – A vector of dimension d with all elements equal to one.

1_{d,d}′ E ℝ^{d} – A vector of dimension d with its first d′ elements set to one and its remaining elements set to zero. For example, 1_{5,3} ∈ R⁵ = [1, 1, 1, 0, 0]^{T}.

δ_{i,j} – A Kronecker delta.

Δ⁻¹ E ℝ^{H×H} – A lower triangular matrix with only ones as non-zero elements.

e₁ ∈ ℝ^{dng} – A vector having one for its first element and zero for its remaining elements.

J_{a×b} --- A matrix of dimensions a × b with all elements equal to one.

Lₖ ∈ ℝ^{H×H} – Lower shift matrices.

$${\tilde{\text{L}}}_{\text{k}}$$

∈ ℝ^{H}^{×H} – A slight variation of Lₖ that fills the first abs(k) columns in the first row with ones.

L_{gr(m}), Lₛₗ₍ₘ₎ ∈ ℝ^{H×H} – Lower shift matrices that represent a good receipt time (or transition time) for a material m and a shelf life for a material m, respectively.

blt(i,m) – A bill of materials (BOM) component lead time offset for a material m with a task i.

L_{blt(i,m)} ∈ ℝ^{H×H} –A shift matrix that is shifted upwards if blt(i,m) is a negative number.

$${\tilde{\text{L}}}_{\text{blt(i,m)}}$$

∈ ℝ^{H×H} – A variation of L_{blt(i,m)}.

dng – Negative days, which typically is the negative BOM lead time offset days with the largest magnitude, such as dng = max(-blt(i, m)), ∀i, m.

gr(m) – A good receipt time for a material m, which denotes the time it takes for the material m to be registered in inventory, such as one day.

sl(m) – A shelf life for a material m, which represents the time between the material m is produced and its expiration.

tₑₛₜ ∈ ℝ^{H×|task|} – An estimated transition time from or to a task. One issue with determining tₑₛₜ lies in the fact that it should be as accurate as possible, but a computation of the actual changeover time may not be desired since it can introduce nonlinearity into the planning stage.

A ∈ ℝ^{H×|task|} – A production of a WIP material or a finished good from a task i and a processing unit j for each step in the horizon. In some cases, this can be quantified by the quantity (such as pound value) of the primary output of the task i.

Aₘₒ ∈ ℝ^{H×|task|×|unit|} – A high-dimensional version of A to account for multi-operation recipes For example, the matrix A may be projected to Aₘₒ via an even split across all operations inside the same task (such as |Jᵢ|, which is the number of operations for a task i).

Aᵣ ∈ ℝ^{H×|mat|} – A matrix denoting arrivals of materials from suppliers. In some cases, it is expected that only the columns corresponding to raw will have non-zero values in Aᵣ, since only raw materials are typically purchased from suppliers.

Aᵣ₀ ∈ ℝ^{H×|mat|} – An “off-the-truck” quantity for a material. This concept may only apply to purchased materials (such as raw materials) Oftentimes, a purchased material will take a “good receipt time” to be registered in inventory. One exception of this is the “off-the-truck” quantity, which can be registered into inventory on the same day of delivery.

∈ₘᵢ ∈ ℝ^{H×|fg_{sfk}|} – A slack variable that represents a surplus of finished goods compared to a maximum inventory level in each day Note that

$${ε}_{m i}^{m} ∈ {ℝ}^{H}$$

represents a column in the matrix ∈ₘᵢ, which corresponds to a specific stocked finished good m

∈ₒₜ ∈ ℝ^{η×H×|unit|} – A slack variable that represents the overtime production for each shift combination in each day on each processing unit.

∈ₛₛ ∈ ℝ^{H×|fgₛᵣₖ|} – A slack variable that represents a deficit of finished goods compared to a minimum inventory level in each day. Note that

$${ε}_{s s}^{m} ∈ {ℝ}^{H}$$

represents a column in the matrix ∈ₛₛ, which corresponds to a specific stocked finished good m.

D₀ ∈ ℝ^{H×|mat|} – A same-day shipment on each day. This concept may only apply to finished goods and can refer to demand that is satisfied by production on the same day (instead of from inventory from a previous day). In some cases, this behavior may be discouraged.

Dₖ ∈ ℝ^{H×|mat|} – A demand (such as firm orders or demand forecasts) for each material at each day for a category k, where

$${D}_{k}^{m} ∈ {ℝ}^{H}$$

denotes one column in the matrix Dₖ. Note that

$${D}_{k}^{m} = 0 ,$$

∀m ∈ wip U raw since there is no explicit demand for raw materials or WIP materials.

D_{miss,k} ∈ ℝ^{H×|mat|} – A missed demand on each day for a given category k. Here, k ∈ K_{c}. Note that the columns of D_{miss,k} can be extended to include wip and raw for dimensional consistency in the equations. In fact,

$${D}_{m i s s , k}^{m} = 0 ,$$

∀m ∈ wip U raw. The same extension can also apply to the demand matrix Dₖ.

N ∈ ℝ^{H×|mat|} – Available net production quantities for materials. The available net production quantity differs from true net production quantity due to the good receipt time, BOM lead time offset, etc Note that N^{m} ∈ ℝ^{H} represents a column in the matrix N, which corresponds to a specific material m.

Nₚᵣᵢₒᵣ ∈ ℝ^{dng×|mat|} – Available net production quantities for materials prior to day 0 of the optimization. The variable dng represents negative days, which may typically be the negative BOM lead time offset days with the largest magnitude.

W ∈ ℝ^{H×(|mat|)} – Quantities of raw materials, WIP materials, and finished goods wasted each day due to expiration. Note that W^{m} ∈ ℝ^{H} represents a column in the matrix W, which corresponds to a specific material m.

X ∈ ℝ^{H×|mat|} – Available inventories of materials at the end of each day over the optimization horizon, which include raw materials, WIP materials, and finished goods. The available inventory differs from the true inventory due to the good receipt time, BOM lead time offset, etc Note that X^{m} ∈ ℝ^{H} represents a column in the matrix X, which corresponds to a specific material m.

X₀ ∈ ℝ^{H×|mat|} – An available quantity of the initial inventory on each day, since some items may not be immediately available due to good receipt time. The variable

$${X}_{0}^{m} ∈ {ℝ}^{H}$$

is the m^{th} column of X₀.

Xₚᵣᵢₒᵣ ∈ ℝ^{dng×|mat|} – Available inventories of materials at the end of each day for dng days prior to day 0 of the optimization.

Xₜᵣᵤₑ ∈ ℝ^{H×|mat|} – True inventories of materials at the end of each day over the optimization horizon. Note that

$${X}_{t r u e}^{m} ∈ {ℝ}^{H}$$

represents a column in the matrix Xₜᵣᵤₑ, which corresponds to a specific material m.

ζₒₜ ∈ {0, 1}^{ξ×H×|unit|} – An overtime production at each shift for each day on each processing unit

Y ∈ {0, 1}^{H×(|task|)} – An indication whether or not a task is being performed on a specific day.

B_{f} ∈ ℕ^{H×(|task|×|unit|)} – An encoding of the number of legs produced for a fixed-duration operation (such as a task i on a processing unit j) on a specific day.

Bᵥ ∈ ℕ^{H×(|task|×|unit|)} – An encoding of the number of legs produced for a variable-duration operation (such as a task i on a processing unit j) on a specific day.

Mᵣᵥ ∈ ℝ^{H×|task|} – A matrix representing a rounding value for each task, where production of the primary output of a task occurs in an integer multiple of the rounding value (which can be ignored if the associated element is zero).

Bᵣ ∈ ℕ^{H×(|task|)} – An indicator of a multiplier on a rounding value with a task i on a processing unit j on a specific day.

Z_{G} ∈ ℤ₊^{G×ξ} – A total number of processing units within a given processing unit group g that can be activated in a given shift s. In some cases, the value of Z can be constant throughout a horizon, meaning the limitation set on Z can be the same for any day d within the horizon

Z ∈ ℝ^{H×|mat|} – A projected expiration of an initial inventory of materials throughout a horizon.

$${s}^{j} , {e}^{j} ∈ {ℝ}^{\left(\left|{\tilde{I}}_{j}\right| + {max}_{j} \left|{I}_{j}^{\text{pd}}\right|\right)} l -$$

Start and end times (such as in relative hour numbers like hour 1.5, hour 5, etc.) associated with each task in a processing unit j (including planned downtime). The hour numbers can be relative to the beginning time of the processing unit for the day.

|Iⱼ| – A number of elements in the set Iⱼ.

|Ĩⱼ| – A total number of tasks performed on a processing unit j for a given day d. This information can be retrieved from the matrix A.

$${I}_{j}^{p d}$$

– Each individual planned downtime for a processing unit j in a day d.

$$\left|{I}_{j}^{p d}\right|$$

A total number of planned down periods for a processing unit j in a day d.

$${max}_{j} \left|{I}_{j}^{p d}\right| -$$

A largest number of planned down periods for any processing unit across all days in the horizon.

s^{j} [: |Ĩⱼ|], s^{j} [|Ĩⱼ| :] – The first |Ĩⱼ| elements and the last maxⱼ

$$\left|{I}_{j}^{p d}\right|$$

elements in s^{j}, respectively.

$${s}_{\text{adj}}^{j} , {e}_{\text{adj}}^{j} ∈ {ℝ}^{\left(\left|{\tilde{I}}_{j}\right| + {max}_{j} \left|{I}_{j}^{\text{pd}}\right|\right)} -$$

Adjusted start and end times associated with each task in a processing unit j (including planned downtime), such as in relative hour number. The adjustment can be done to align the beginning hour for all processing units in use for a given day.

$${S}_{p}^{j} ∈ {ℝ}^{1} -$$

A so-called “makespan” that quantifies the length of the schedule for each processing unit j.

∈ₛₒₜ ∈ ℝ^{|unit|×Ĩⱼ} – A slack variable that quantifies the number of hours that the end of a task goes beyond an ending time of an allowed shift. Although the dimensions of this variable may be expressed in matrix form, it could also be a dictionary of lists since Ĩⱼ can be of different lengths for different processing units.

$${δ}^{j} ∈ {\left\{0 , 1\right\}}^{\left(\left|{\overline{I}}_{j}\right| + \left|{I}_{j}^{\text{pd}}\right|\right) \times \left(\left|{\overline{I}}_{j}\right| + {I}_{j}^{\text{pd}}\right)} -$$

Optimization variables describing the order of production on a processing unit j. A value of one for δ^{j}[i, k] means that, in the processing unit j, the task i is performed prior to the task k. The columns or rows corresponding to

$$\left|{I}_{j}^{p d}\right|$$

indicate that the current “task” is a planned down period.

$${Q}_{c}^{m} , {U}_{c}^{m} ∈ {ℝ}^{2 \left(\left|{\tilde{I}}_{j}\right| + {max}_{j} \left|{I}_{j}^{\text{pd}}\right|\right)} -$$

Quantities of a material m that are produced and consumed, respectively, by continuous processes (tasks) at each timestep.

$${Q}_{b}^{m} , {U}_{b}^{m} ∈ {ℝ}^{2 \left(\left|{\tilde{I}}_{j}\right| + {max}_{j} \left|{I}_{j}^{\text{pd}}\right|\right)} -$$

Quantities of a material m that are produced and consumed, respectively, by operations with batch inputs or outputs at each timestep.

$${b}_{q} , {b}_{u} ∈ {ℕ}^{\left|{\tilde{I}}_{j}\right| \times 2 \left({\sum }_{j} \left|{\tilde{I}}_{j}\right| + {\sum }_{j} {max}_{j} \left|{I}_{j}^{\text{pd}}\right|\right)} -$$

A number of legs completed at each timestep for the tasks that are producing and consuming, respectively, a material m. In some cases, this variable may only apply to operations with batch input or output. Note that notations

$${b}_{q}^{f}$$

and

$${b}_{q}^{v}$$

can be identical to b_{q} and correspond to the elements in b_{q} that related to variable-duration and fixed-duration, respectively. The same can be true for

$${b}_{u}^{f}$$

and

$${b}_{u}^{v} .$$

$${X}_{\text{sub}} ∈ {ℝ}^{2 \left({\sum }_{j} \left|{\tilde{I}}_{j}\right| + {\sum }_{j} {max}_{j} \left|{I}_{j}^{\text{pd}}\right|\right) \times \left|w i p\right|} -$$

A sub-day level inventory of WIP products at each timestamp.

$$t ∈ {ℝ}^{2 \left({\sum }_{j} \left|{\tilde{I}}_{j}\right| + {\sum }_{j} {max}_{j} \left|{I}_{j}^{\text{pd}}\right|\right)} -$$

Each material balance check-point in a day, which can represent a start and an end of each task performed on that day.

### Example Formulation of Planning Stage

During the first stage (the planning stage 1306) of the production schedule optimization process, an optimal schedule for all dates within a planning horizon H can be produced, which can be accomplished by grouping production of each finished good into as few dates as possible while accounting for the availability of raw materials, shelf life constraints, etc. The following formulation defines an example optimization problem that may be used during the planning stage 1306 of the production schedule optimization process.

$$\begin{matrix}{\text{minimize}}_{\begin{matrix}Y , X , A , {B}_{r 0} , {B}_{x} , {B}_{f} , W , {D}_{min} , \\ {D}_{0} , {A}_{r 0} , N , {e}_{i f} , {ε}_{\text{n0l}} , {ε}_{o}\end{matrix}} {λ}_{1} {d}_{H}^{T} Y {1}_{\left|t a s k\right| , \left|t a s {k}_{\text{prod}}\right|} + {λ}_{2} {d}_{H}^{T} \left({B}_{v} + {B}_{f}\right) {1}_{\left|t a s k\right| , \left|t a s {k}_{\text{prod}}\right|} \\ + {λ}_{3} {d}_{H}^{T} {ε}_{\text{mi}} {1}_{\left|{f}_{f f \text{stk}}\right|} + {λ}_{4} {d}_{H}^{T} {ε}_{s s} {1}_{\left|f {g}_{\text{sik}}\right|} \\ + {λ}_{5} {\sum }_{k ∈ {K}_{0}} {d}_{H}^{T} {D}_{\text{miss,} k} ⋅ {c}_{D , k} \\ + {λ}_{6} {\sum }_{m ∈ r a w} {d}_{H}^{T} A {R}_{\text{in}}^{m} \\ \text{+} {λ}_{7} {\sum }_{s = 1}^{ξ} {d}_{H}^{T} {ε}_{\text{ot}} \left|s , : , :\right| {1}_{\left|u n i t\right|} \\ \text{+} {λ}_{8} {\sum }_{s = 1}^{ξ} {d}_{H}^{T} \left({ζ}_{\text{ot}} \left[s , : , :\right] ⊙ {c}_{\text{ot}} \left[s , : , :\right]\right) {1}_{\left|u n i t\right|} \\ + {λ}_{9} {d}_{H}^{T} {W}_{{c}_{W}} + {λ}_{10} {d}_{H}^{T} {D}_{0} {1}_{\left[m a t\right]} \\ + {λ}_{11} {d}_{H}^{T} {A}_{r 0} {1}_{\left[m a t\right]} + {λ}_{12} {d}_{H}^{T} Y {c}_{p} \\ + {λ}_{13} {d}_{H}^{T} {P}_{o c o} {1}_{\left|\text{p} u n i t s\right|} + {λ}_{14} {d}_{H}^{T} {O}_{l p , m} {1}_{\left[m a t\right]}\end{matrix} \qquad \text{(1a)}$$

$$\begin{matrix}\text{subject to} {P}_{\text{pw}}^{m} ⊙ {X}^{m} = {P}_{\text{pw}}^{m} ⊙ {Δ}^{- 1} \left({X}_{0}^{m} + {O}_{l p , m}^{m} + {N}^{m} - {\sum }_{k ∈ {K}_{c}} {D}_{k}^{m} +\right) \\ \left({\sum }_{k ∈ {K}_{c}} {D}_{\text{miss,} k}^{m}\right) , ∀ m ∈ m a t\end{matrix} \qquad \text{(1b)}$$

$$\begin{matrix}{N}^{m} = {L}_{g r \left(m\right)} A {R}_{\text{out}}^{m} - {\sum }_{i ∈ \text{in} \left(m\right)} {\tilde{L}}_{b l t \left(i , m\right)} A \left[: , i\right] {R}_{\text{in}} \left[i , m\right] - {W}^{m} + \\ {A}_{r 0}^{m} + {L}_{g r \left(m\right)} \left({A}_{r}^{m} - {A}_{r 0}^{m}\right) , ∀ m ∈ m a t\end{matrix} \qquad \text{(1c)}$$

$$\begin{matrix}{X}_{\text{true}}^{m} = {Δ}^{- 1} \left(\left({1}_{H} {X}_{0}^{m}\right) {e}_{1} + {O}_{l p , m}^{m} + A {R}_{\text{out}}^{m} - A {R}_{\text{in}} - {W}^{m} + {A}_{r}^{m}\right) \\ \left(- {\sum }_{k ∈ {K}_{c}} {D}_{k}^{m} + {\sum }_{k ∈ {K}_{c}} {D}_{\text{miss} , k}^{m}\right) , ∀ m ∈ m a t\end{matrix} \qquad \text{(1d)}$$

$$\begin{matrix}{Δ}^{- 1} \left(A {R}_{\text{in}}^{m} + {\sum }_{k ∈ {K}_{c}} {D}_{k}^{m} - {\sum }_{k ∈ {K}_{c}} {D}_{\text{miss,} k}^{m} + {W}^{i n}\right) \geq \\ {Δ}^{- 1} \left({L}_{s l \left(m\right)} A {R}_{\text{out}}^{m} + {Z}^{m} + {L}_{s l \left(m\right)} {A}_{r}^{m} + {L}_{s l \left(m\right)} {O}_{l p , m}^{m}\right) . \\ ∀ m ∈ m a t\end{matrix} \qquad \text{(1e)}$$

$${D}_{0} = max \left(0 , {\sum }_{k ∈ {K}_{c}} {D}_{k} - {\sum }_{k ∈ {K}_{c}} {D}_{\text{miss,} k} - \left({L}_{1} X + {X}_{0}\right)\right) \qquad \text{(1f)}$$

$${X}_{\text{prior}}^{m} = {Δ}^{- 1} \left({e}_{1} {X}_{0}^{m} \left[0 , :\right] + {N}_{\text{prior}}^{m}\right) \qquad \text{(1g)}$$

$${N}_{\text{rior}}^{m} = - {\sum }_{i ∈ \text{in} \left(m\right)} {L}_{b l t \left(i , m\right) + d n g} A \left[: d n g , i\right] {R}_{\text{in}} \left[i , m\right] \qquad \text{(1h)}$$

$$A - {M}_{\text{rv}} ⊙ {B}_{r} = 0 \qquad \text{(1i)}$$

$${A}_{\text{mo}} \left[: , i , j\right] = \frac{1}{\left|{J}_{i}\right|} A \left[: , i\right] , ∀ i , ∀ j \qquad \text{(1j)}$$

$${A}_{\text{mo}} - {M}_{\text{max}}^{\text{f}} ⊙ {B}_{\text{f}} \leq 0 \qquad \text{(1k)}$$

$${A}_{\text{mo}} - {M}_{\text{min}}^{\text{f}} ⊙ {B}_{\text{f}} \geq 0 \qquad \text{(1l)}$$

$${A}_{\text{mo}} - {M}_{\text{max}}^{\text{v}} ⊙ {B}_{\text{v}} \leq 0 \qquad \text{(1m)}$$

$$A - M Y \leq 0 \qquad \text{(1n)}$$

$$Y Π \leq {J}_{H \times \left|e x c l u s i v e s e t\right|} \qquad \text{(1o)}$$

$$\begin{matrix}\left({A}_{\text{mo}} \left[: , {I}_{j}^{\text{v}} , j\right] ⊙ {C}^{\text{v}} \left[: , {I}_{j}^{\text{v}} , j\right]\right) ⊙ Ω \left[s , : , {I}_{j}^{\text{v}}\right] \\ + \left({B}_{\text{f}} \left[: , {I}_{j}^{\text{f}} , j\right] ⊙ {C}^{\text{f}} \left[: , {I}_{j}^{\text{f}} , j\right]\right) ⊙ Ω \left[s , : , {I}_{j}^{\text{f}}\right] \\ + {P}_{\text{pd}} \left[s , : , j\right] + \left({t}_{\text{est}} \left[: , {I}_{j}\right] ⊙ Y \left[: , {I}_{j}\right] ⊙ Ω \left[s , : , {I}_{j}\right]\right) \\ \leq {n}^{s} \left[s , : , j\right] + {ε}_{\text{ot}} \left[s , : , j\right] ∀ j , s\end{matrix} \qquad \text{(1p)}$$

$$\begin{matrix}\left({A}_{\text{mo}} \left[: , {I}_{j}^{\text{v}} , j\right] ⊙ {C}^{\text{v}} \left[: , {I}_{j}^{\text{v}} , j\right]\right) ⊙ Ω \left[s , : , {I}_{j}^{\text{v}}\right] \\ + \left({B}_{\text{f}} \left[: , {I}_{j}^{\text{f}} , j\right] ⊙ {C}^{\text{f}} \left[: , {I}_{j}^{\text{f}} , j\right]\right) ⊙ Ω \left[s , : , {I}_{j}^{\text{f}}\right] \\ + {P}_{\text{pd, max}} \left[s , : , j\right] + \left({t}_{\text{est}} \left[: , {I}_{j}\right] ⊙ Y \left[: , {I}_{j}\right] ⊙ Ω \left[s , : , {I}_{j}\right]\right) \\ \leq {n}^{\text{max}} \left[s , : , j\right] ∀ j , s\end{matrix} \qquad \text{(1q)}$$

$${ε}_{\text{ot}} \left[: , d , :\right] - M {ζ}_{\text{ot}} \left[: , d , :\right] \leq 0 ∀ d \qquad \text{(1r)}$$

$$Y \left[t - 1 , i\right] + Y \left[t , {i}^{′}\right] - 1 \leq {P}_{o c o} \left[t , j\right] ∀ \left(i , {i}^{′}\right) ∈ t a s k {s}_{o c {o}_{j}} \qquad \text{(1s)}$$

The following auxiliary constraints may be associated with the objective function of Equation (1a).

$${\sum }_{\begin{matrix}i ∈ {I}_{j} , \\ i ∉ {I}_{j}^{\text{md}}\end{matrix}} Y \left[d , i\right] \leq M \left(1 - {\sum }_{i ∈ {I}_{j}^{\text{md}}} {\sum }_{\begin{matrix}{d}^{′} = max \left(0 ,\right) \\ \left(d - {C}_{\text{md}} \left[i , j\right] + 1\right)\end{matrix}}^{d} Y \left[{d}^{′} , i\right]\right) , ∀ j , ∀ d \qquad \text{(2a)}$$

$$A ⊙ Φ = 0 \qquad \text{(2b)}$$

$$A - Y ⊙ V \geq 0 \qquad \text{(2c)}$$

$${P}_{\text{lp,p}}^{\text{v}} ⊙ \left(A - {O}_{\text{lp,p}}^{\text{v}}\right) = 0 \qquad \text{(2d)}$$

$${P}_{\text{lp,p}}^{\text{f}} ⊙ \left({B}_{\text{f}} - {O}_{\text{lp,p}}^{\text{f}}\right) = 0 \qquad \text{(2e)}$$

$${O}_{l p , m}^{m} \leq {P}_{l p , m}^{m} \qquad \text{(2f)}$$

$${D}_{\text{miss,} k} \leq {D}_{k} , ∀ k ∈ {K}_{c} \qquad \text{(2g)}$$

$${X}_{\text{true}}^{m} + {ε}_{\text{ss}}^{m} \geq {I}_{\text{ss}}^{m} ∀ m ∈ p r o {d}_{\text{MTS}} \qquad \text{(2h)}$$

$${X}_{\text{true}}^{m} + {ε}_{\text{mi}}^{m} \geq {I}_{\text{mi}}^{m} ∀ m ∈ p r o {d}_{\text{MTS}} \qquad \text{(2i)}$$

$${ε}_{\text{mi}}^{m} \leq {X}_{\text{true}}^{m} ∀ m ∈ p r o {d}_{\text{MTS}} \qquad \text{(2j)}$$

$${A}_{r 0} \leq {A}_{r} \qquad \text{(2k)}$$

$${W}^{m} = 0 , ∀ m ∈ p r o {d}_{\text{std}} \qquad \text{(2l)}$$

$$Ω \left[: , d , :\right] = {Ω}_{0} , ∀ d \qquad \text{(2m)}$$

$$X , {X}_{\text{true}} , {X}_{\text{prior}} , A , {A}_{r 0} , {ε}_{\text{ot}} , {ε}_{\text{mi}} , {ε}_{\text{ss}} , W , {D}_{\text{miss}} \geq 0 \qquad \text{(2n)}$$

Note that matrices and tensors are often sliced in the equations above. It can be assumed that the dimensions of each matrix or tensor will be reduced if only one slice is picked from any axis For example, if M ∈ ℝ^{A×B×C} and i is an index (i ≤ B), M[:, i, :] ∈ ℝ^{A×C}. As noted above, matrices of the form Lₖ ∈ ℝ^{H×H} are lower shift matrices, where the element Lₖ[i,j] = δ_{i,j+k} such that (LₖA)[i,j] = A[i-k,j]. Note here that the positive or negative sign on k determines in which direction the matrix shifts (upper or lower). The notation

$${\tilde{L}}_{k} ∈ {ℝ}^{H \times H}$$

is a slight variation of Lₖ that fills the first abs(k) columns in the first row with ones. The following demonstrates L̃₋₁ when H = 4.

$$\begin{matrix}I = \left[\begin{matrix}1 & 0 & 0 & 0 \\ 0 & 1 & 0 & 0 \\ 0 & 0 & 1 & 0 \\ 0 & 0 & 0 & 1\end{matrix}\right] , \\ {L}_{- 1} = \left[\begin{matrix}0 & 1 & 0 & 0 \\ 0 & 0 & 1 & 0 \\ 0 & 0 & 0 & 1 \\ 0 & 0 & 0 & 0\end{matrix}\right] , \\ {\tilde{L}}_{- 1} = \left[\begin{matrix}1 & 1 & 0 & 0 \\ 0 & 0 & 1 & 0 \\ 0 & 0 & 0 & 1 \\ 0 & 0 & 0 & 0\end{matrix}\right] ,\end{matrix} \qquad \text{(3)}$$

The ⊙ operator represents a Hadamard product, which performs element-wise multiplication between two matrices Note that if a material m can only come from one specific task i, some specific gr(m) information (such as “micro-hold”) can come from the associated task i. The notation Iⱼ represents a set (or equivalently a list of indices) of all tasks i’s that can be performed on a processing unit j. Similarly, the notations

$${I}_{j}^{v}$$

and

$${I}_{j}^{f}$$

respectively represent the set of variable-duration operations and the set of fixed-duration operations that can be performed on the processing unit j. The notations i and I in general represent tasks; however, once a set Iⱼ (which is a set of tasks associated with a processing unit) is defined, that set of tasks is equivalent to operations under that processing unit. In the matrix expressions, a set and a list of indices are used interchangeably. The notation

$${I}_{j}^{m d}$$

denotes the set of tasks on the processing unit j that require multiple days to complete.

An exclusive task set (exclusiveset) includes one or more sets of tasks where only one of the tasks in a set can be performed on any given day. In some cases, these task sets may be constructed using “same-day disallowed” changeovers between tasks For example, if one task i produces chicken and a second task j produces beef and these two products cannot be produced on the same day, the set exclusiveset may contain an entry (i, j), and the corresponding column of Π will contain ones in rows i and j and zeros everywhere else. In many cases, only pairs of tasks may be considered, so the length of each entry in exclusiveset may be two. However, no changes to the formulation would be needed to consider larger groups of exclusive tasks. In practice, increasing the size of each exclusive set and reducing the total length of exclusiveset can sometimes improve optimization performance. A set of ordered task pairs tasks_{ocoⱼ} can represent a set of ordered pairs of tasks (tuples) that indicate an objective penalty should exist on those two tasks if they are done in consecutive timestamps. For instance, if the tuple (i, i′) ∈ tasks_{ocoⱼ}, this implies that both tasks i and i′ are members of the processing unit j, and (if task i is performed the day before task i′) an overnight changeover objective penalty should be added. It may be assumed that tasks_{ocoⱼ}⊆ exclusiveset or (if an ordered task pair has an overnight changeover) that it must also be same-day exclusive.

In the optimization problem of Equations (1a)-(1s), the cost function in Equation (1a) includes fourteen terms. The first and second terms ensure that production is grouped and penalizes spreading production across days, across legs, and across processing units. The third and fourth terms penalize an MTS material that is higher than the maximum inventory level or lower than the minimum inventory level. The fifth term penalizes missing demand, where missed demand for each finished good carries a different cost (which may be specified by C_{D}). The sixth term penalizes the use of raw materials. The seventh and eighth terms penalize overtime production on each processing unit and over the weekends, respectively. The ninth term penalizes waste of materials, where the waste of each material may carry a different cost (which may be specified by C_{W}). The tenth term penalizes same-day shipment, the eleventh term penalizes off-the-truck arrivals, and the twelfth term penalizes production with recipes of lower priority. The thirteenth term penalizes overnight changeovers on a processing unit, and the fourteenth term penalizes locked puck input materials’ material balance slack variables.

The constraints in Equations (1b) and (1d) denote the material balance of the materials over the horizon. The constraint in Equation (1c) defines the net production, and the constraint in Equation (1e) defines the behavior of wasted materials. The constraint in Equation (1f) defines the same-day shipment, and the constraint in Equation (1g) denotes the material balance in the period prior to day 0 of the optimization. The constraint in Equation (1h) defines the net production in the period prior to day 0 of the optimization, and the constraint in Equation (1i) defines the rounding value of the quantities of the materials that can be produced on each day The constraint in Equation (1o) ensures that, for each set of tasks that cannot be performed on the same day, a maximum of one of the tasks is performed on each day. The soft constraint in Equation (1p) ensures the capacity constraint of the processing unit is kept unless there is a need to introduce additional capacity through overtime production, and the constraint in Equation (1q) ensures that even overtime production does not take capacity past its absolute physical limit (such as a limit of 24 hours per day or until the next shift starts). Note that those two constraints can be applied for each of the shift combinations. The constraint in Equation (1s) enforces overnight changeovers between tasks sharing the same processing unit that preferably are not run on consecutive days If a processing unit performs such a sequence of actions, the P_{oco} variable for that processing unit’s day can trigger an objective penalty.

Within the auxiliary constraints of Equations (2a) through (2n), the constraint in Equation (2a) enforces the limitation on multi-day production processes. The constraint in Equation (2b) allows a user to apply configurable planning rules, and the constraint in Equation (2c) defines the minimum lot size for production. The constraint in Equation (2g) indicates that missed demand for MTO material cannot exceed the actual demand for the material on that day. The constraints in Equations (2h)-(2j) set the limit on maximum and minimum inventory and define the behavior of the slack variables ∈ₘᵢ and ∈ₛₛ for MTS materials. The constraint in Equation (2ℓ) enforces the waste of standard materials (those materials are made-up and do not physically exist) to be zero. Finally, the constraint in Equation (2n) enforces that all decision variables take values greater than or equal to zero.

By solving the optimization problem as defined in Equations (1a)-(1s) and (2a)-(2n), it is possible to use A as the production quantities for each task for each day of the horizon. As a result, solving for A can be performed to complete the planning stage 1306 of the production schedule optimization process Depending on the implementation, in some embodiments, a solution for A can be generated using an off-the-shelf optimization solver or other optimization solver. This enables the subsequent scheduling stage 1308 to solve the scheduling problem for each day of the horizon, which in some cases can be performed independently and in parallel.

Note that it is possible to extend the PSO formulation defined above to handle transportation between multiple facilities, including production facilities (PFs) and distribution centers (DCs) For example, the PSO formulation defined above can be extended to handle transportation requirements such as stock transfer orders (STOs), as-your-ship (AYS, also referred to as demand-push), and demand-pull. The optimization results on transportation can be stored as stock transfer requests (STRs). Depending on the implementation, arbitrary transportation of materials between production facilities may or may not be supported, and there may or may not be support for more than two layers of chained distribution centers. Moreover, it may or may not be possible to ship excessive initial inventory accumulated on day 0 during the optimization run. If not, it may be possible to overcome this limitation by running rule-based pre-processing of the initial inventory to ship excessive initial inventory to a reasonable storage location before the optimization run.

One possible use of the transportation extension is to create “dummy” tasks to represent transportation activities and create copies of “dummy” materials to represent the same material at different locations and with various statuses. Tracking materials at different locations separately makes it easier to represent transportation by recipes, such as a task with a recipe of consuming material at a production facility and producing material at a distribution center that is intuitively a transportation lane carrying the material from the production facility to the distribution center. The need for tracking materials in the same facility with various statuses may be less obvious. In some cases, various statuses of the same material can be designed to ensure that shelf-life and expiration logic are honored both before and after transportation. For example, for a regular production task that consumes a WIP product and produces a finished good, the tracking of the shelf-life for the produced finished good can start at zero on the date of production. For a transportation task that consumes a finished good at a production facility and produces a finished good at a distribution center (after the finished good has already stayed at the production facility for two days before the shipment), tracking the shelf-life for the finished good at the distribution center cannot start at zero The description further below describes in full detail how the consistency of shelf-life can be ensured.

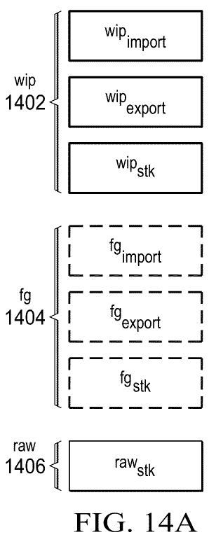

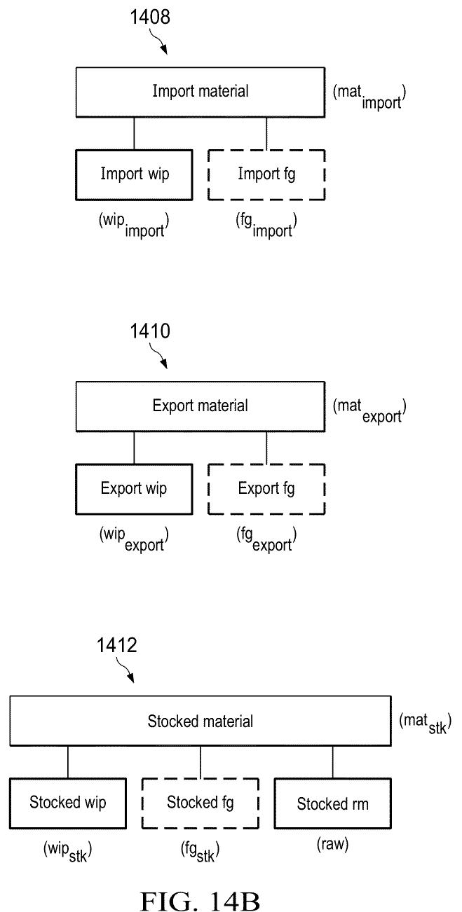

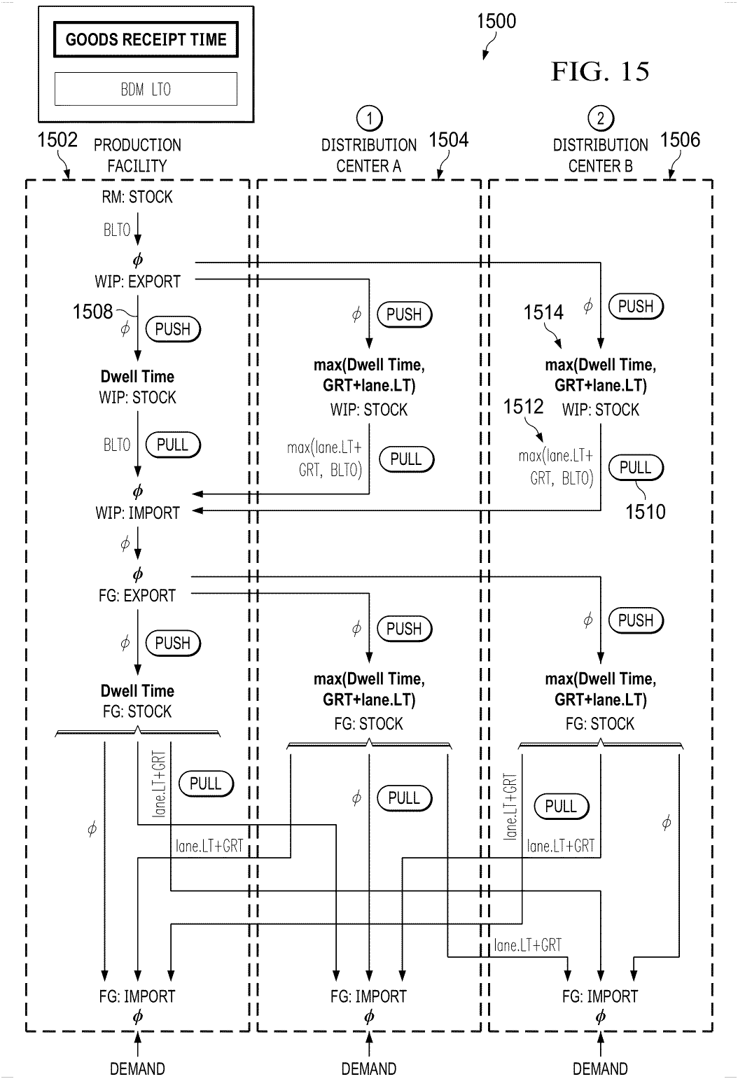

FIGS. 14A and 14B illustrate examples of various statuses defined for materials to support transportation considerations in the RTN-based templated PSO framework according to this disclosure. As shown in FIG. 14A, original WIP products can have three copies 1402 to track three different statuses (namely IMPORT, EXPORT, and STOCK) in different facilities, and FG products can have three copies 1404 to track three different statuses (namely IMPORT, EXPORT, and STOCK) in different facilities. In some cases, raw materials cannot be shipped, so there may only be one copy 1406 of the raw material status (STOCK) in a production facility For example, in a setup where there is one production facility (PF) and two distribution centers (denoted DC1 and DC2), a WIP material can be represented by a few copies of dummy materials (such as WIP PF STOCK, WIP PF EXPORT, WIP PF IMPORT, WIP DC1 STOCK, and WIP DC2 STOCK). Note that all of these dummy copies represent the same material (the WIP material). Similarly, a finished good can be represented by a few copies of dummy materials (such as FG PF EXPORT, FG PF STOCK, FG PF IMPORT, FG DC1 STOCK, FG DC2 STOCK, FG DC l IMPORT, and FG DC1 IMPORT). The examples of the copies here are aligned with the demonstration in FIG. 15, where it is explained why these copies are created. As shown in FIG. 14B, using these definitions of import, export, and stock, a definition 1408 can define imported material (matᵢₘₚₒᵣₜ) as the combination of imported WIP products (wipᵢₘₚₒᵣₜ} and imported FG products (fgᵢₘₚₒᵣₜ). Also, a definition 1410 can define exported material (matₑₓₚₒᵣₜ) as the combination of exported WIP products (wipₑₓₚₒᵣₜ) and exported FG products (fgₑₓₚₒᵣₜ). In addition, a definition 1412 can define stocked material (matₛₜₖ) as the combination of stocked WIP products (wipₛₜₖ), stocked FG products (fgₛₜₖ), and stocked raw materials (raw).

Transportation tasks and dummy materials can be naturally incorporated into the objective formulation by extending the dimensions of the matrices involved. For example, the set task and the set mat can be extended in the following manner.

$$t a s k = t a s {k}_{\text{prod}} ∪ t a s {k}_{\text{trans}} \qquad \text{(4)}$$

$$f g = f {g}_{\text{stk}} ∪ f {g}_{\text{import}} ∪ f {g}_{\text{export}} \qquad \text{(5)}$$

$$w i p = w i {p}_{\text{stk}} ∪ w i {p}_{\text{import}} ∪ w i {p}_{\text{export}} \qquad \text{(6)}$$

$$r a w = r a {w}_{\text{stk}} \qquad \text{(7)}$$

Here, the set of finished goods (fg) now includes the set of stocked finished goods (fgₛₜₖ), the set of imported finished goods (fgᵢₘₚₒᵣₜ), and the set of exported finished goods (fgₑₓₚₒᵣₜ). The same is true for the WIP materials Note that fgₛₜₖ includes stock finished goods across all facilities (such as FG PF STOCK and FG DC1 STOCK in the previous example). Also note that all original finished goods may have at least a copy of fgₛₜₖ since they will have to be stocked somewhere. However, whether the finished goods will have copies of imported/exported finished goods depends on whether there are transportation lanes for those finished goods. The set of tasks now includes both the regular production tasks (task_{prod}) and the transportation tasks (taskₜᵣₐₙₛ).

FIG. 15 illustrates an example setup 1500 showing how additional transportation tasks can be added and connected to “dummy” materials during production schedule optimization according to this disclosure. In this simplified example setup 1500, there are assumed to be three facilities, namely one production facility 1502 and two distribution centers 1504 and 1506. Dummy materials are represented using notations like “RM: STOCK”, “WIP: STOCK”, “FG: STOCK”, “WIP: EXPORT”, “WIP: IMPORT”, “FG: EXPORT”, and “FG: IMPORT”

Arrows 1508 connecting these dummy materials represent production, transportation, or other tasks. Some of the arrows 1508 point from/to materials within the same facility, and these arrows 1508 represent production tasks (such as RM ----> WIP or WIP ----> FG) or trivial tasks that transit the status of the material (such as WIP:EXPORT → WIP:STOCK or WIP:STOCK ⇢ WIP:IMPORT). Other arrows 1508 connect materials from different facilities, and these arrows 1508 represent transportation tasks. Note that transportation tasks may connect materials of the same type (such as WIP → WIP or FG → FG) with different statuses, which is expected since a material (such as a WIP) cannot be transported from one facility to another facility and become a different material (such as an FG).

“Push” and “pull” indicators 1510 next to the transportation arrows 1508 in FIG. 15 represent the types of transportation that are supported. A “push” indicator 1510 for a transportation arrow 1508 may represent an as-your-ship (AYS) shipment, while a “pull” indicator 1510 for a transportation arrow 1508 may represent a demand-pull. Labels 1512 next to the transportation arrows 1508 represent BOM lead time offsets (BOM LTOs or BLTOs) associated with material-task pairs, while labels 1514 next to the materials represent good receipt times (GRTs) associated with the materials. One goal of the illustrated approach in FIG. 15 is to assign appropriate BLTO and GRT values to each task and material in order to ensure that corresponding expiration constraints (such as shelf-life constraints) can be honored.

In some embodiments, all EXPORT and IMPORT dummy materials may not have positive inventory. That is, all of these dummy materials may need to be consumed (not wasted) immediately on the date of production in order to keep the end-of-day inventory to be exactly zero In these embodiments, only STOCK materials may have positive inventory levels (which is where the description “STOCK” comes from). Also note that tasks to convert the same material between different statuses may not be attached to any processing units in the production facility 1502, which make sense since those tasks are either just for bookkeeping purposes or only utilize transportation lanes.

In the top potion of FIG. 15, there is a raw material RM in the production facility 1502 (which defaults to “RM:STOCK” since it cannot be shipped). RM:STOCK can be used to produce WIP:EXPORT. where the arrow 1508 connecting those two materials is a production task (which has a regular BLTO). However, the GRT for WIP:EXPORT is set to zero, which supports the intention to convert WIP:EXPORT into WIP:STOCK immediately after its production. Following WIP:EXPORT, there are three “push” tasks converting WIP:EXPORT to WIP:STOCK at various locations, after which there are three “pull” tasks converting them to WIP:IMPORT. This is an example that represents a setting where a distribution center can temporarily store excessive WIP material produced by the production facility 1502 and can ship the WIP material back to the production facility 1502, such as upon the need of producing the downstream FGs. However, this ability is not necessarily required.

Notice that the BLTOs for all push tasks are set to zero. Also, the GRTs on the output materials are used to track the transportation lead times, the specific GRTs on the recipient facilities (which differ from the GRTs used in the formulation), or the dwell time. Further, notice that the GRTs on WIP:IMPORT tasks are set to zero for all pull tasks, and the BLTOs are used to track the transportation lead times and the specific GRTs on the recipient facilities. One reason for modeling these “lagging times” in this manner is because no inventory may be kept for EXPORT or IMPORT materials. Each task (arrow 1508) that connects WIP:IMPORT and FG:EXPORT is a production task. Note that FG:EXPORT may have zero days of BLTO or GRT since neither WIP:IMPORT nor FG:EXPORT may be stocked. Push tasks that transport FG:EXPORT to each of the facilities resembles those tasks for WIP:EXPORT.

At the bottom of FIG. 15, the FG:STOCK can be converted to FG:IMPORT before being used to satisfy customer demand. The transition from FG:STOCK to FG:IMPORT represents the fact that the objective formulation can support demand-pull for the FG This mechanism can be useful, such as when there is misplaced FG inventory on day 0. Note that the setup 1500 in FIG. 15 represents a specific business scenario. Should the business scenario change, the system can still be accurately modeled by (among other things) adding or removing push/pull tasks in the system The framework is also extensible to handle multiple DC-to-DC and PF-to-PF transportations, and more complicated networks may also be supported.

While converting the transportation extension into a suitable formulation, various structures and values may be introduced into the matrices along with some additional constraints For example, the good receipt time for a stocked material m can satisfy the following.

$$g r \left(m : \text{STOCK}\right) = \left\{\begin{matrix}max \left(G R T \left(\text{facility}\right) + L T \left(\text{lane}\right) , D T \left(m\right)\right) \\ ∀ m \text{if} m \text{can be generated by push tasks} \text{.} \\ \text{0} ∀ m \text{if} m \text{can be generated by pull tasks,} \\ \text{or transportation within same facility,} \\ D T \left(m\right) ∀ m \text{otherwise} \text{.}\end{matrix}\right) \qquad \text{(8)}$$

Here, m represents the original material before being copied as a dummy material, and m : STOCK represents the stocked dummy material. The notation gr(.) represents the GRT in the formulation (which is a data field in the model), and GRT(facility) represents the good receipt time associated with a facility (which is in the input data). The notation LT(lane) denotes the lead time on the transportation lane, and DT (·) represents the dwell time for the material. The BLTO (such as blt(·,·)) for taskₜᵣₐₙₛ can be expressed as follows.

$$\begin{matrix}b l t \left(i , m : \text{IMPORT}\right) = \left\{\begin{matrix}max \left(G R T \left(\text{facility}\right) + L T \left(\text{lane}\right) ,\right) \\ \left(B L T O \left(i , m\right)\right) ∀ m \text{if} m \text{can be} \\ \text{generated by pull tasks,} \\ \text{0} ∀ m \text{if} m \text{can be generated by push} \\ \text{tasks, or transportation within same} \\ \text{facility,} \\ B L T O \left(i , m\right) ∀ m \text{otherwise} \text{.}\end{matrix}\right) \\ ∀ i ∈ t a s {k}_{\text{trans}}\end{matrix} \qquad \text{(9)}$$

Here, m represents the original material before being copied as a dummy material, and m : IMPORT represents the imported dummy material. The notation blt(·,·) represents the BLTO in the formulation (which is a data field in the model), and BLTO(i, m) represents the BLTO associated with the original material and task (which is in the input data) The notation LT(lane) again denotes the lead time on the transportation lane.

Note that the rounding value, minimum and maximum lot sizes, and minimum and maximum batch sizes for the dummy tasks associated with transportation can be set to zero. This may be expressed as follows

$${M}_{\text{rv}} \left[: , i\right] = 0 , ∀ i ∈ t a s {k}_{\text{trans}} \qquad \text{(10)}$$

$${M}_{\text{max}}^{f} \left[: , i , j\right] = 0 , ∀ i ∈ t a s {k}_{\text{trans}} \qquad \text{(11)}$$

$${M}_{\text{min}}^{f} \left[: , i , j\right] = 0 , ∀ i ∈ t a s {k}_{\text{trans}} \qquad \text{(12)}$$

$${M}_{\text{max}}^{v} \left[: , i , j\right] = 0 , ∀ i ∈ t a s {k}_{\text{trans}} \qquad \text{(13)}$$

$$V \left[: , i\right] = 0 , ∀ i ∈ t a s {k}_{\text{trans}} \qquad \text{(14)}$$

These constraints can therefore be ignored by an optimizer. The time cost C can also be set to zero for shadow tasks, which can be expressed as follows

$$C \left[: , i , :\right] = 0 , ∀ i ∈ t a s {k}_{\text{trans}} \qquad \text{(15)}$$

In addition, the recipe matrices Rᵢₙ and Rₒᵤₜ can be expanded to represent the recipes of the transportation tasks (such as when an element will be set to one on the “ship from” dummy material in Rᵢₙ and set to one on the “ship to” dummy material in Rₒᵤₜ). Additional constraints may be used to enforce the fact that IMPORT and EXPORT materials cannot have positive end-of-day inventories, which in some cases can be expressed as follows.

$$X \left[: , m\right] = 0 , ∀ m ∈ \left\{f {g}_{\text{export}} , f {g}_{\text{import}} , w i {p}_{\text{export}} , w i {p}_{\text{import}}\right\} \qquad \text{(16a)}$$

$$W \left[: , m\right] = 0 , ∀ m ∈ \left\{f {g}_{\text{export}} , f {g}_{\text{import}} , w i {p}_{\text{export}} , w i {p}_{\text{import}}\right\} \qquad \text{(16b)}$$

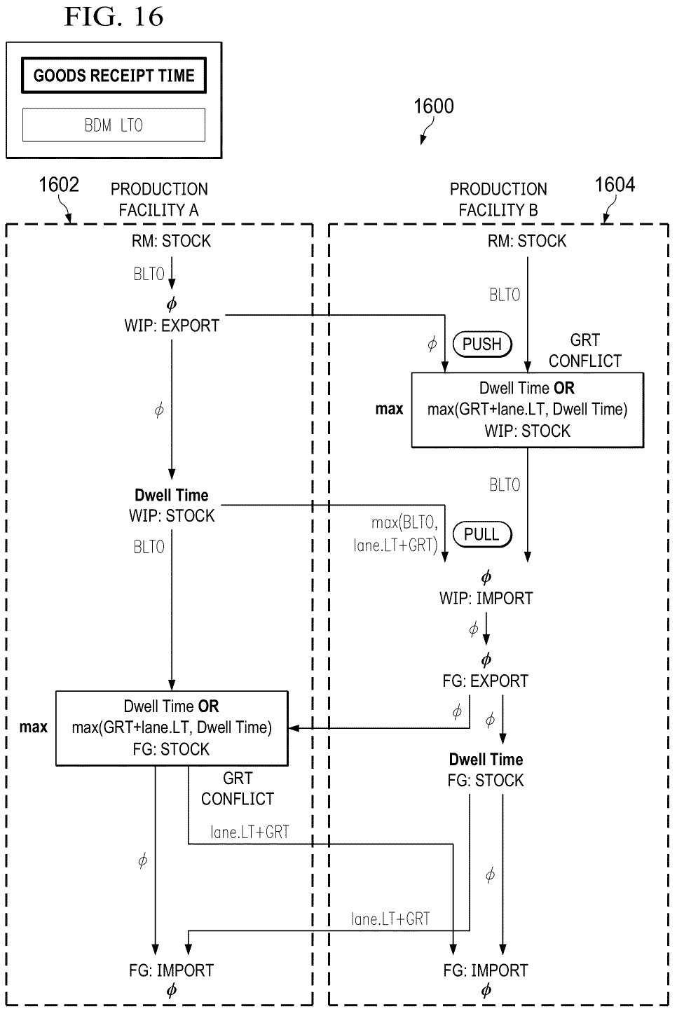

FIG. 16 illustrates an example setup 1600 showing how additional transportation tasks can be added and connected to “dummy” materials during production schedule optimization when considering stock transportation between production facilities according to this disclosure. The layout of FIG. 16 is designed to support both pull and push transportations of WIP materials from one facility 1602 to another facility 1604. As shown in FIG. 16, there could be a conflict when calculating the GRT of WIP:STOCK at the second facility 1604 Since the GRT may be modeled as an attribute of the material (instead of as an attribute on the task-material pair), the GRT on WIP:STOCK may not differentiate whether it is generated by WIP:EXPORT or RM:STOCK. The GRT is equal to the dwell time if it is generated by RM:STOCK or equal to max(GRT + LT, dwell time) if it is generated by WIP:EXPORT (where LT denotes the lead time on a transportation lane). To resolve this conflict on GRT, one approach can use the larger one from the two options, which collapses to max(GRT + LT, dwell time). This solution may be overly conservative for the production task (RM:STOCK → WIP:STOCK) when the sum of GRT and LT is larger than the dwell time, which may result in a slightly sub-optimal solution. A similar GRT conflict-resolving mechanism can be applied to any materials that can be generated by both production and transportation tasks. Note that the above conflict may not happen if there is not WIP transportation between production facilities.

Although FIGS. 14A and 14B illustrate examples of various statuses defined for materials to support transportation considerations in the RTN-based templated PSO framework and FIGS. 15 and 16 illustrate examples of setups showing how additional transportation tasks can be added and connected to “dummy” materials during production schedule optimization, various changes may be made to FIGS. 14A through 16. For example, the specific statuses and specific setups can easily vary based on the particular details of a given application or use case.

Returning to the optimization problem of Equations (1a)-(1s) above, shift scheduling constraints for the planning stage 1306 are expressed in Equations (1p) and (1q). These constraints can be enforced via the concept of “shift combination.” As noted above, ξ represents the maximum number of shifts that can happen across all processing units within the planning horizon. The total number of “shift combinations” is denoted as η, which can be expressed as follows.

$$η = {2}^{ξ} - 1 \qquad \text{(17)}$$

If a matrix Γ ∈ {0, 1}^{ξx|task|} is used to denote whether a task i can be performed on a shift s, a simple example with ξ ::: 3 and |task| ::: 3 can be defined as follows.

$$Γ = \begin{matrix} & \begin{matrix}{t}_{1} & {t}_{2} & {t}_{3}\end{matrix} \\ \begin{matrix}{S}_{1} \\ {S}_{2} \\ {S}_{3}\end{matrix} & \left[\begin{matrix}1 & 0 & 0 \\ 0 & 1 & 1 \\ 0 & 1 & 0\end{matrix}\right]\end{matrix} ∈ {ℝ}^{3 \times 3} \qquad \text{(18)}$$

The first column of the matrix Γ indicates that a task t₁ can only be performed during a shift S₁. The second column of the matrix indicates that a task t₂ can either be performed during a shift S₂ or S_{3.} The third column of the matrix indicates that a task t₃ can only be performed during a shift S_{2.}

Based on the definition above, it is possible to consider whether tasks can be performed in any combination of shifts (such as whether the task t₁ can be performed during either shift S₁ or S₂). If all possible combinations of shifts are examined, there will be at most 2^{ξ} combinations. However, since the scenario of empty combinations is not considered, 2^{ξ} - 1 (meaning η combinations remain. Here, the shift combination matrix Ω₀ ∈ {0, 1}^{(2 - 1)×|task|} may be defined as follows.

$${Ω}_{0} \left[s , i\right] = \left\{\begin{matrix}1 , & \text{(19)} i \text{should be considered in shift combination} s , \\ 0 , & \text{otherwise} \text{.}\end{matrix}\right)$$

Following the example of Γ ∈ R^{3x3} above, the corresponding shift combination matrix Ω₀ ∈ R^{7x3} can be expressed as follows

$${Ω}_{0} = \begin{matrix} & \begin{matrix}{t}_{1} & {t}_{2} & {t}_{3}\end{matrix} \\ \begin{matrix}{S}_{1} \\ {S}_{2} \\ {S}_{3} \\ \left\{{S}_{1} , {S}_{2}\right\} \\ \left\{{S}_{1} , {S}_{3}\right\} \\ \left\{{S}_{2} , {S}_{3}\right\} \\ \left\{{S}_{1} , {S}_{2} , {S}_{3}\right\}\end{matrix} & \left[\begin{matrix}1 & 0 & 0 \\ 0 & 0 & 1 \\ 0 & 0 & 0 \\ 1 & 0 & 1 \\ 1 & 0 & 0 \\ 0 & 1 & 1 \\ 1 & 1 & 1\end{matrix}\right]\end{matrix} ∈ {ℝ}^{7 \times 3} \qquad \text{(20)}$$

Note here that there are seven rows in the shift combination matrix Ω₀ (since 2³ - 1 = 7). The first column in Ω₀ indicates that processing unit time constraints for all of the following shift/shift combinations need to include time used for task t₁: shift S₁. shift combination {S₁, S₂}, shift combination {S₁, S₃), and shift combination {S₁, S₂, S₃}. The other columns can be interpreted in a similar manner. Note that the zeros in the second, third, fourth, and fifth rows of the second column in the matrix of Equation (20) may appear a bit counter-intuitive. For example, one would not consider the time used for the task t₂ when applying the time constraints for the shift S₂ alone since (i) the task t₂ can span across both shifts S₂ and S₃ and (ii) its operation time should not be bounded by the hours available in the shift S₂. Equations (1p) and (1q) make sure the time limitations for each of the shift combinations are satisfied accordingly. In some cases, single shifts {S₁, S₂, and S₃ in the above example) may always be included the first ξ rows of the shift combination matrix Ω₀, which is the reason why only the first ξ rows in the seventh term of the objective function in Equation (1a) are added. The concept of “shift combination” can be easily extended to the scheduling stage 1308, which will be explained in detail below.

With respect to the constraint for multi-day processes expressed in Equation (2a) above, this constraint enforces that (if a multi-day task i is planned on a day d) no other tasks on a processing unit j can be planned on the processing unit j within the duration of the task i (meaning Cmd[i,j]). This applies to both multi-day tasks

$$\left(i ∈ {l}_{j}^{m d}\right)$$

and single-day tasks

$$\left(i ∈ {I}_{j} , i ∉ {I}_{j}^{m d}\right) .$$

When there are not any multi-day tasks planned, single-day tasks on the processing unit j can be freely planned. A more straight-forward expression of Equation (2a) is shown in Equation (21) below For multi-day processes, Y[d, i] = 1 indicates that a task i begins on a date d, not that the task i is performed at some point on the date d.

$$\begin{matrix}{\sum }_{i ∈ {I}_{j}^{\text{md}}} {\sum }_{\begin{matrix}{d}^{′} = max \left(0 ,\right) \\ \left(d - {C}_{\text{md}} \left[i , j\right] + 1\right)\end{matrix}}^{d} Y \left[{d}^{′} , i\right] + {\sum }_{\begin{matrix}i ∈ {I}_{j :} \\ i ∉ {I}_{j}^{\text{md}}\end{matrix}} Y \left[d , i\right] \leq 1 + \\ {M}^{′} \left(1 - {\sum }_{i ∈ {I}_{j}^{\text{md}}} {\sum }_{\begin{matrix}{d}^{′} = max \left(0 ,\right) \\ \left(d - {C}_{\text{md}} \left[i , j\right] + 1\right)\end{matrix}}^{d} Y \left[{d}^{′} , i\right]\right) , ∀ j , ∀ d\end{matrix} \qquad \text{(21)}$$

If the first term in Equation (21) is one, it indicates that the processing unit j is still within a multi-day task duration on a day d. Therefore, no tasks can be planned on that day d. Otherwise, if the first term in Equation (21) is zero, it means no multi-day tasks are planned, and single-day tasks are free from any limits. Note that comparing M′ in Equation (21) and M in Equation (2a), it can be shown that M′ = M - 1. A reasonable value for M′ here can be

$$\left|{I}_{j}\right| - \left|{I}_{j}^{m d}\right| .$$

Equation (2a) forces multi-day tasks to have a non-zero value in the matrix A on its first day being planned and a zero value in the matrix A for the consecutive days. The corresponding good receipt time (gr) and shelf life (sl) for the material(s) as output from each multi-day task can be updated. For example, the updated good receipt time and shelf life for material m (denoted as gr(m)′ and sl(m)′) may be expressed as follows.

$$g r {\left(m\right)}^{′} = g r \left(m\right) + {C}_{\text{md}} \left[i , j\right] , ∀ i ∈ {I}_{j}^{\text{md}} \text{and} i ∈ \text{out} \left(m\right) , ∀ j \qquad \text{(22)}$$

$$s l {\left(m\right)}^{′} = s l \left(m\right) + {C}_{\text{md}} \left[i , j\right] , ∀ i ∈ {I}_{i}^{\text{md}} \text{and} i ∈ \text{out} \left(m\right) , ∀ j \qquad \text{(23)}$$

The notation out(m) depicts a set of tasks with the material m as an output material Note that this update can be done in a data preparation step and may not affect any formulation in Equations (1a)-(1s). Once the variable Y and corresponding A matrix are determined in the planning stage 1306, the fact that a task is a multi-day process may not affect the scheduling formulation, which is discussed below. If a multi-day task is planned, Equation (2a) ensures that no tasks on the same processing unit are planned within the task duration, so no conflict will occur during the scheduling stage 1308.

In some cases, additional constraints can be added to enable the use of configurable optimization parameters. For off-the-truck arrivals, if it is set to “disallowed”, the following can be obtained.

$${A}_{r 0} = 0 \qquad \text{(24)}$$

Similarly, for same-day shipment, if it is set to “disallowed”, the following can be obtained.

$${D}_{0} = 0 \qquad \text{(25)}$$

For overtime production, if it is set to “disallowed”, the following can be obtained.

$${ε}_{\text{ot}} = 0 \qquad \text{(26)}$$

Finally, for production version priority, I_{low} can be defined to represent tasks with lower priority or priorities. The following constraint can be used if the configuration is set to “only allow top priority ”

$$A \left[: , {I}_{\text{low}}\right] = 0 \qquad \text{(27)}$$

The decision variables associated with the matrix A determined in the planning stage 1306 can be used as input for the scheduling stage 1308

Note that the exclusive task sets constraint in Equation (1o) provide an efficient way to prevent tasks from occurring on the same days when this is not possible However, other formulations are possible and could have superior performance in some situations. One alternative is the use of “exclusive group sets.” In this approach, the tasks on a processing unit j could belong to multiple groups, and those groups could form multiple exclusive sets. The groups involving the processing unit j and in an exclusive set k can be represented by group_{j,k}. For example, assume that all tasks for the processing unit j can be categorize into four groups, such as soy, milk,fish, and chicken. Also assume that the groups soy and milk are exclusive to each other and that the groups fish and chicken are exclusive to each other. Therefore, group_{j,0} = {soy, milk} and group_{j,1} = {fish, chicken}. The set of all groups across all processing units can be represented by group. This leads to the following expressions.

$$Y {E}_{p}^{j} {G}^{j , k} \leq M {μ}^{j , k} , ∀ j , ∀ k \qquad \text{(28)}$$

$${μ}^{j , k} {1}_{\left|g r o u p\right|} \leq {1}_{H} , ∀ j , ∀ k \qquad \text{(29)}$$

In this formulation, µ^{j,k} ∈ {0, 1}^{H×|group|} is an additional decision variable representing whether a task belonging to certain groups is being executed in the processing unit j and the exclusive set k. Note that the groups in the processing unit j and in the exclusive set k are represented by group_{j,k}, which is a subset of group here, so all not-used elements in µ^{j,k} can be set to zero. The matrix G^{j,k} ∈ {0, 1}^{|I|×|group|} is a mapping matrix that maps tasks to groups. The superscript k denotes a specific group of the processing unit j, where each member in that group is exclusive to other member(s) in that group. For any processing unity, there may be only |group_{j,k}| columns out of |group| that are used in G^{j,k}, and the remaining columns from G^{j,k} can be set to zero. Here, the element G^{j,k}[i, l] can have a value of one if a task i can be categorized into a group l. Note that one task can be categorized into multiple groups if desired.

### Example Formulation of Scheduling Stage

Having described the first (planning) stage 1306 of the production schedule optimization process, the second (scheduling) stage 1308 is now described. Notice that, having determined the solution to the optimization problem as described above, the production requirements for each of the production lines for each day d have also been determined. For example, having solved the production planning optimization problem for all days in the horizon H, row d of matrix A summarizes the production requirements for a task i on a processing unit j for a day d. This enables the framework to optimize the schedule for each day such that (i) byproducts are produced prior to being used and (ii) the end time of each line is minimized. The following optimization problem defines the scheduling stage 1308 in some embodiments Since the formulation below can be repeated for each day d in the horizon H, the notation d in the majority of the matrix definitions is omitted below for simplicity.

$${\text{minimize}}_{{s}^{j} , {e}^{j} , {δ}^{j} , {S}_{p}^{j} , {X}_{\text{sab}} , t} {λ}_{12} {\sum }_{j} {S}_{p}^{j} + {λ}_{13} {\sum }_{j} {\sum }_{i ∈ {\tilde{I}}_{j}} {ε}_{\text{sot}} \left[j\right] \left[i\right] \qquad \text{(30a)}$$

$$\begin{matrix}\text{subject to} {e}^{j} \left[i\right] - {s}^{j} \left[i\right] = \left[\left({A}_{\text{mo}} \left[: , : , j\right] ⊙ {C}^{\text{Y}} \left[: , : , j\right]\right) ⋅ {E}_{p}^{j}\right] \left[d , i\right] , \\ ∀ j , ∀ i ∈ {\tilde{I}}_{j}^{\text{Y}}\end{matrix} \qquad \text{(30b)}$$

$${e}^{j} \left[i\right] - {s}^{j} \left[i\right] = \left[\left({B}_{\text{f}} \left[: , : , j\right] ⊙ {C}^{\text{f}} \left[: , : , j\right]\right) ⋅ {E}_{p}^{j}\right] \left[d , i\right] , ∀ j , ∀ i ∈ {\tilde{I}}_{j}^{\text{f}} \qquad \text{(30c)}$$

$${S}_{p}^{j} \leq {n}^{max} \left[s , d , j\right] , ∀ s \leq ξ , ∀ j \qquad \text{(30d)}$$

$${e}^{j} \left[i\right] \leq {S}_{p}^{j} ∀ j , ∀ i ∈ {\tilde{I}}_{j} ∪ {I}_{j}^{\text{pd}} \qquad \text{(30e)}$$

$${s}^{j} \left[i\right] \geq 0 ∀ j , ∀ i ∈ {\tilde{I}}_{j} ∪ {I}_{j}^{\text{pd}} \qquad \text{(30f)}$$

$${s}^{j} \left[i\right] \geq min \left({τ}_{s} \left[: , j\right] ⊙ \text{Ω} \left[: ξ , i\right]\right) ∀ j , ∀ i ∈ {\tilde{I}}_{j} \qquad \text{(30g)}$$

$${e}^{j} \left[i\right] \leq max \left({τ}_{e} \left[: , j\right] ⊙ \text{Ω} \left[: ξ , i\right]\right) + {ε}_{\text{SOI}} \left[j\right] \left[i\right] ∀ j , ∀ i ∈ {\tilde{I}}_{j} \qquad \text{(30h)}$$

$$\left({P}_{\text{Ip, s}} \left[j , :\right] {E}_{p}^{j}\right) ⊙ \left({s}^{j} \left[: \left|{\tilde{I}}_{j}\right|\right] - {s}_{\text{Ip,s}} \left[j , :\right] {E}_{p}^{j}\right) = 0 , ∀ j \qquad \text{(30i)}$$

$${P}_{\text{pd, s}} ⊙ \left({s}^{j} \left[\left|{\tilde{I}}_{j}\right| :\right] - {s}_{\text{pd,s}} \left[j , :\right]\right) = 0 , ∀ j \qquad \text{(30j)}$$

$${P}_{\text{pd, s}} ⊙ \left({e}^{j} \left[\left|{\tilde{I}}_{j}\right| :\right] - {e}_{\text{pd,s}} \left[j , :\right]\right) = 0 , ∀ j \qquad \text{(30k)}$$

$${s}^{j} \left[i\right] \geq {e}^{j} \left[k\right] + {T}_{c}^{j} \left[k , i\right] - M {δ}^{j} \left[i , k\right] ∀ j ; ∀ i , k ∈ {\tilde{I}}_{j} ∪ {I}_{j}^{\text{pd}} \qquad \text{(30ℓ)}$$

$${δ}^{j} \left[i , k\right] = 1 - {δ}^{j} \left[k , i\right] , ∀ i , k ∈ {\tilde{I}}_{j} ∪ {I}_{j}^{\text{pd}} , i \neq k \qquad \text{(30m)}$$

$${δ}^{j} \left[i , i\right] = 1 , ∀ i ∈ {\tilde{I}}_{j} ∪ {I}_{j}^{\text{pd}} \qquad \text{(30n)}$$

In addition, sub-day inventory balance constraints may be associated with the objective function in Equation (30a) as follows. Note that i, j, k, and m applied to these constraints can be inferred, so redundant notations at the end of those constraints are omitted below for simplicity.

$${s}_{\text{adj}}^{j} = {s}^{j} + f \left[j\right] {1}_{\left|{\tilde{I}}_{j}\right| + {max}_{j} \left|{I}_{j}^{\text{pd}}\right|} \qquad \text{(31a)}$$

$${e}_{\text{adj}}^{j} = {e}^{j} + f \left[j\right] {1}_{\left|{\tilde{I}}_{j}\right| + {max}_{j} \left|{I}_{j}^{\text{pd}}\right|} \qquad \text{(31b)}$$

$${X}_{\text{sub}}^{m} \left[k\right] = {Q}_{\text{c}}^{m} \left[k\right] + {Q}_{\text{b}}^{m} \left[k\right] - {U}_{\text{c}}^{m} \left[k\right] - {U}_{\text{b}}^{m} \left[k\right] + \left({L}_{1} {X}^{m} + {X}_{0}\right) \left[d\right] \qquad \text{(31c)}$$

$${t}_{\text{prod}}^{i , k} = min \left({e}_{\text{adj}}^{j} \left[i\right] , t \left[k\right]\right) - min \left({s}_{\text{adj}}^{j} \left[i\right] , t \left[k\right]\right) \qquad \text{(31d)}$$

$$\begin{matrix}{t}_{\text{cons}}^{i , k , m} = min \left({e}_{\text{adj}}^{j} \left[i\right] + \text{Δ} {t}_{\text{blt} \left(i , m\right)} , t \left[k\right] + \text{Δ} {t}_{\text{blt} \left(i , m\right)}\right) - \\ min \left({s}_{\text{adj}}^{j} \left[i\right] + \text{Δ} {t}_{\text{blt} \left(i , m\right)} , t \left[k\right] + \text{Δ} {t}_{\text{blt} \left(i , m\right)}\right)\end{matrix} \qquad \text{(31e)}$$

$$\begin{matrix}{Q}_{\text{c}}^{m} \left[k\right] = {\sum }_{j} {\sum }_{\begin{matrix}i ∈ {\text{out}}_{c} \left(m\right) , \\ i ∈ {\tilde{I}}_{j}^{\text{v}}\end{matrix}} {t}_{\text{prod}}^{i , k} \left(\frac{1}{{C}^{\text{v}} \left[d , i , j\right]}\right) {R}_{\text{out}} \left[i , m\right] \\ + {\sum }_{j} {\sum }_{\begin{matrix}i ∈ {\text{out}}_{c} \left(m\right) , \\ i ∈ {\tilde{I}}_{j}^{\text{f}}\end{matrix}} {t}_{\text{prod}}^{i , k} \left(\frac{1}{{C}^{\text{f}} \left[d , i , j\right]}\right) \frac{{A}_{\text{mo}} \left[d , i , j\right]}{{B}_{\text{f}} \left[d , i , j\right]} {R}_{\text{out}} \left[i , m\right]\end{matrix} \qquad \text{(31f)}$$

$$\begin{matrix}{U}_{\text{c}}^{m} \left[k\right] = {\sum }_{j} {\sum }_{\begin{matrix}i ∈ {\text{in}}_{c} \left(m\right) , \\ i ∈ {\tilde{I}}_{j}^{\text{v}}\end{matrix}} {t}_{\text{cons}}^{i , k , m} \left(\frac{1}{{C}^{\text{v}} \left[d , i , j\right]}\right) {R}_{\text{in}} \left[i , m\right] \\ + {\sum }_{j} {\sum }_{\begin{matrix}i ∈ {\text{in}}_{c} \left(m\right) , \\ i ∈ {\tilde{I}}_{j}^{\text{f}}\end{matrix}} {t}_{\text{cons}}^{i , k , m} \left(\frac{1}{{C}^{\text{f}} \left[d , i , j\right]}\right) \frac{{A}_{\text{mo}} \left[d , i , j\right]}{{B}_{\text{f}} \left[d , i , j\right]} {R}_{\text{in}} \left[i , m\right]\end{matrix} \qquad \text{(31g)}$$

$${\sum }_{j} {\sum }_{\begin{matrix}i ∈ {\text{out}}_{b} \left(m\right) , \\ i ∈ {\tilde{I}}_{j}^{\text{v}}\end{matrix}} {b}_{q}^{\text{v}} \left[i , j , k\right] \frac{{A}_{\text{mo}} \left[d , i , j\right]}{{B}_{\text{v}} \left[d , i , j\right]} {R}_{\text{out}} \left[i , m\right] \qquad \text{(31h)}$$

$${b}_{q}^{\text{f}} \left[i , j , k\right] {C}^{\text{f}} \left[d , i , j\right] < {t}_{\text{prod}}^{i , k} , ∀ k , ∀ i ∈ {\tilde{I}}_{j}^{\text{f}} , ∀ j \qquad \text{(31i)}$$

$${t}_{\text{prod}}^{i , k} \leq \left({b}_{q}^{\text{f}} \left[i , j , k\right] + 1\right) {C}^{\text{f}} \left[d , i , j\right] , ∀ k , ∀ i ∈ {\tilde{I}}_{j}^{\text{f}} , ∀ j \qquad \text{(31j)}$$

$${b}_{q}^{\text{v}} \left[i , j , k\right] {M}_{max}^{\text{v}} \left[d , i\right] {C}^{\text{v}} \left[d , i , j\right] < {t}_{\text{prod}}^{i , k} , ∀ k , ∀ i ∈ {\tilde{I}}_{j}^{\text{v}} , ∀ j \qquad \text{(31k)}$$

$${t}_{\text{prod}}^{i , k} \leq \left({b}_{q}^{\text{v}} \left[i , j , k\right] + 1\right) {M}_{max}^{\text{v}} \left[d , i\right] {C}^{\text{v}} \left[d , i , j\right] , ∀ k , ∀ i ∈ {\tilde{I}}_{j}^{\text{v}} , ∀ j \qquad \text{(31ℓ)}$$

$$\begin{matrix}{U}_{b}^{m} \left[k\right] = {\sum }_{j} {\sum }_{\begin{matrix}i ∈ {\text{out}}_{b} \left(m\right) , \\ i ∈ {\tilde{I}}_{j}^{\text{f}}\end{matrix}} {b}_{u}^{\text{f}} \left[i , j , k , m\right] \frac{{A}_{\text{mo}} \left[d , i , j\right]}{{B}_{\text{f}} \left[d , i , j\right]} {R}_{\text{in}} \left[i , m\right] \\ + {\sum }_{j} {\sum }_{\begin{matrix}i ∈ {\text{out}}_{b} \left(m\right) , \\ i ∈ {\tilde{I}}_{j}^{\text{v}}\end{matrix}} {b}_{u}^{\text{v}} \left[i , j , k , m\right] \frac{{A}_{\text{mo}} \left[d , i , j\right]}{{B}_{\text{v}} \left[d , i , j\right]} {R}_{\text{in}} \left[i , m\right]\end{matrix} \qquad \text{(31m)}$$

$$\left({b}_{u}^{\text{f}} \left[i , j , k , m\right] - 1\right) {C}^{\text{f}} \left[d , i , j\right] < {t}_{\text{cons}}^{i , k , m} , ∀ k , ∀ i ∈ {\tilde{I}}_{j}^{\text{f}} ∩ i n \left(m\right) , ∀ j \qquad \text{(31n)}$$

$${t}_{\text{cons}}^{i , k , m} \leq {b}_{u}^{\text{f}} \left[i , j , k , m\right] {C}^{\text{f}} \left[d , i , j\right] , ∀ k , ∀ i ∈ {\tilde{I}}_{j}^{\text{f}} ∩ i n \left(m\right) , ∀ j \qquad \text{(310)}$$

$$\begin{matrix}\left({b}_{u}^{\text{v}} \left[i , j , k , m\right] - 1\right) {M}_{max}^{\text{v}} {C}^{\text{v}} \left[d , i , j\right] < {t}_{\text{cons}}^{i , k , m} , \\ ∀ k , ∀ i ∈ {\tilde{I}}_{j}^{\text{v}} ∩ i n \left(m\right) , ∀ j\end{matrix} \qquad \text{(31p)}$$

$$\begin{matrix}{t}_{\text{cons}}^{i , k , m} \leq {b}_{u}^{\text{v}} \left[i , j , k , m\right] {M}_{max}^{\text{v}} \left[d , i , j\right] {C}^{\text{v}} \left[d , i , j\right] , \\ ∀ k , ∀ i ∈ {\tilde{I}}_{j}^{\text{v}} ∩ i n \left(m\right) , ∀ j \\ {X}_{\text{sub}}^{m} \left[k\right] \geq 0 ,\end{matrix} \qquad \text{(31q)}$$

$$∀ m ∈ w i p ; ∀ k ∈ \left[0 , 1 , … , 2 \left({\sum }_{j} \left|{\tilde{I}}_{j}\right| + {\sum }_{j} {max}_{j} \left|{I}_{j}^{\text{pd}}\right|\right) - 1\right] \qquad \text{(31r)}$$

$$t = {∪}_{∀ j} \left({e}^{j} \left[: \left|{\tilde{I}}_{j}\right|\right] ∪ {s}^{j} \left[: \left|{\tilde{I}}_{j}\right|\right]\right) \qquad \text{(31s)}$$

$$t \geq 0 \qquad \text{(31t)}$$

There can also be constraints for multi-operation recipes, which support multiple dependency modes across each of the operations under the same task. For example, the following constraints may be associated with the same objective function.

$$\begin{matrix}{s}_{\text{adj}}^{j} \left[i\right] = {s}_{\text{adj}}^{{j}^{′}} \left[i\right] , ∀ \left(j , {j}^{′}\right) ∈ {\text{Δ}}_{\text{md}} \left[i\right] \left[\text{‘START-START’}\right] , j \neq {j}^{′} , \\ ∀ \left|{J}_{i}\right| > 1 , ∀ i\end{matrix} \qquad \text{(32a)}$$

$$\begin{matrix}{s}_{\text{adj}}^{j} \left[i\right] = {e}_{\text{adj}}^{{j}^{′}} \left[i\right] , ∀ \left(j , {j}^{′}\right) ∈ {\text{Δ}}_{\text{md}} \left[i\right] \left[\text{‘START-FINISH’}\right] , j \neq {j}^{′} , \\ ∀ \left|{J}_{i}\right| > 1 , ∀ i\end{matrix} \qquad \text{(32b)}$$

$$\begin{matrix}{e}_{\text{adj}}^{j} \left[i\right] = {e}_{\text{adj}}^{{j}^{′}} \left[i\right] , ∀ \left(j , {j}^{′}\right) ∈ {\text{Δ}}_{\text{md}} \left[i\right] \left[\text{‘FINISH-FINISH’}\right] , j \neq {j}^{′} , \\ ∀ \left|{J}_{i}\right| > 1 , ∀ i\end{matrix} \qquad \text{(32c)}$$

Before introducing how the matrices come from the input data, it should be pointed out that the notations

$${t}_{p r o d}^{i , k} \text{and} {t}_{c o n s}^{i , k , m}$$

are fully defined in Equations (31d) and (31e). Those two notations exist only to simplify mathematical equations and to remove redundancy in the expressions. They need not be considered variables for the optimization problem, and thus the dimension information for those two notations are not provided.

The notations τₛ, τₑ ∈ R^{ξx|unit|} denote the shift starting time and shift ending time for each shift of each processing unit in the day. The notations P_{lp,s} ∈ {0, 1}^{|unit|×|task|} and

$${P}_{\text{pd,s}} ∈ {\left\{0 , 1\right\}}^{\left|u n i t\right| \times {max}_{j} \left|{I}_{j}^{\text{pd}}\right|}$$

represent the pre-specified “lock puck” and the planned downtime, respectively. Matrices S_{lp,s} ∈ R^{|unit|×|task|} represent the corresponding start timestamp for each “lock puck” and

$${s}_{\text{pd,s}} , {e}_{\text{pd,s}} ∈ {ℝ}^{\left|u n i t\right| \times {max}_{j} \left(\left|{I}_{j}^{\text{pd}}\right|\right)}$$

are the start and end for planned downtime. Note that

$${max}_{j} \left(\left|{I}_{j}^{p d}\right|\right)$$

can be taken to make sure that the total number of columns for each row are aligned. In fact, each processing unit j can have a different

$$\left|{I}_{j}^{p d}\right| .$$

The elements in the gap between

$$\left|{I}_{j}^{p d}\right|$$

and

$${max}_{j} \left(\left|{I}_{j}^{p d}\right|\right)$$

in each row can be set to zero and excluded as a decision variable.The matrices

$${T}_{c}^{j} ∈ {ℝ}^{\left(\left|{\tilde{I}}_{j}\right| + \left|{\tilde{I}}_{j}^{p d}\right|\right) \times \left(\left|{\tilde{I}}_{j}\right| + \left|{\tilde{I}}_{j}^{p d}\right|\right)}$$

represent the required transition times between products for the processing unit j such that

$${T}_{c}^{j} \left[i , k\right]$$

is the time required between a task i and a task k.

As noted earlier, I̅ⱼ denotes the set of tasks that are active on a given processing unit j for a given day. Similarly,

$${\tilde{I}}_{j}^{v}$$

and

$${\tilde{I}}_{j}^{f}$$

denote the active fixed-duration and variable-duration processes on a given day. The notation

$${M}_{max}^{v} ∈ {ℝ}^{H \times \left|t a s k\right|}$$

denotes the maximum quantity for variable-duration process This matrix can default to A[d, i] on a given day if not provided. The notations C^{v} and C^{f} are not new matrices, and they both are equal to the C matrix defined earlier and correspond to the elements in C that relate to variable-duration and fixed-duration, respectively.

In the sub-day inventory balance in Equations (31a)-(31t) and the multi-operation recipe in Equations (32a)-(32c), the vector ƒ ∈ R^{|unit|} denotes the relative shift of the beginning hours for each processing unit. The notation Δt_{blt} (no dimension specified) denotes a dictionary that stores the sub-day BOM lead time offset in hours for each of the task-material pairs. Note that the value of Δt_{blt} is often a negative number. The notation in(m) denotes all tasks or processing units that consume a material m, and the notation out(m) denotes all tasks or processing units that produce the material m. The notation Jᵢ denotes all processing units (operations) associated with a task i. In some cases, for the majority of tasks, |Jᵢ| = 1 since most tasks may have single-operation recipes. However, for tasks with multi-operation recipes, |Jᵢ| > 1, and the starting time of the task i across multiple units in some cases can be the same.

The dictionary Δ_{md} contains dependency mode information for multi-operation tasks and essentially functions as a “dictionary of dictionaries.” Keys for a first dictionary layer may include an index of tasks, and keys for a second dictionary layer may include strings representing dependency modes. The value under each key of Δ_{md}[i] can contain a list of pairs of processing units that follow the dependency mode prescribed by the key (where i is the task index). For example, Δ_{md}[i][‘START - START’] = [[0, 1], [4, 5]], where 0, 1, 4, and 5 are processing unit indices.

The objective function in Equation (30a) contains two terms. The first term minimizes the makespan of each line in order to ensure that production occurs over the shortest total time possible. The second term minimizes the violation of the shift end constraint. The constraint in Equation (30c) ensures that the time scheduled for a task i on a processing unit j satisfies the required daily production time, and the constraint in Equation (30d) ensures that the makespan is smaller than the maximum timesteps allowed in a day based on the demand planning stage 1306 The constraints in Equations (30e) and (30f) enforce that all production occurs between timestamp zero and the makespan and that production end times follow start times. Equations (40a) and (40b) below enforce the shift constraints. Note that in Equation (40a), the entries with zero in the matrix Ω can be excluded from the min statement. The constraints in Equations (30i), (30j), and (30k) enforce “lock puck” and planned downtime requirements. Note that here only the starting time is enforced, and the end time can be computed based on Equation (30c). The constraint in Equation (30ℓ) enforces an ordering in production in each processing unit and ensures that only one task is performed at each timestamp. It also ensures that sufficient transition time between tasks is maintained as specified by

$${T}_{c}^{{j}_{j}} .$$

Equations (30m) and (30n) enforce that δ^{j} is a skew-symmetric matrix.

Within the constraints for sub-day material balance. Equations (31c) and (31r) are the governing equations and help to ensure that WIP materials do not run out of stock on a sub-day time granularity. This may not be needed if the “good receipt time” for all materials in a facility is longer than a day. The constraints in Equations (31a) and (31b) apply the relative time adjustments for the start time and end time on each of the processing units. Equations (31d) and (31e) define temporary notations for complicated expressions and are not constraints. The constraints in Equations (31f) and (31g) represent production and consumption quantities by continuous tasks. The constraints in Equations (31h) and (31m) represent production and consumption quantities in batches. The constraint in Equation (31s) enforces that sub-day check-points are on the start and end of each task. Note that the union sign means concatenation when it is applied to vectors instead of sets.

In some cases, users may have the option to pass an “invalid” planning output for scheduling. These plans could be invalid in various ways, such as insufficient line (processing unit) capacity or insufficient input material for a task. Once the user has acknowledged those issues and still choose to pass on the resulting plan to the scheduling stage 1308, the constraints in Equations (30d) and (31r) can be excluded for the corresponding processing unit or the input material.

The following now explains the constraints that are relevant to multi-operation dependency. The notation Δ_{md} ∈ ℝ^{1x|task|} denotes existing multi-operation dependency relationships between processing units. Each element in this list, Δ_{md}[i], denotes the dependency relationships for a task i. These constraints enforce start/end times according to dependency mode. For example, a “start-start” pair of processing units can be forced to have the same start times.

Some facilities may use custom sequencing rules beyond minimization of changeovers. These rules can lead to substantial performance degradation and might be discouraged in some cases. However, the following additions to the scheduling objective function can account for these rules.

$$\begin{matrix}+ {\text{λ}}_{14} {\sum }_{j} {1}_{\left|{I}_{j}\right| + \left|{I}_{j}^{p d}\right|}^{T} \left(\left|{δ}^{j} - {ๅ}^{j}\right| ⊙ {θ}^{j}\right) {1}_{\left|{I}_{j}\right| + \left|{I}_{j}^{p d}\right|} \\ + {\text{λ}}_{15} {\sum }_{j} {\sum }_{i ∈ {I}_{j} ∪ {I}_{j}^{p d}} {\sum }_{k = 1}^{i} {α}^{j} \left[i , k\right] \left(max \left({s}^{j} \left[i\right] , {s}^{j} \left[k\right]\right)\right) - min \left(\left({e}^{j} \left[i\right] , {e}^{i} \left[k\right]\right)\right)\end{matrix} \qquad \text{(33)}$$

In this formulation, the binary matrices

$${γ}^{i} ∈ {\left\{0 , 1\right\}}^{\left(\left|{\tilde{I}}_{j}\right| + \left|{I}_{j}^{p d}\right|\right) \times \left(\left|{\tilde{I}}_{j}\right| + \left|{I}_{j}^{p d}\right|\right)}$$

are inputs describing the “ideal” production order for each processing unit j, where (like δ^{j}) a value of one for y^{j}[i, k] indicates that a finished good i would ideally be produced on a processing unit j prior to a finished good k. The matrices

$${θ}^{j} ∈ {ℝ}^{\left(\left|{\tilde{I}}_{j}\right| + \left|{I}_{j}^{\text{pd}}\right|\right) \times \left(\left|{\tilde{I}}_{j}\right| + \left|{I}_{j}^{\text{pd}}\right|\right)}$$

describe the importance of the production order δ^{j} being equal to the ideal order γ^{j} for each pair of products. For example, if γ^{j}[i, k] = 1 while y^{j}[i, m] = 0.5, it is twice as important that δ^{j}[i, k] = y^{j}[i, k] as it is that δ^{j}[i, m] = γ^{j}[i, m]. The matrices

$${α}^{j} ∈ {ℝ}^{\left(\left|{\tilde{I}}_{j}\right| + \left|{I}_{j}^{\text{pd}}\right|\right) \times \left(\left|{\tilde{I}}_{j}\right| + \left|{I}_{j}^{\text{pd}}\right|\right)}$$

represent the importance of each pair of products being produced one after the other (“adjacently”) on each processing unit j. A value greater than zero for α^{j}[i, k] indicates that a penalty can be applied in the objective function for each hour that i and k are separated in the production timeline for a processing unit j. The term with λ₁₄ minimizes the discrepancies between the production order δⁱ and the ideal production order γⁱ, weighted by the importance of each element of the production order as defined in θⁱ. The term with λ₁₅ minimizes the gap between products that are desired to be adjacent or nearby one another. Note that these two terms with λ₁₄ and λ₁₅ are optional.

In a production setting, each task can be assigned multiple attribute key-value pairs based on the properties of the input materials. For example, Task 1 may be assigned raw material type: beef and allergen type: egg at the same time. Here, raw material type and allergen type are attribute keys, while beef and egg are attribute values. On the other hand, each processing unit may belong to one or more processing unit groups. For example, group 1 may include processing unit 1 and processing unit 2, and group 2 may include processing unit 2, processing unit 3, and processing unit 4. One example goal of attribute constraints and objective terms can be to make sure (on all processing units within the processing unit groups) that, for each attribute key, only tasks with the same attribute value can be scheduled at the same time. These attribute constraints may impact both the planning stage 1306 and the scheduling stage 1308. The following identifies the impacts on each stage, along with an identification of which constraint equations to add or replace for planning and scheduling, respectively.

During the planning stage 1306, additional constraints and terms can be introduced into the objective function. Similar to the idea of the estimated changeover time in the planning stage 1306, one goal of adding attribute constraints in the planning stage 1306 may be to limit the total number of hours scheduled on each processing unit so that (once the scheduling stage 1308 is entered) there is adequate buffer to fully honor the attribute constraints for the scheduling stage 1308. In some embodiments, for simplification, all processing units in a processing unit group are assumed to have the same working shift hours. However, this need not be the case in other embodiments.

In the following, κ can be used to denote an attribute key, such as when this key represents a raw material type Also, A_{κ} can be used to denote a full set of attribute values associated with the key κ, such as when A_{κ} = {beef, pork, chicken}. Further, α_{κ} ∈ A_{κ} can be used to denote a specific attribute value for the key κ. In addition, αₘₐₓ = max_{κ}(|A_{κ}|) can be used to denote the maximum number of values available across all keys. Example additional constraints that may be introduced to the planning stage 1306 are as follows.

$$T \left[s , : , {I}_{j}^{\text{v}} , j\right] = \left({A}_{\text{mo}} \left[: , {I}_{j}^{\text{v}} , j\right] ⊙ C \left[: , {I}_{j}^{\text{v}} , j\right]\right) ⊙ \text{Ω} \left[s , : , {I}_{j}^{\text{v}}\right] , ∀ s , j \qquad \text{(34a)}$$

$$T \left[s , : , {I}_{j}^{\text{f}} , j\right] = \left({B}_{\text{f}} \left[: , {I}_{j}^{\text{f}} , j\right] ⊙ C \left[: , {I}_{j}^{\text{f}} , j\right]\right) ⊙ \text{Ω} \left[s , : , {I}_{j}^{\text{f}}\right] , ∀ s , j \qquad \text{(34b)}$$

$${\text{Γ}}_{l} \left[k , s , d , : , j\right] = T \left[s , d , : , j\right] {\text{Λ}}_{κ \left(k\right)} , ∀ s , d , j ; ∀ k \qquad \text{(34c)}$$

$$\begin{matrix}{\text{Γ}}_{g} \left[k , s , d , {a}_{κ \left(k\right)}\right] = max \left({\text{Γ}}_{l} \left[k , s , d , {a}_{κ \left(k\right)} , :\right] ⊙ {J}_{G , g \left(k\right)}\right) \\ ∀ s , d , ∀ {a}_{κ \left(k\right)} ∈ {A}_{κ \left(k\right)} ; ∀ k\end{matrix} \qquad \text{(34d)}$$

$${\sum }_{{a}_{κ \left(k\right)}} {\text{Γ}}_{g} \left[k , s , : , {a}_{κ \left(k\right)}\right] \leq {n}_{g \left(k\right)}^{s} \left[s , :\right] + {∈}_{\text{ot} , g , κ} \left[k , s , :\right] , ∀ s ; ∀ k \qquad \text{(34e)}$$

$${\sum }_{{a}_{κ \left(k\right)}} {\text{Γ}}_{g} \left[k , s , : , {a}_{κ \left(k\right)}\right] \leq {n}_{g \left(k\right)}^{max} \left[s , :\right] , ∀ s ; ∀ k \qquad \text{(34f)}$$

The decision variables used here can be defined as follows.

T ∈ R^{η×H}^{×|task|×|unit|} - A time spent per day per task per processing unit per shift-combination. By default, s may be used to denote the index for the shift-combination.

Γₗ ∈ R^{K×η×H×}^{αmax×|unit|} ^{_} A time spent per attribute constraint per processing unit. A dimension K here denotes the total number of attribute constraints in the problem Each of the constraints is also known as a group-attribute key pair (or a g-κ pair).

Γ_{g}∈ ℝ^{K×η×}^{H×α}^{max} - A maximum time spent per attribute value across all lines within a line group. Again, the dimension K here denotes the total number of attribute constraints in the problem. For each attribute constraint index k, there is a processing unit group g(k) and an associated attribute key κ(k). Note that α_{κ(k)} is used flexibly here to denote the index corresponding to the attribute value.

∈_{ot,g,κ} ∈ R^{K×η×H} ^{_} A slack variable that represents an overtime production for each shift combination in each day for each g-κ pair

The notation

$${n}_{g \left(k\right)}^{s} ∈ {ℝ}^{η \times H}$$

represents the number of working hours for each shift-combination in each day without overtime in the processing unit group g(k). The notation

$${n}_{g \left(k\right)}^{max} ∈ {ℝ}^{η \times H}$$

represents the number of working hours for each shift-combination in each day including overtime in the processing unit group g(k). The notation ^{Λ}^{n(k)}∈ {0,1}^{|task|×α}^{max} represents a task-to-attribute mapping for each attribute constraint index k, and J_{G,gk)} ∈ {0, 1} ^{|unit|} represents a set of processing units in the processing unit group g(k) for each attribute constraint index k. An additional term can also be added to the objective function used during the planning stage 1306, where the additional term corresponds to the penalization added on the slack variable ∈_{ot,g,κ}. This additional term may be expressed as follows.

$${\text{λ}}_{13} {\sum }_{k} {\sum }_{s = 1}^{η} {d}_{H}^{T} {∈}_{\text{ot} , g , κ} \left[k , s , :\right] \qquad \text{(35)}$$

In the scheduling stage 1308, additional constraints can be enforced so that (for certain processing unit groups) tasks on the processing units within the group with different attribute values cannot have overlaps on the schedule for the same attribute key κ. Since the formulation below can be repeated for each day d in the horizon H, the notation d is eliminated in the majority of the matrix definitions below for simplicity.

$$\begin{matrix}{s}_{\text{adj}}^{j} \left[i\right] \geq {e}_{\text{adj}}^{{j}^{′}} \left[{i}^{′}\right] - M {γ}^{j {j}^{′}} \left[i , {i}^{′}\right] , \\ ∀ i ∈ {\tilde{I}}_{j}^{{a}_{κ \left(k\right)}} , ∀ {i}^{′} ∈ {\tilde{I}}_{{j}^{′}} - {\tilde{I}}_{{j}^{′}}^{{u}_{κ \left(k\right)}} ; ∀ {a}_{κ \left(k\right)} ∈ {A}_{κ \left(k\right)} , ∀ j , {j}^{′} \neq j ∈ {J}_{G , g \left(k\right) ;} ∀ k\end{matrix} \qquad \text{(36a)}$$

$$\begin{matrix}{s}_{\text{adj}}^{{j}^{′}} \left[{i}^{′}\right] \geq {e}_{\text{adj}}^{j} \left[i\right] - M {γ}^{{j}^{′} j} \left[{i}^{′} , i\right] , \\ ∀ i ∈ {\tilde{I}}_{j}^{{a}_{κ \left(k\right)}} , ∀ {i}^{′} ∈ {\tilde{I}}_{{j}^{′}} - {\tilde{I}}_{{j}^{′}}^{{u}_{κ \left(k\right)}} ; ∀ {a}_{κ \left(k\right)} ∈ {A}_{κ \left(k\right)} , ∀ j , {j}^{′} \neq j ∈ {J}_{G , g \left(k\right) ;} ∀ k\end{matrix} \qquad \text{(36b)}$$

$$\begin{matrix}{γ}^{j {j}^{′}} \left[i , {i}^{′}\right] + {γ}^{{j}^{′} j} \left[{i}^{′} , i\right] = 1 \\ ∀ i ∈ {\tilde{I}}_{j}^{{a}_{κ \left(k\right)}} , ∀ {i}^{′} ∈ {\tilde{I}}_{{j}^{′}} - {\tilde{I}}_{{j}^{′}}^{{a}_{κ \left(k\right)}} ; ∀ {a}_{κ \left(k\right)} ∈ {A}_{κ \left(k\right)} , ∀ j , {j}^{′} \neq j ∈ {J}_{G , g \left(k\right) ;} ∀ k\end{matrix} \qquad \text{(36c)}$$

For the equations in this formulation, κ and g can correspond to the same attribute constraint k. The variables used here can be defined as follows.

$${s}_{\text{adj}}^{j} \left(i\right) , {e}_{\text{adj}}^{j} \left(i\right) ∈ {ℝ}^{\left|{\overline{I}}_{j}^{{a}_{κ \left(k\right)}}\right|}$$

Adjusted start and end times, respectively (such as in relative hour number), associated with each task i on a processing unity, with an attribute value α_{κ(k)}.

$${s}_{\text{adj}}^{{j}^{′}} \left({i}^{′}\right) , {e}_{\text{adj}}^{{j}^{′}} \left({i}^{′}\right) ∈ {ℝ}^{\left|{\tilde{I}}_{{j}^{′}}\right| - \left|{\tilde{I}}_{{j}^{′}}^{{a}_{κ \left(k\right)}}\right|}$$

Adjusted start and end times, respectively (such as in relative hour number), associated with each task i^{′} on a processing unit j^{′}, with an attribute value different from α_{κ(k)} (for the same attribute key κ).

$${γ}^{j {j}^{′}} ∈ {\left\{0 , 1\right\}}^{\left|{\tilde{I}}_{j}^{{a}_{κ \left(k\right)}}\right| \times \left(\left|{\tilde{I}}_{{j}^{′}}\right| - \left|{\tilde{I}}_{{j}^{′}}^{{a}_{κ \left(k\right)}}\right|\right)}$$

Optimization variables describing the order of tasks performed on processing units j,j^{′} within the same processing unit group g. A value of one for γ^{jj′} [i, i′] means that a task i with a specific attribute value α_{κ(k)} that runs on a processing unit j is performed prior to a task i^{′} with an attribute value different from α_{κ(k)} that runs on another processing unity j^{′}. As mentioned above, I̅̃̅ⱼ represents a set of all tasks that are planned to be performed on a processing unit j on a specific day, and

$${\tilde{I}}_{j}^{{a}_{κ \left(k\right)}}$$

represents a set of all tasks with a specific attribute value α_{κ(k)} that are planned to be performed on the processing unit j on a specific day.

In some cases, active processing unit constraints may be used. One goal of using active processing unit constraints may be to ensure that (for certain processing unit groups) only a limited subset can be activated during the same shift, such as when only seven out of eight processing units may be active at any given time. These constraints may exist due to various reasons, such as labor shortages or other labor limitations. These constraints can be applied at the shift level of granularity, rather than at the timestamp level. The active processing unit constraints can impact both the planning stage 1306 and the scheduling stage 1308. The following identifies the impacts on each stage, along with an identification of which constraint equations to add or replace for planning and scheduling, respectively.

During the planning stage 1306, to consider active processing unit constraints, Equation (2m) can be deactivated, and additional constraints can be introduced to the planning stage 1306 as follows.

$${Y}_{s} \left[s , d , :\right] {E}_{p}^{j} \left[: , i\right] \leq \text{Ψ} \left[s , d , j\right] , ∀ s , ∀ d , ∀ j , ∀ i , \qquad \text{(37a)}$$

$$\text{Ψ} \left[s , d , :\right] {J}_{G} \left[g , :\right] \leq {Z}_{G} \left[g , s\right] , ∀ s , ∀ d , ∀ g , \qquad \text{(37b)}$$

$${\sum }_{s} {Y}_{s} \left[s , : , :\right] \geq Y \qquad \text{(37c)}$$

$$M Y \geq {\sum }_{s} {Y}_{s} \left[s , : , :\right] \qquad \text{(37d)}$$

$${Y}_{s} \left[: , d , :\right] \leq \text{Γ,} ∀ d \qquad \text{(37e)}$$

$$\tilde{\text{Ω}} \text{=Ξ} {Y}_{s} , \qquad \text{(37f)}$$

$$\text{Ω} = 1 - \text{min} \left(1 , \tilde{\text{Ω}}\right) \qquad \text{(37g)}$$

The decision variables used here can be defined as follows.

Yₛ ∈ {0, 1}^{ξ×H×|task|} - A binary variable that indicates whether a task i is activated on a given day d for a given shift s, where:

$${Y}_{s} \left[s , d , i\right] = \left\{\begin{matrix}1 , \text{if task} i \text{is performed in shift} s \text{, on day} d \\ 0 , \text{otherwise} \text{.}\end{matrix}\right)$$

Ψ ∈ {0, 1}^{ξ×H×|units|} ^{_} A binary variable that indicates whether a processing unit j is activated on a given day d for a given shift s, where:

$$\text{Ψ} \left[s , d , j\right] = \left\{\begin{matrix}1 , \text{if processing unit} j \text{is active in shift} s \text{, on day} d \\ 0 , \text{otherwise} \text{.}\end{matrix}\right)$$

Ω̅ ∈ {0,1}^{η×H×|task|} ^{_} An auxiliary binary variable that represents the opposite state of Ω.

The notation J_{G} ∈ {0, 1}^{G×|unit|} indicates whether a processing unit j is included in a given processing unit group g The notation Z_{G} ∈ Z₊^{G×ξ} represents the total number of processing units within a given processing unit group g that can be activated in the given shift s, where the notation G denotes the total number of processing unit groups defined. Note that the value of Z_{G} may be constant throughout the horizon, meaning the limitation set on Z_{G} can be the same for any day d within the horizon.

The following provides an example to better understand the use of active processing unit constraints. Assume that there are three processing units in a facility, such as when unit = {PU₀ PU₁, PU₂}. Also assume that there are two processing unit groups, such as when group₀ = {PU₀, PU₁} and group₁ = {PU₁, Pu₂}. Based on this, J_{G}[0, :] = [1, 1, 0] and J_{G}[1, :] = [0, 1, 1] For each of the processing unit groups, the maximum number of processing units that can be activated in the same shift is one, so Z_{G}[0, :] = Z_{G}[1, :] = 1. The notation M is a large positive number, and Γ ∈ {0, 1}^{ξ×|task|} is the shifts-allowed matrix. The notation Ξ ∈ {0, 1}^{η×ξ} is a specially-designed shift-transformation matrix used here to enforce the consistency between Yₛ and Ω. The Ξ matrix helps to transform Yₛ from shift (ξ) into shift-combination (η). Let P^{S} denote the power-set for the set of available shifts (S) without the empty set Based on this, the Ξ matrix can be defined as follows.

$$\text{Ξ} \left[s , i\right] = \left\{\begin{matrix}1 , \text{if} S \left[i\right] ∉ {P}^{S} \left[s\right] \\ 0 , \text{otherwise} \text{.}\end{matrix}\right) \qquad \text{(38)}$$

As an example, consider the case where there are three shifts available, meaning S = {S₁, S₂, S₃} and ξ = |S| = 3. Here, P^{S} = {{S₁}, {S₂}, ⋯, {S₁, S₂, S3}} with |P^{S}| = 2^{ξ} - 1 = 7. Therefore, Ξ can be expressed as follows.

$$\begin{matrix}\begin{matrix}{S}_{1} & {S}_{2} & {S}_{3}\end{matrix} \\ \text{Ξ=} \begin{matrix}{S}_{1} \\ {S}_{2} \\ {S}_{3} \\ \left\{{S}_{1} , {S}_{2}\right\} \\ \left\{{S}_{1} , {S}_{3}\right\} \\ \left\{{S}_{2} , {S}_{3}\right\} \\ \left\{{S}_{1} , {S}_{2} , {S}_{3}\right\}\end{matrix} \left[\begin{matrix}0 & 1 & 1 \\ 1 & 0 & 1 \\ 1 & 1 & 0 \\ 0 & 0 & 1 \\ 0 & 1 & 0 \\ 1 & 0 & 0 \\ 0 & 0 & 0\end{matrix}\right]\end{matrix} \qquad \text{(39)}$$

In non-technical terms, if the shift associated with a column does not belong to the set associated with a row, the corresponding element is one, otherwise, it is zero. Looking at thefirst row of the matrix Ξ here, S₁ (in the first column) belongs to the set of S₁ (in the first row), so Ξ[0, 0] = 0. Also, S₂ and S₃ (in the second and third columns) do not belong to the set of S₁ (in the first row), so Ξ[0, 1] = Ξ[0, 2] = 0.

For scheduling, consider the variables Yₛ and Ψ from the solution of the planning stage 1306 that satisfy active processing unit constraints. Scheduling constraints may now be defined as follows.

$${s}^{j} \left[i\right] \geq min \left({τ}_{s} \left[{I}_{+} , j\right] ⊙ {Y}_{s} \left[{I}_{+} , d , i\right]\right) ∀ j , ∀ i ∈ {\tilde{I}}_{j} \qquad \text{(40a)}$$

$${e}^{j} \left[i\right] \leq max \left({τ}_{e} \left[: , j\right] ⊙ {Y}_{s} \left[: , d , i\right]\right) + {\text{ε}}_{\text{sot}} \left[j\right] \left[i\right] ∀ j , ∀ i ∈ {\tilde{I}}_{j} \qquad \text{(40b)}$$

In Equation (40a), I₊ denotes the indexes of nonzero elements in Yₛ[:, d, i].

If an unconstrained processing unit formulation is needed or desired, existing constraints can be modified both in the planning and scheduling stages 1306-1308 in order to accommodate unconstrained processing units. Note that a processing unit can be constrained or unconstrained depending on the day of the horizon H. Also note that this flexibility can be introduced onto line capacity constraints and can be used to handle other nonphysical exceptions from the input data (such as overlapping lock pucks).

In the planning stage 1306, it is possible to simply ignore lines in line capacity constraints. More explicitly, let

$${d}_{u c}^{j} ⊆ \left\{1 , ⋯ , H\right\} \text{for} 1 \leq j \leq \left|u n i t\right| ,$$

where

$${d}_{u c}^{j}$$

denotes the set of days where line j is unconstrained. In cases where the line is always constrained,

$${d}_{u c}^{j}$$

would be an empty set. Based on this, the line capacity constraints can be modified as follows.

$$\begin{matrix}\left({A}_{\text{mo}} \left[d , {I}_{j}^{\text{v}} , j\right] ⊙ C \left[d , {I}_{j}^{\text{v}} , j\right]\right) ⊙ \text{Ω} \left[s , d , {I}_{j}^{\text{v}}\right] + \\ \left({B}_{\text{f}} \left[d , {I}_{j}^{\text{f}} , j\right] ⊙ C \left[d , {I}_{j}^{\text{f}} , j\right]\right) ⊙ \text{Ω} \left[s , d , {I}_{j}^{\text{f}}\right] \\ + {P}_{\text{pd}} \left[s , d , j\right] + \left({t}_{\text{est}} \left[d , {I}_{j}\right] ⊙ Y \left[d , {I}_{j}\right]\right) ⊙ \text{Ω} \left[s , d , {I}_{j}\right] \\ \leq {n}^{s} \left[s , d , j\right] + {ε}_{\text{ot}} \left[s , d , j\right] ∀ j , d ∉ {d}_{\text{uc}}^{j} , s\end{matrix} \qquad \text{(41a)}$$

$$\begin{matrix}\left({A}_{\text{mo}} \left[d , {I}_{j}^{\text{v}} , j\right] ⊙ C \left[d , {I}_{j}^{\text{v}} , j\right]\right) ⊙ \text{Ω} \left[s , d , {I}_{j}^{\text{v}}\right] + \\ \left({B}_{\text{f}} \left[d , {I}_{j}^{\text{f}} , j\right] ⊙ C \left[d , {I}_{j}^{\text{f}} , j\right]\right) ⊙ \text{Ω} \left[s , d , {I}_{j}^{\text{f}}\right] \\ + {P}_{\text{pd, max}} \left[s , d , j\right] + \left({t}_{\text{est}} \left[d , {I}_{j}\right] ⊙ Y \left[d , {I}_{j}\right]\right) ⊙ \text{Ω} \left[s , d , {I}_{j}\right] \\ \leq {n}^{max} \left[s , d , j\right] ∀ j , d ∉ {d}_{\text{uc}}^{j} , s .\end{matrix} \qquad \text{(41b)}$$

One modification here involves the introduction of

$$d ∉ {d}_{u c}^{j}$$

in Equation (41b)

In the scheduling stage 1308, there may be no need to enforce and order among the processing unit tasks, so neither transition times between tasks nor overlaps may be relevant Furthermore, since planning is unconstrained, a span time constraint may not need to be enforced for unconstrained lines. Consequently, these two constraints can be modified as follows.

$${S}_{p}^{j} \leq {n}^{max} \left[s , d , j\right] , ∀ s \leq ξ , ∀ j , ∀ d ∉ {d}_{\text{uc}}^{j} \qquad \text{(42a)}$$

$$\begin{matrix}{s}^{j} \left[i\right] \geq {e}^{j} \left[k\right] + {T}_{c}^{j} \left[k , i\right] - M {δ}^{j} \left[i , k\right] ∀ j ; ∀ i , k ∈ {\tilde{I}}_{j} ∪ {I}_{j}^{\text{pd}} , \\ ∀ d ∉ {d}_{\text{uc}}^{j} .\end{matrix} \qquad \text{(42b)}$$

In some embodiments, the framework can support simultaneous grouping and scheduling That is, solving an optimization problem using a two-stage approach (the planning and scheduling stages 1306-1308) is numerically efficient. However, it may result in infeasibility in the scheduling stage 1308 for a date d if a byproduct balance cannot be kept above zero throughout the day while keeping all production within the time limit defined by nⁱ [d] + ∈ⁱ[d]. In order to avoid such issues, the constraint of Equation (30d) can be removed so that the makespan for each line can be minimized but is not guaranteed to exactly fit within the overtime specified by the planning stage 1306.

Although the above description has provided a specific approach for performing RTN-based templated production schedule optimization, this disclosure is not limited to the specific approach described above. Other approaches (including ones that do not use a two-stage process or that use different equations) may be performed by the RTN-based templated PSO framework of this disclosure. As a particular example, the two-stage process described above may be used with other optimization problem formulations. Also, while the specific approach described above has used days as the timesteps for the two-stage process, the two-stage process may use any other suitable timesteps.

### Example Application

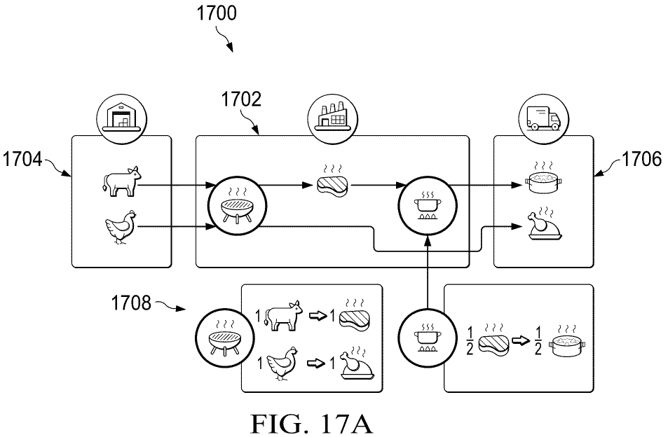

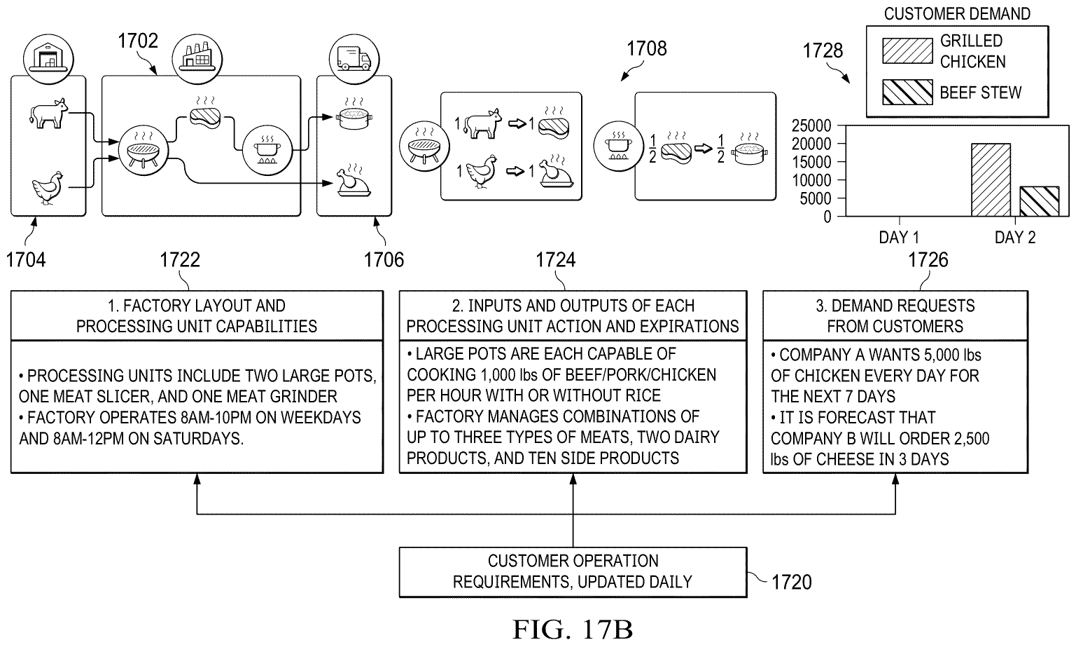

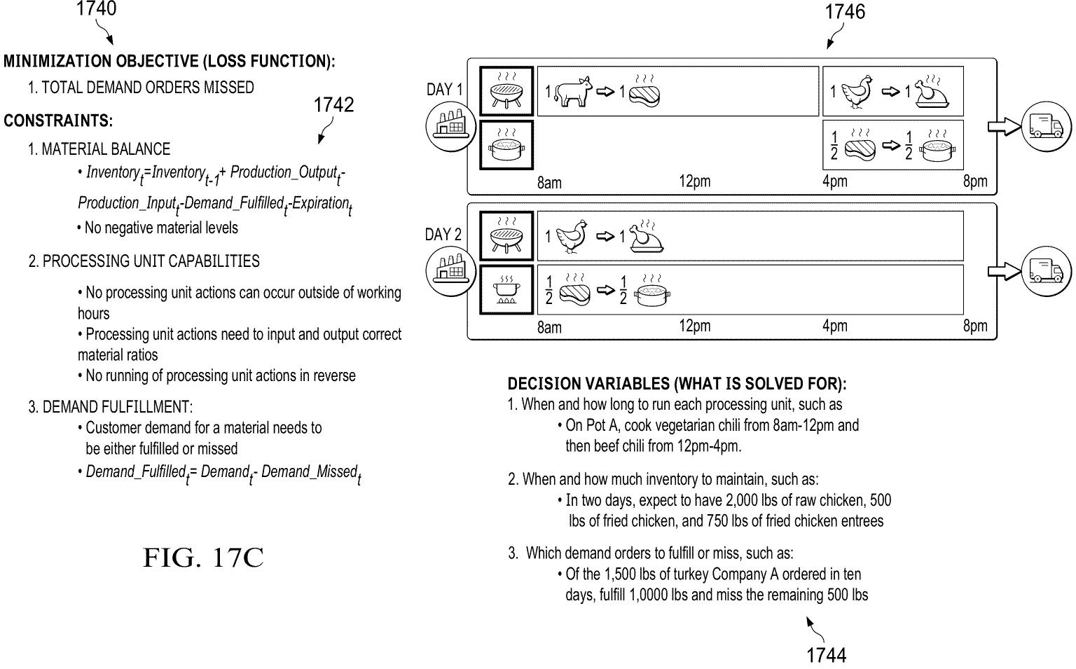

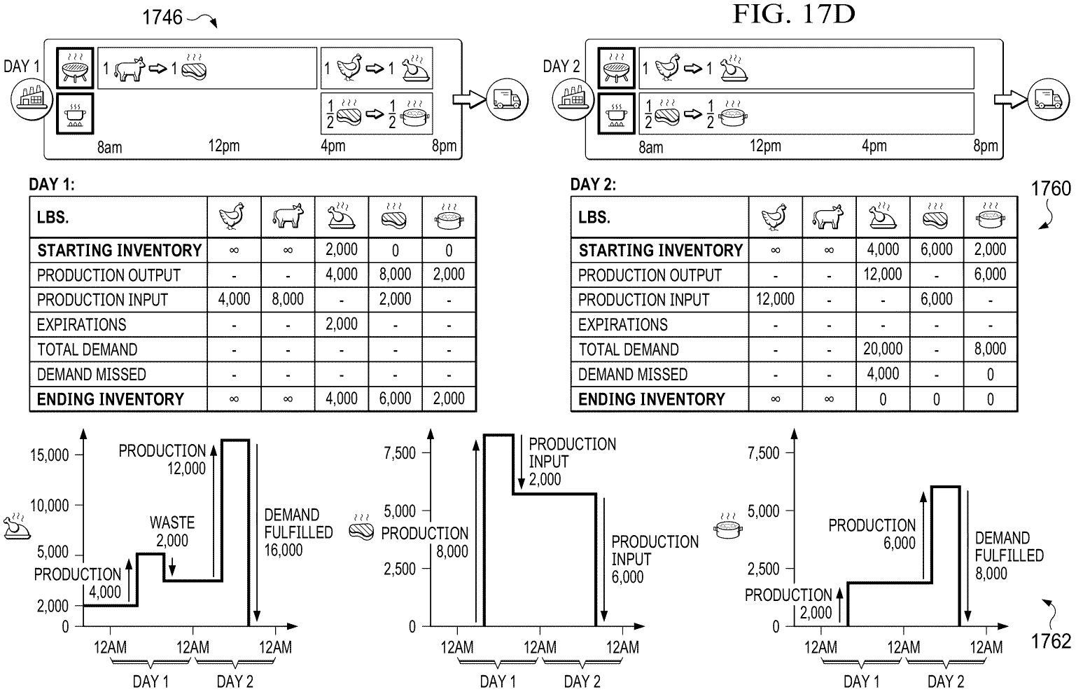

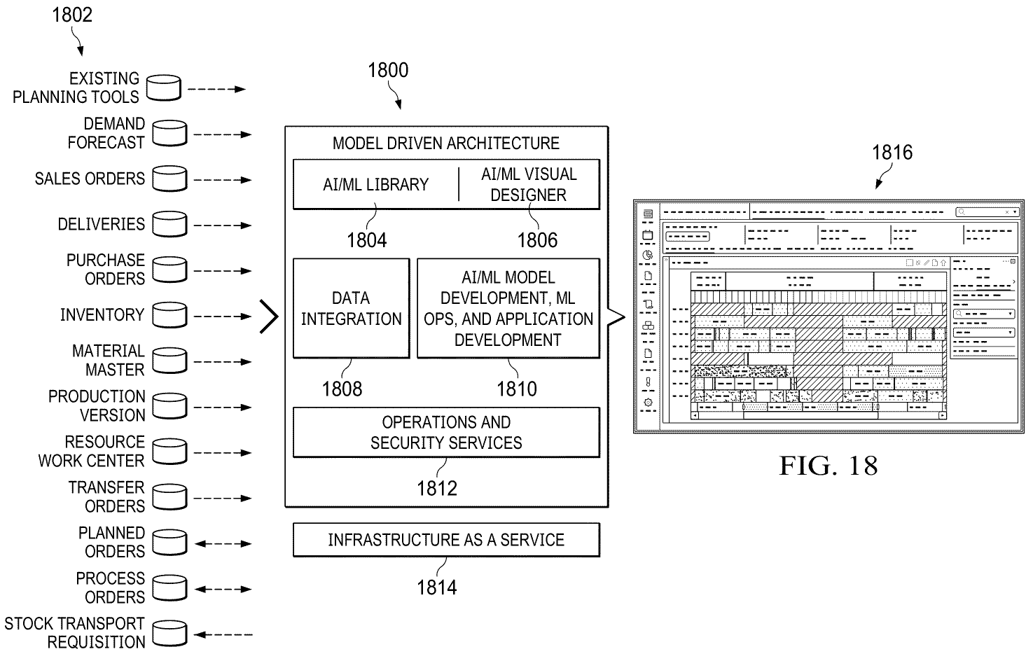

FIGS. 17A through 17D illustrate an example application of an RTN-based templated PSO framework according to this disclosure. In particular, FIGS. 17A through 17D illustrate an example of how the RTN-based templated PSO framework may use the techniques described above in a food industry environment to generate a discrete-time formulation. As shown in FIG. 17A, production schedule optimization can be performed for a processing facility 1702 that receives raw materials from one or more suppliers 1704 and that produces multiple end products 1706 In this particular example, the processing facility 1702 receives both steak and chicken from one or more suppliers 1704, processes the steak and chicken using (among other things) common grilling equipment, and produces grilled chicken and beef stew as the end products 1706. Two recipes 1708 are supported in the processing facility 1702, namely a recipe for grilling the steak or chicken and a recipe for producing beef stew.

As shown in FIG. 17B, based on the specific scenario shown in FIG. 17A, it is possible to collect various information 1720 in order to create fixed variables associated with this particular application. In this example, the information 1720 includes information 1722 associated with the layout of the processing facility 1702 (such as the processing units that are available and how the processing units are arranged) and the capabilities of the processing units in the processing facility 1702, as well as information about the processing facility 1702 itself (such as its hours of operation and work shifts). The information 1720 also includes information 1724 associated with inputs and outputs of the processing units in the processing facility 1702 and expirations associated with the inputs and outputs. The information 1720 further includes information 1726 associated with estimated demands for the one or more products 1706, which in some cases may include or be used to produce one or more demand forecasts 1728.

As shown in FIG. 17C, at least one objective 1740, one or more constraints 1742, and one or more fixed or decision variables 1744 associated with this particular application can be defined. In this example, the at least one objective 1740 indicates a desire to minimize missed product orders. Also, the one or more constraints 1742 include a material balance constraint, constraints on the operations of the processing units in the processing facility 1702, and a definition of a demand fulfillment constraint (which defines a variable associated with missed product orders). In addition, the one or more fixed or decision variables 1744 include an identification of when and how long to operate each processing unit in the processing facility 1702 each day or other timestep, when and how much inventory to maintain, and which orders to fulfill or miss. Note that at least one of these elements 1740-1744 may be defined using at least one template 406, 412.

Using this information, the framework can develop a production schedule for the processing facility 1702. A portion of a production schedule 1746 is shown in FIGS. 17C and 17D. In this example, the production schedule 1746 can include or be associated with information 1760, which includes various information about estimated inventories, production amounts, expirations, demands, and other product-related characteristics. The production schedule 1746 can also include or be associated with information 1762, which can define quantities of products produced in different timesteps of the production schedule 1746.

In some embodiments, at least some of the information related to the production schedule 1746 can be presented to one or more users for review, approval, or modification. In some cases, for instance, a user might invoke an option to change one or more constraints or other inputs used by the framework to produce the production schedule 1746, and the framework may generate one or more additional production schedules for comparison or selection. When a particular production schedule is selected by a user for implementation, that production schedule may become the master schedule for the processing facility 1702. The master schedule generally represents the production schedule that is currently in use by the processing facility 1702. The master schedule may remain in use by the processing facility 1702 until the master schedule is updated or replaced by a new master schedule

Although FIGS. 17A through 17D illustrate one example of an application of an RTN-based templated PSO framework, various changes may be made to FIGS. 17A through 17D. For example, the specific application shown here is for illustration only and can easily vary based on the setup and purpose of the facility or facilities associated with the production schedule. Also, a single facility or multiple facilities may be associated with any other or additional fixed variables, objectives, constraints, decision variables, production schedules, or other characteristics shown here.

### Example Architecture

FIG. 18 illustrates an example architecture 1800 of an RTN-based templated PSO framework according to this disclosure. For example, the architecture 1800 may be implemented using one or more applications 112 that are executed by an application server 106, one or more user devices 102a-102d, or other or additional components in order to provide various functions of the RTN-based templated PSO framework described above. As shown in FIG. 18, the architecture 1800 is configured to receive data from or provide data to a number of external systems or tools 1802. For example, the architecture 1800 can receive data from production planning, demand forecast, sales order, delivery, and purchase order systems or tools 1802. The architecture 1800 can also receive data from inventory, master material, production version, resource work center, and transfer order systems or tools 1802. The architecture 1800 can further receive data from or provide data to planned order and process order systems or tools 1802, and the architecture 1800 can interact with an STR system or tool 1802. Note that these systems or tools 1802 are for illustration only and can easily vary depending on the specific implementation of the architecture 1800.

As can be seen in this example, the architecture 1800 supports a machine learning model-driven architecture for performing production schedule optimization. In this particular example, the architecture 1800 includes a library 1804 of various artificial intelligence/machine learning (AI/ML) functions. Among other things, the library 1804 can provide various AI/ML functions that facilitate the development of machine learning models and other machine learning algorithms. For example, the library 1804 can provide various deep-code tools and low-code environments for developing, deploying, and operating enterprise-level AI applications. In some cases, the library 1804 may, for example, represent the AI STUDIO product from C3.AI, INC. The AI STUDIO product, for instance, can provide a cohesive development experience on a visual canvas and support data ingestion, data modeling, machine learning feature engineering, machine learning model lifecycle management, and a metadata-driven user interface (UI) development tooling.

The architecture 1800 also includes an AI/ML visual designer tool 1806, which allows users to develop, scale, and apply AI insights without writing code. For example, the visual designer tool 1806 may allow users to identify data to be processed, use automated machine learning (AutoML) to automatically train high-performing machine learning models (such as for any regression, classification, or clustering problem), and deploy the machine learning models for use. One or more of these functions can be performed graphically, such as when the visual designer tool 1806 allows users to visually define dataflows between AI/ML-based tasks or other tasks In some cases, the visual designer tool 1806 may, for example, represent the AI EX MACHINA product from C3.AI, INC.

A data integration function 1808 is used by the architecture 1800 to obtain suitable data for processing using AI/ML models or other logic. For example, the data integration function 1808 can be used to integrate, federate, and unify data from multiple disparate sources, such as the external systems or tools 1802 (which may include data sources internal to an organization and external to the organization), into a single logical data image. In some embodiments, the data integration function 1808 can use metadata transformation expressions or other techniques to combine data entities, leverage AI-based data reconciliation capabilities, maintain data lineage, and enforce data governance rules. Also, in some embodiments, the data integration function 1808 can support the use of various connectors for interacting with various data sources, and data that is retrieved by the data integration function 1808 can be stored in a virtual data lake and used to create a unified data image. The data integration function 1808 may support the use of standard (pre-built) and custom data models. In some cases, the data integration function 1808 may represent an example integration function available in the C3 AI Platform from C3.AI, INC.

Information from the library 1804 and the visual designer tool 1806, as well as information from the data integration function 1808, are provided to an AI/ML application pipeline 1810, which is generally used to create, modify, and manage machine learning models and applications that use the machine learning models (where the machine learning models can process data from the data integration function 1808) For example, the AI/ML application pipeline 1810 may support various functions related to data exploration, feature engineering, machine learning model development, and machine learning model deployment. These functions can be used to support the creation of one or more machine learning models, such as those used to implement various prediction functions or other functions of the RTN-based templated PSO framework described above. The AI/ML application pipeline 1810 may also support various functions related to machine learning model inferencing or other operations performed using machine learning models, governance or other management of machine learning models, and application development to support the design and use of application user interfaces or other components to expose AI/ML insights and data or to otherwise use outputs generated by the machine learning models. In some cases, the AI/ML application pipeline 1810 may represent various AI enterprise functions available in a model-drive architecture, such as the C3 AI Platform from C3.AI, INC.

Operations and security services 1812 represent a collection of functions associated with the usage of machine learning models and data security for the machine learning models For example, the operations and security services 1812 may include services supporting data persistence, batch and stream processing of data, time-series normalization of data, auto-scaling of data, data encryption, attribute and role-based access control, and various AI/ML services. The operations and security services 1812 may also include cybersecurity-related services, such as those used for protecting online data. In some cases, the operations and security services 1812 may represent various functions available in a model-drive architecture, such as the C3 AI Platform from C3.AI, INC.

In some embodiments, the architecture 1800 may be supported by infrastructure as a service (laaS) functionality 1814, which generally allows integration of the architecture 1800 (when implemented using cloud-native, multi-cloud, or on-premise applications) with existing data storages, enterprise source systems, tools, and underlying infrastructures. For example, the IaaS functionality 1814 can allow the architecture 1800 to be implemented using various cloud computing systems, such as AMAZON WEB SERVICES (AWS), MICROSOFT AZURE, GOOGLE CLOUD PLATFORM, and IBM CLOUD, and integrated with data sources and other components that are available in a particular user’s environment or domain. In some cases, the IaaS functionality 1814 may represent various functions available in a model-drive architecture, such as the C3 AI Platform from C3.AI, INC.

Among other things, the architecture 1800 can be used to generate one or more graphical user interfaces 1816, which can be provided to one or more users (such as via one or more of the user devices 102a-102d). The one or more graphical user interfaces 1816 may support any of various functions described above For example, the one or more graphical user interfaces 1816 may allow users to define and change constraints and objective terms, display information about generated production schedules, and compare production schedules generated using different constraints or objective terms. Note, however, that the one or more graphical user interfaces 1816 may be used to present any other or additional information to users. One specific example of a graphical user interface 1816 is described in more detail below.

Example embodiments of the RTN-based templated PSO framework described in this disclosure can be used with a model-driven architecture that includes a type system. A model-driven architecture is a term for a software design approach that provides models as a set of guidelines for structuring specifications. An example model-driven architecture can include a type system that may be used as a domain-specific language (DSL) within a platform used to access data, interact with data, and/or perform processing or analytics based on one or more type or function definitions within the type system. By using an abstraction layer provided by a type system, the complexity of a production schedule optimization problem can be reduced by orders of magnitude, such as to the order of a few thousand types, for any given production schedule optimization application that a programmer manipulates using JAVASCRIPT or other language to achieve a desired result. Thus, all of the complexity of the underlying foundation (with an order of M×S×T×A×U using structured programming paradigms) is abstracted and simplified for the programmer. Here, M represents the number of process modules (APACHE Open Source modules are examples of process modules), S represents the number of disparate enterprise and extraprise data sources, T represents the number of unique sensored devices, A represents the number of programmatic APIs, and U represents the number of user presentations or interfaces. Example technologies that can be included in one or more embodiments may include nearly-free and unlimited compute capacity and storage in scale-out cloud environments, such as AWS; big data and real-time streaming; smart connected devices; mobile computing; and data science including big-data analytics and machine learning to process the volume, velocity, and variety of big-data streams.

The type system of the model-driven architecture may include types as data objects and at least one of: associated methods, associated logic, and associated machine learning classifiers. One or more of the data objects may be associated with at least one of: one or more customers, one or more companies, one or more accounts, one or more products, one or more employees, one or more suppliers, one or more opportunities, one or more contracts, one or more locations, and one or more digital portals. Type definitions may include properties or characteristics of an implemented software construct.

Employing the type system of the model-driven architecture may include performing data modeling to translate raw source data formats into target types. Sources of data may be associated with at least one of: accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, and service logs. Among other things, the type system can be employed to perform data modeling in order to translate raw source data formats into target types. Sources of data for which data modeling and translation can be performed may include accounts, products, employees, suppliers, opportunities, contracts, locations, digital portals, geolocation manufacturers, SCADA information, OMS information, inventories, supply chains, bills of materials, transportation services, maintenance logs, or service logs.

The model-driven architecture enables capabilities and applications including precise predictive analytics, massively parallel computing at the edge of a network, and fully-connected sensor networks at the core of a business value chain. The model-driven architecture can serve as the nerve center that connects and enables collaboration among previously-separate business functions, including product development, marketing, sales, service support, manufacturing, inventory, finance, shipping, order management, human capital management, etc. Some embodiments may include a product cloud that includes software running on a hosted elastic cloud technology infrastructure that stores or processes product data, customer data, enterprise data, and Internet data. The product cloud may provide one or more of: a platform for building and processing software applications; massive data storage capacity; a data abstraction layer that implements a type system; a rules engine and analytics platform; a machine learning engine; smart product applications; and social human-computer interaction models One or more of the layers or services may depend on the data abstraction layer for accessing stored or managed data, communicating data between layers or applications, or otherwise storing, accessing, or communicating data.

An example model-driven architecture for integrating, processing, and abstracting data related to a production schedule optimization development platform can include tools for machine learning, application development and deployment, data visualization, automated control and instruction, other tools (such as an integration component, a data services component, a modular services component, and an application that may be located on or behind an application layer), etc. The model-driven architecture may operate as a comprehensive design, development, provisioning, and operating platform for industrial-scale applications in various industries, such as chemical, pharmaceutical, oil, pipeline, food, dairy, consumer good, manufacturing, steel, and paper industries. Other example industries may include energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

An integration component, data services component, and modular services component may store, transform, communicate, and process data based on the type system. In some embodiments, the data sources and/or the applications may also operate based on the type system. In an example embodiment, the applications may be configured to operate or interface with the components based on the type system. For example, the applications may include business logic written in code and/or accessing types defined by a type system to leverage services provided by the system.

In some embodiments, the model-driven architecture uses a type system that provides type-relational mapping based on a plurality of defined types. For example, the type system may define types for use in the applications, such as a type for a customer, organization, device, or the like. During development of an application, an application developer may write code that accesses the type system to read or write data to the system, perform processing or business logic using defined functions, or otherwise access data or functions within defined types. In some embodiments, the model-driven architecture enforces validation of data or type structure using annotations/keywords. The types in the type system may include defined view configuration types used for rendering type data on a screen in a graphical, text, or other format. In some embodiments, a server, such as a server that implements at least a portion of the system, may implement mapping between data stored in one or more databases and a type in the type system, such as data that corresponds to a specific customer type or other type.

One example of a type system is given by way of the following non-limiting example, which may be used in various embodiments and in combination with any other teachings of this disclosure. In some embodiments, the fundamental concept in the type system is a “type,” which is similar to a “class” in object-oriented programming languages. At least one difference between “class” in some languages and “type” in some embodiments of the type system disclosed here is that the type system is not tied to any particular programming language. As discussed here, at least some embodiments disclosed here include a model-driven architecture, where types are the models. Not only are types interfaces across different underlying technologies, they are also interfaces across different programming languages. In fact, the type system can be considered self-describing, so below is presented an overview of the types that may define the type system itself.

A type is the definition of a potentially-complex object that the system understands. Types may be the primary interface for all platform services and the primary way that application logic is organized. Some types are defined by and built into the platform itself. These types provide a uniform model across a variety of underlying technologies. Platform types also provide convenient functionality and build up higher-level services on top of low-level technologies. Other types are defined by the developers using the platform. Once installed in the environment, they can be used in the same ways as the platform types. There is no sharp distinction between types provided by the platform and types developed using the platform.

The production schedule optimization functionality described above can also be used with various enterprise functions, such as messaging, reporting, alerting, etc. processes to update systems based on triggers, detecting anomalies, real-time data streams, etc. In example enterprise environments, the production schedule optimization functionality can control or instruct manufacturing or resource planning systems. As a particular example, the production schedule optimization functionality can be used to schedule (automatically or after user approval) production of various products and may control (again automatically or after user approval) processing units to support this production.

Although FIG. 18 illustrates one example of an architecture 1800 of an RTN-based templated PSO framework, various changes may be made to FIG. 18. For example, the RTN-based templated PSO framework may be implemented in other ways depending on (among other things) the types of computing and programming technologies used to implement the RTN-based templated PSO framework.

### Example Usage of Rtn-Based Pso

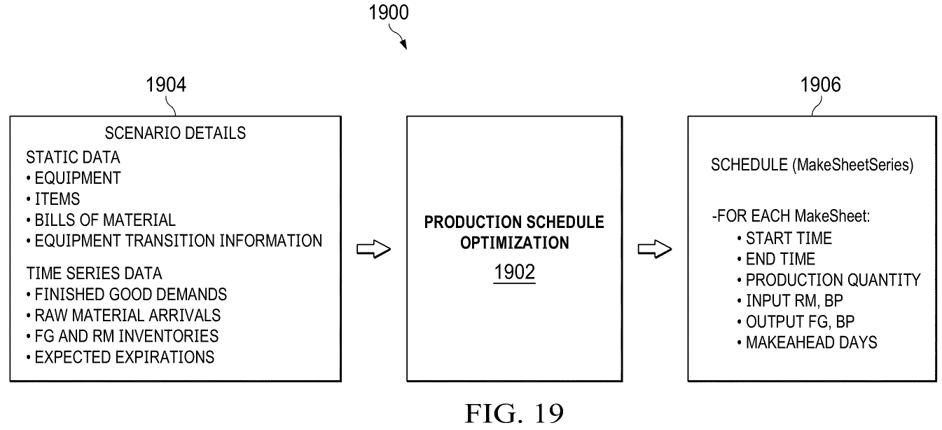

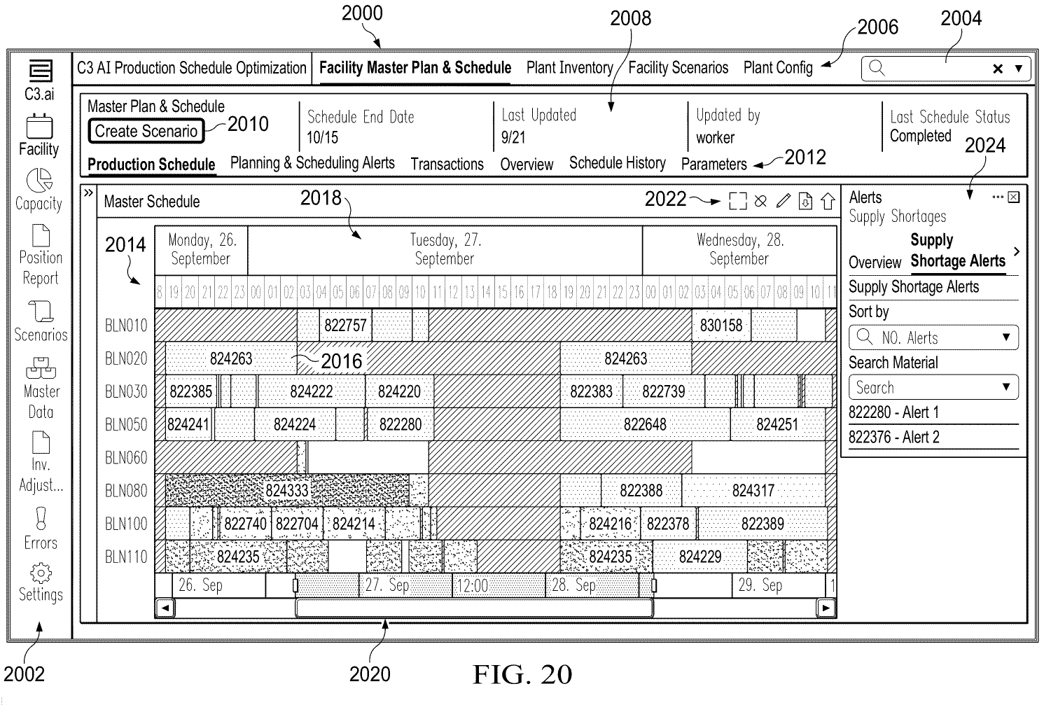

FIG. 19 illustrates an example overview 1900 of a usage of an RTN-based templated PSO framework according to this disclosure. As shown in FIG. 19, the overview 1900 illustrates a production schedule optimization function 1902, which may generally represent the RTN-based templated PSO framework as implemented using the one or more applications 112 and/or the architecture 1800 described above. In this example, the production schedule optimization function 1902 receives various inputs 1904, such as static data, time-series data, and data related to a particular scenario (such as current constraints and other user-defined parameters). In this example, the static data can relate to equipment parameters, item parameters (such as raw material or WIP parameters), bills of material for finished goods, and equipment transition information. These types of information tend to remain unchanging over time and therefore can be said to represent static information. Also, in this example, the time-series data can relate to demands for finished goods, arrivals of raw materials, finish good and raw material inventories, and expected expirations of raw materials or finish goods. These types of information typically involve various quantities or other numerical values associated with specific dates or other timesteps 1304.

In some embodiments, the inputs 1904 may generally be classified into four groups of input data, such as product details, process details, supply chain details, and cost details. The product details relate to specific products to be or being manufactured or processed and may include product recipes, bills of material, product attributes, transition wheels (how transitions can be made between producing different products), transportation requirements, maximum/minimum lot sizes, batch sizes, product qualities, and product shelf lives. The process details relate to processes to be or being used to produce the products, such as process dependencies (like how one process may depend on another), product planning rules (like when a process can only occur on one or more specified days of the week), multi-day process definitions, a product-to-processing unit compatibility matrix (like one defining which processing units can produce which products), processing unit attributes, locked production processes, work shifts, work shift combinations, and overtime rules. The supply chain details relate to the overall supply chain in which the products are to be or are being produced and the processes used, such as a planning horizon identification, raw material lead times, good receipt processing times or dwell times, inventory management parameters, intermediate product quantities, finished good surpluses, and finished good deficits. The cost details relate to costs associated with the products or processes, such as missed demand costs, fixed overtime costs, low-priority process penalties, wasted material costs, same-day production penalties, and same-day shipment penalties. Note, however, that any other or additional inputs or input types may be used here

The production schedule optimization function 1902 here generally operates to produce at least one production schedule 1906 based on the inputs 1904. Each production schedule 1906 in this example takes the form of a series of makesheets. In this particular example, each makesheet identifies start and end times for a production task, a quantity of material to be produced, one or more input raw materials or byproducts to be used, one or more output finished goods or byproducts to be produced, and a number of makeahead days (which indicate how far ahead of time the one or more output finished goods or byproducts are being produced). The series of makesheets can thereby identify tasks to be performed in order to produce products over a specified period of time.

Although FIG. 19 illustrates one example of an overview 1900 of a usage of an RTN-based templated PSO framework, various changes may be made to FIG. 19. For example, the production schedule optimization function 1902 may receive any other or additional inputs 1904. The production schedule optimization function 1902 may also or alternatively generate any other or additional outputs, such as a production schedule having any other suitable form or contents

### Example Graphical User Interface

FIGS. 20 through 24 illustrate example graphical user interfaces associated with an RTN-based templated PSO framework according to this disclosure. For example, the graphical user interfaces may be generated using one or more applications 112 and/or the architecture 1800 described above and presented on one or more of the user devices 102a-102d. As shown in FIG. 20, a graphical user interface 2000 can provide various information and controls related to production schedule optimization. In this example, the graphical user interface 2000 includes controls 2002 that allow one or more users to view information associated with a facility, a capacity associated with one or more facilities, position reports associated with one or more facilities, and scenarios for production schedule optimization associated with one or more facilities In some cases, the scenarios may represent “what if” scenarios that are defined when one or more users change constraints, capacities, demand priorities, or other parameters associated with one or more facilities in order to generate new optimal schedules for those scenarios. The controls 2002 also allow one or more users to view master data associated with one or more facilities, make inventory adjustments associated with one or more facilities, view errors associated with one or more facilities, and control settings of the framework itself.

In this example, a user has elected to view information associated with a facility, and a control 2004 (such as a drop-down menu or text search box) can be used to select a specific facility. Additional controls 2006 allow the user to access various contents related to different aspects of production schedule optimization for the selected facility. In this particular example, the controls 2006 allow the user to choose to view information about a master plan and schedule for the selected facility, inventory for the selected facility, one or more production schedule optimization scenarios that have been defined for the selected facility, and a configuration for the selected facility. General information 2008 is also provided for the selected facility, such as the current end date of the master schedule being used by the facility, an update date for the master schedule, a user who last updated the master schedule, and a status of the master schedule. A control 2010 allows the user to invoke creation of a new production schedule scenario for the facility. Controls 2012 allow the user to view various information about the selected facility, such as the current production schedule, alerts, transactions, overview, history, and parameters of the selected facility

In this example, the user has elected to view the current production schedule of the selected facility, and the graphical user interface 2000 provides a detailed production schedule 2014. In this particular example, the detailed production schedule 2014 includes various rows of production indicators 2016, where each row can be associated with a processing unit or a group of processing units. Each production indicator 2016 can identify one or more operations to be performed using the associated processing unit or group of processing units In some cases, the production indicators 2016 may be color-coded or otherwise marked to identify the types of products to be input to or output from the processing units associated with the production indicators 2016 Also, in some cases, each production indicator 2016 can have a unique identifier, and each production indicator 2016 may be selectable to view more-specific information about the one or more operations to be performed using the associated processing unit or group of processing units.

A legend 2018 can identify time periods associated with the production indicators 2016, and a control 2020 can be used to scroll through the current production schedule backwards and forwards in time Controls 2022 can be used to edit various aspects of the production schedule, such as when the controls 2022 can be used to add/modify/delete orders, edit recipes, move orders, and extend or find future open slots when operations can be scheduled. An alert section 2024 can be used to present and manage any alerts or other notifications associated with the production schedule, such as when the alert section 2024 identifies constraints that are violated using the production schedule. In some cases, the alert section 2024 can be used by the user to manage item-level alerts for unfilled demand. Also, in some cases, explainable alerts can be provided here, where the explainable alerts can provide detailed information identifying why the alerts were generated. One example of this is described below.

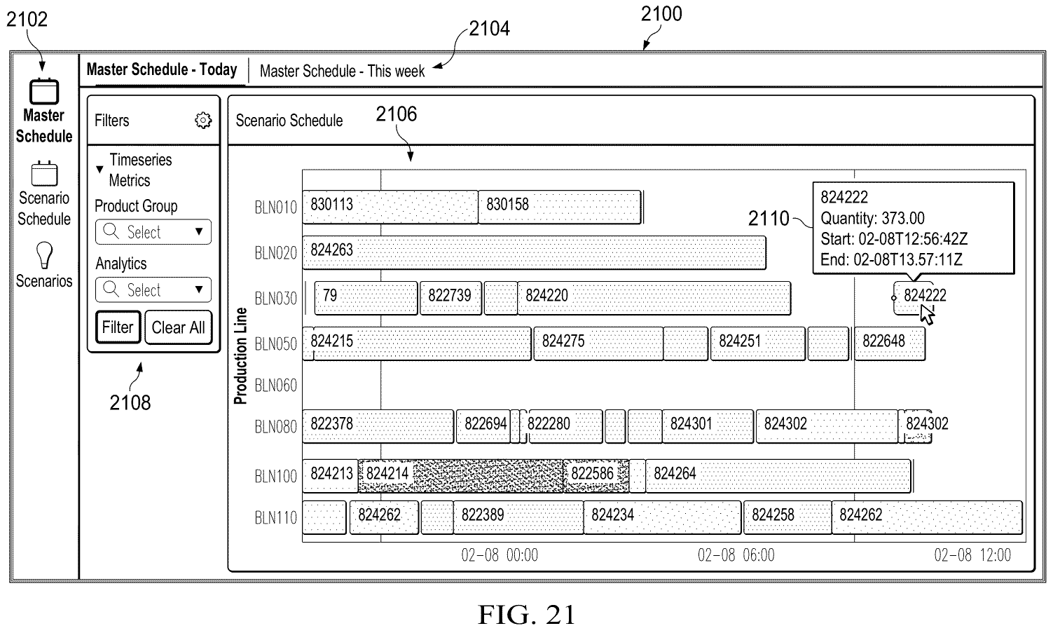

If the user elects to define and manage scenarios (such as via the appropriate control 2002), a graphical user interface 2100 as shown in FIG. 21 may be presented. In this example, the graphical user interface 2100 includes controls 2102 for invoking various functions related to the scenarios, such as viewing a current master schedule being used by a facility, viewing one or more simulated scenarios that have been defined, and creating one or more additional scenarios. Here, the user has elected to view the current master schedule, and controls 2104 allow the user to view the current master schedule for the current day or some future time period. A production schedule 2106 defined by the current master schedule is presented in the graphical user interface 2100, along with controls 2108 that allow the user to filter the production schedule 2106 (such as by data type or product group). If the user selects any particular indicator in the production schedule 2106, a pop-up display 2110 may provide information about the one or more operations associated with the indicator (such as a quantity of product to be produced and start/end times) The same type of pop-up display 2110 may be supported in the graphical user interface 2000 described above.

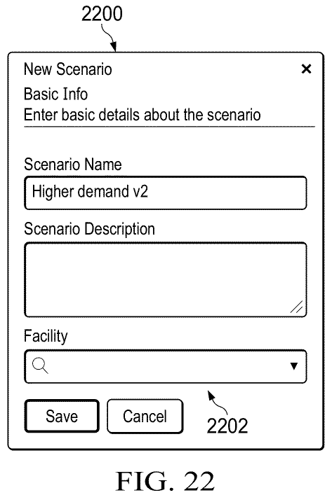

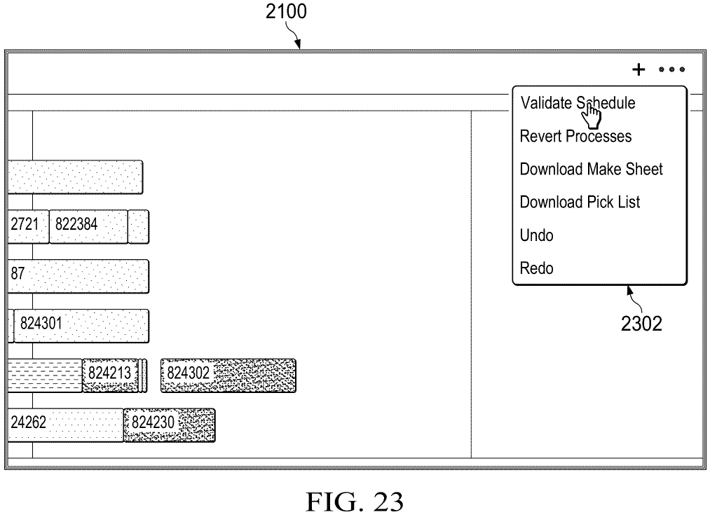

If the user elects to define a new scenario (such as via selection of the control 2010), a graphical user interface 2200 as shown in FIG. 22 may be presented. In this example, the graphical user interface 2200 includes various controls 2202 for receiving input from the user, such as text boxes for receiving general details, a name, and a description of the scenario and a drop-down menu for selecting a facility associated with the scenario. Once defined, the user may be able to modify various parameters associated with the scenario, such as product demand, labor capacity, material inventory, etc. At any appropriate time, the user can trigger production schedule optimization in order to create, for example, a production schedule 2106 for the defined scenario. As shown in FIG. 23, the graphical user interface 2100 may also include various controls 2302 for invoking functions like schedule validation, reversion to a prior schedule, undoing or redoing changes, and downloading various information. If selected, the schedule validation function can analyze optimization constraints and generate alerts if the constraints are not satisfied. For instance, if the user manually increases a production quantity of a finished good but raw material inventory is not sufficient for that quantity, the schedule validation can identify the constraint violation . In some cases, this can be done in real-time so that users can be notified of any issues. Among other things, this may help to guide users when modifications are made to optimized production schedules when defining scenarios so that the users can understand why certain modifications were not made

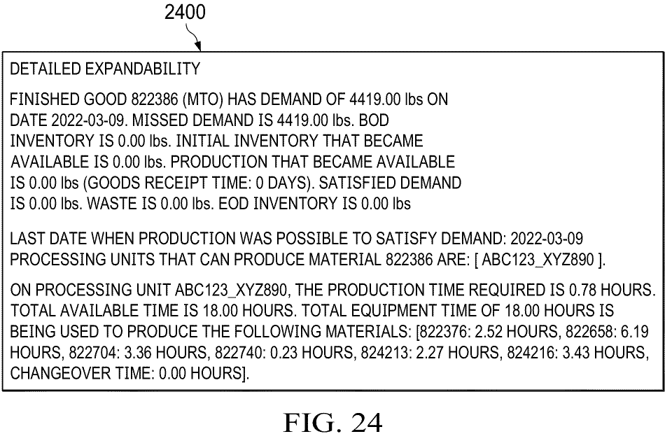

In some embodiments, when an alert is presented in the graphical user interface 2000, the alert may be selected in order to view an explanation 2400 as shown in FIG. 24, where the explanation 2400 may be provided in a pop-up window or other suitable manner. As can be seen here, the explanation 2400 may provide information as to why a particular alert has been generated. In this example, the alert indicates that some demand cannot be satisfied because a particular processing unit is not available, since that particular processing unit is currently scheduled to produce other products. Providing this type of explanation can help users understand, for example, why a proposed scenario might not be the optimal scenario. In this way, explanations 2400 can be presented that provide reasons why an optimizer made certain decisions, such as explanations 2400 related to missed demands, waste, overtime, etc. This can help to add transparency to the optimizer and make the overall framework more trustworthy from the perspective of users.

Note that the graphical user interfaces described above may support a wide variety of features and functions depending on the implementation. For example, when a production schedule is shown, users may be given the option to view and edit fourteen-day schedules or other schedules generated by an optimizer. In some cases, users may be able to view the schedules at the product code level for each production line. Users may also view historical key performance indicators (KPIs) for things like sales, shipments, inventory levels, planned production, and actual production, and users may view planned or estimated KPIs based on the latest master schedule to be approved for use Users may be able to zoom in and zoom out of the production schedule in order to view the production schedule over various time horizons, such as over a period of several minutes to several days. Users may be allowed to edit the production schedule by adding, deleting, shifting, expanding, reducing, locking, and unlocking processing units and reverting to an original or previous schedule generated by the optimizer. Users may be able to view the impacts of changes on planned KPIs, possibly in near-real-time as the users make changes to a schedule. Users may be able to review fill rates at risk and resource utilizations based on a planned production schedule Users may be able to view downgrades made by the optimizer, view changeovers required between product codes for a scenario generated by the optimizer, and view errors and warnings for changes to a scenario that fail to meet soft and hard constraints.

When a scenario schedule is shown, users may be given the option to generate a scenario schedule with adjustable demands (such as at the product code and day levels), adjust capacity (such as at a production line level for run rate and hours of production), adjust an objective function to modify costs of production or missing demands, and adjust working days. Users may be able to edit a scenario schedule and compare the scenario schedule and a master schedule, and users may be able to promote the scenario schedule to the master schedule (meaning the master schedule is replaced with the scenario schedule). Users may be able to initiate exporting of data related to the master schedule or a scenario schedule, such as makesheets and product pick lists.

Although FIGS. 20 through 24 illustrate examples of graphical user interfaces associated with an RTN-based templated PSO framework, various changes may be made to FIGS. 20 through 24. For example, the content, layout, and arrangement of each graphical user interface can easily vary from those shown here. Graphical user interfaces can come in a wide variety of designs and configurations, and FIGS. 20 through 24 do not limit the scope of this disclosure to any particular graphical user interfaces.

It should be noted that the functions shown in or described with respect to FIGS. 1 through 24 can be implemented in at least one application server 106, user device 102a-102d, device 200, or other device(s) in any suitable manner For example, in some embodiments, at least some of the functions shown in or described with respect to FIGS. 1 through 24 can be implemented or supported using one or more software applications or other software instructions that are executed by one or more processing devices 202 In other embodiments, at least some of the functions shown in or described with respect to FIGS. 1 through 24 can be implemented or supported using dedicated hardware components. In general, the functions shown in or described with respect to FIGS. 1 through 24 can be performed using any suitable hardware or any suitable combination of hardware and software/firmware instructions. Also, the functions shown in or described with respect to FIGS. 1 through 24 can be performed using a single device or any suitable combination of devices.

### Example Method

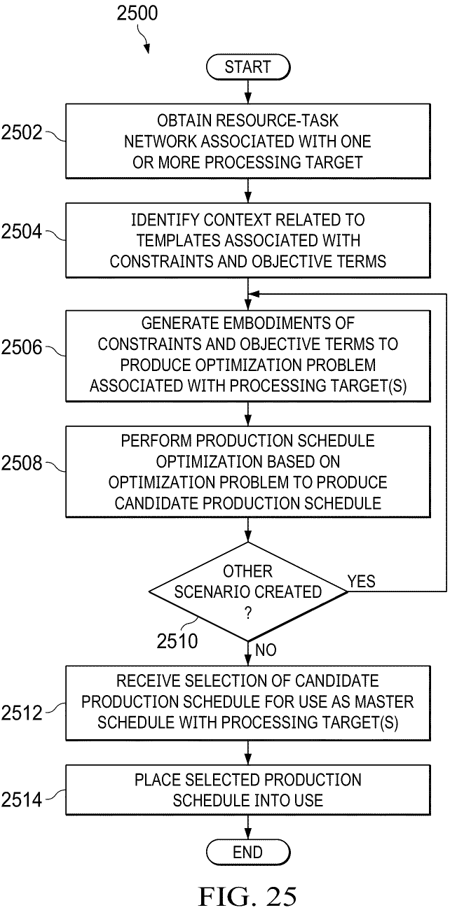

FIG. 25 illustrates an example method 2500 for production schedule optimization using an RTN-based templated PSO framework according to this disclosure. The method 2500 may, for example, be performed using the one or more applications 112 and/or the architecture 1800 described above. However, the method 2500 may be performed using any suitable device(s) and in any suitable system(s).

As shown in FIG. 25, a resource-task network associated with one or more processing targets is obtained at step 2502. This may include, for example, the processing device 202 of the application server 106 generating a resource-task network based on information defining the processing units and other characteristics of one or more plants (or one or more portions thereof). This may alternatively include the processing device 202 of the application server 106 obtaining the resource-task network from another source. The phrase “processing target” here generally refers to any collection of processing or other equipment or other assets that can be used to implement a production schedule. As examples, one or more processing targets may include a single manufacturing or processing plant, a portion of a single manufacturing or processing plant, a collection of multiple manufacturing or processing plants, or portions of multiple manufacturing or processing plants.

Context related to templates associated with constraints and terms of at least one objective function associated with at least a portion of the one or more processing targets is identified at step 2504. This may include, for example, the processing device 202 of the application server 106 identifying various contextual information associated with constraint templates 406 and objective templates 412. The contextual information may include information such as formulation math configuration preferences, such as whether one or more constraints or objective terms should be implemented using linear, quadratic, piecewise-linear, bilinear, or other versions or whether continuous, discretized, or other formulations should be used. The contextual information may also include information identifying facility characteristics of one or more plants or portions thereof. The contextual information may further include information identifying a domain configuration, such as any domain-specific information that can control or affect how constraints and objectives are formulated. As a specific example, waste may need to be considered in one or more embodiments of one or more material balance constraint templates for the food processing industry, but waste may not need to be considered for the chemical industry. The context may be identified here in any suitable manner, such as based on user input or stored data.

Embodiments of the constraints and terms are generated to produce an optimization problem associated with at least the portion of the one or more processing targets at step 2506. This may include, for example, the processing device 202 of the application server 106 generating embodiments 408 of the constraint templates 406 and embodiments 414 of the objective templates 412. For instance, the mapping process from templates to embodiments could be accomplished using a variety of techniques, such as by using dictionary look-ups or a machine learning classification model. In some cases, a user may fill in portions of at least one of the templates, and dependency management can be used to automatically fill in other portions of the at least one template based on the information provided by the user. Also, in some cases, conflict detection can be used to identify variables or other parameters of different constraints that might conflict, and dependency reconciliation can be performed to reconcile the constraints. As particular examples, the techniques described above with respect to FIGS. 5, 6, and 7 may be used to create suitable constraints and objective terms

Production schedule optimization is performed based on the optimization problem to produce a potential production schedule at step 2508. This may include, for example, the processing device 202 of the application server 106 using an optimizer to identify a solution to the optimization problem defined above, where the solution represents a candidate production schedule for the one or more processing targets. In some cases, the processing device 202 of the application server 106 may use the two-stage process described above to identify an overall production schedule within a planning horizon and identify a production schedule for each day or other timestep within a scheduling horizon based on the overall production schedule.

A determination is made whether an additional scenario is to be created at step 2510. This may include, for example, the processing device 202 of the application server 106 determining whether a user has requested creation of a new scenario with one or more modified constraints, objective terms, or other parameters If so, the process can return to step 2506 to generate another solution to another optimization problem, where the other solution represents another candidate production schedule for the one or more processing targets.

At some point, the candidate production schedule (or one of the candidate production schedules) can be selected for use as a master schedule at step 2512 and placed into use at step 2514. This may include, for example, the processing device 202 of the application server 106 receiving a user selection of a candidate production schedule for use as the master schedule with the one or more processing targets. The selected production schedule may be used as the master schedule until the selected production schedule has run its course or been replaced by another production schedule In some cases, this may also include the processing device 202 of the application server 106 using the selected production schedule to actually control processing units and other components in the one or more processing targets.

Note that it may be assumed above that the optimization problem is associated with the resource-task network However, as described earlier, it may be possible to divide the resource-task network into multiple sub-networks. In that case, steps 2504-2514 may be performed for each sub-network of the resource-task network In some embodiments, optimization problems associated with different sub-networks can be solved separately. In other embodiments, optimization problems associated with different sub-networks can be combined and solved collectively.

Although FIG. 25 illustrates one example of a method 2500 for production schedule optimization using an RTN-based templated PSO framework, various changes may be made to FIG. 25. For example, while shown as a series of steps, various steps in FIG. 25 may overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
using templates to identify constraints and terms of at least one objective function associated with at least a portion of one or more processing targets, wherein at least one of the templates is based on a resource-task network (RTN) representation of resource nodes and task nodes associated with at least the portion of the one or more processing targets;
generating one or more optimization problems, wherein the constraints and the at least one objective function represent at least part of the one or more optimization problems; and
generating at least one candidate production schedule for at least the portion of the one or more processing targets using the one or more optimization problems.

2. The method of claim 1, wherein:
one or more of the templates used to identify one or more of the constraints include at least one of: a material balance constraint template, an energy balance constraint template, a resource constraint template, a status balance constraint template, and a time balance constraint template; and
one or more of the templates used to identify one or more of the terms of the at least one objective function include at least one of: a revenue template, a cost template, a customer satisfaction template, a risk template, an intangible asset template, and an environmental footprint template.

3. The method of claim 1, further comprising:
using information provided for at least one portion of at least one of the templates to automatically add information to at least one other portion of the at least one template based on one or more dependencies associated with the at least one template.

4. The method of claim 1, further comprising:
using dependencies associated with the templates to identify one or more conflicts associated with two or more of the constraints or terms; and
reconciling the one or more conflicts.

5. The method of claim 4, wherein:
using the dependencies associated with the templates comprises using a dependency graph associated with multiple hierarchically-arranged templates, the dependency graph identifying relationships between the hierarchically-arranged templates and dependency information for each of the hierarchically-arranged templates, and
reconciling the one or more conflicts comprises reconciling the one or more conflicts based on dependencies of the constraints and terms and their associated variables of the hierarchically-arranged templates on input data to ensure that the constraints, terms, and associated variables are consistent.

6. The method of claim 1, further comprising:
performing automatic dependency building using a dependency graph associated with multiple hierarchically-arranged templates, the dependency graph identifying relationships between the hierarchically-arranged templates and dependency information for each of the hierarchically-arranged templates, the automatic dependency building introducing dependencies into the generation of the one or more optimization problems.

7. The method of claim 1, further comprising:
decomposing the RTN representation into multiple sub-networks, each sub-network associated with a subset of the resource and task nodes;
wherein using the templates comprises using the templates to identify one or more constraints and terms of an objective function for each sub-network.

8. The method of claim 7, wherein decomposing the RTN representation into the multiple sub-networks comprises using at least one of: graph-based decomposition, time-based decomposition, space-based decomposition, or business-rule-based decomposition.

9. The method of claim 7, wherein generating the at least one candidate production schedule comprises one of:
generating candidate production schedules associated with different optimization problems and combining the candidate production schedules into a combined candidate production schedule, each sub-network associated with one of the optimization problems; or
combining the objective functions for the sub-networks to produce a combined optimization problem and generating a candidate production schedule using the combined optimization problem.

10. The method of claim 1, wherein different ones of the templates are associated with different types of processing units in the one or more processing targets.

11. The method of claim 1, wherein at least one of the templates is used multiple times to generate multiple embodiments of a common constraint or term.

12. The method of claim 1, further comprising:
decomposing the RTN representation into multiple sub-networks, each sub-network associated with a subset of the resource and task nodes; and
using different embodiments of a single template for a constraint for different ones of the sub-networks.

13. The method of claim 12, wherein the different embodiments of the single template for the constraint comprise (i) a nonlinear constraint used for at least one of the sub-networks and (ii) a simplified linear version of the nonlinear constraint used for at least one other of the sub-networks.

14. The method of claim 12, wherein the different embodiments of the single template are used in one of:
a single optimization problem; or
multiple optimization problems associated with different ones of the embodiments of the single template.

15. The method of claim 12, wherein:
generating the at least one candidate production schedule comprises generating multiple candidate production schedules associated with the multiple sub-networks; and
the method further comprises iteratively reconciling the candidate production schedules to generate a final production schedule.

16. The method of claim 1, wherein:
the RTN representation is associated with multiple interconnected processing targets;
at least one optimization problem and at least one candidate production schedule are generated for each of the processing targets; and
the method further comprises iteratively reconciling the candidate production schedules for the processing targets to generate a final production schedule for the processing targets.

17. The method of claim 1, wherein the RTN representation is scalable and able to represent processing units in at least a portion of a single processing target up to processing units in multiple interconnected processing targets.

18. The method of claim 1, wherein the templates are configured to define constraints and terms of objective functions for processing targets in multiple industries and across different scales within processing targets.

19. The method of claim 1, wherein the one or more processing targets comprise one or more manufacturing or processing plants.

20. An apparatus comprising:
at least one processing device configured to:
use templates to identify constraints and terms of at least one objective function associated with at least a portion of one or more processing targets, wherein at least one of the templates is based on a resource-task network (RTN) representation of resource nodes and task nodes associated with at least the portion of the one or more processing targets;
generate one or more optimization problems, wherein the constraints and the at least one objective function represent at least part of the one or more optimization problems; and
generate at least one candidate production schedule for at least the portion of the one or more processing targets using the one or more optimization problems.

21. The apparatus of claim 20, wherein:
one or more of the templates used to identify one or more of the constraints include at least one of: a material balance constraint template, an energy balance constraint template, a resource constraint template, a status balance constraint template, and a time balance constraint template; and
one or more of the templates used to identify one or more of the terms of the at least one objective function include at least one of: a revenue template, a cost template, a customer satisfaction template, a risk template, an intangible asset template, and an environmental footprint template.

22. The apparatus of claim 20, wherein the at least one processing device is further configured to use information provided for at least one portion of at least one of the templates to automatically add information to at least one other portion of the at least one template based on one or more dependencies associated with the at least one template.

23. The apparatus of claim 20, wherein the at least one processing device is further configured to:
use dependencies associated with the templates to identify one or more conflicts associated with two or more of the constraints or terms; and
reconcile the one or more conflicts.

24. The apparatus of claim 23, wherein:
to use the dependencies associated with the templates, the at least one processing device is configured to use a dependency graph associated with multiple hierarchically-arranged templates, the dependency graph identifying relationships between the hierarchically-arranged templates and dependency information for each of the hierarchically-arranged templates; and
to reconcile the one or more conflicts, the at least one processing device is configured to reconcile the one or more conflicts based on dependencies of the constraints and terms and their associated variables of the hierarchically-arranged templates on input data to ensure that the constraints, terms, and associated variables are consistent.

25. The apparatus of claim 20, wherein the at least one processing device is further configured to perform automatic dependency building using a dependency graph associated with multiple hierarchically-arranged templates, the dependency graph identifying relationships between the hierarchically-arranged templates and dependency information for each of the hierarchically-arranged templates, the automatic dependency building introducing dependencies into the generation of the one or more optimization problems.

26. The apparatus of claim 20, wherein:
the at least one processing device is further configured to decompose the RTN representation into multiple sub-networks, each sub-network associated with a subset of the resource and task nodes; and
the at least one processing device is configured to use the templates to identify one or more constraints and terms of an objective function for each sub-network.

27. The apparatus of claim 26, wherein, to decompose the RTN representation into the multiple sub-networks, the at least one processing device is configured to use at least one of: graph-based decomposition, time-based decomposition, space-based decomposition, or business-rule-based decomposition.

28. The apparatus of claim 26, wherein, to generate the at least one candidate production schedule, the at least one processing device is configured to one of:
generate candidate production schedules associated with different optimization problems and combine the candidate production schedules into a combined candidate production schedule, each sub-network associated with one of the optimization problems; or
combine the objective functions for the sub-networks to produce a combined optimization problem and generate a candidate production schedule using the combined optimization problem.

29. The apparatus of claim 20, wherein different ones of the templates are associated with different types of processing units in the one or more processing targets.

30. The apparatus of claim 20, wherein the at least one processing device is configured to use at least one of the templates multiple times to generate multiple embodiments of a common constraint or term.

31. The apparatus of claim 20, wherein the at least one processing device is further configured to:
decompose the RTN representation into multiple sub-networks, each sub-network associated with a subset of the resource and task nodes; and
use different embodiments of a single template for a constraint for different ones of the sub-networks.

32. The apparatus of claim 31, wherein the different embodiments of the single template for the constraint comprise (i) a nonlinear constraint used for at least one of the sub-networks and (ii) a simplified linear version of the nonlinear constraint used for at least one other of the sub-networks.

33. The apparatus of claim 31, wherein the at least one processing device is configured to use the different embodiments of the single template in one of:
a single optimization problem; or
multiple optimization problems associated with different ones of the embodiments of the single template.

34. The apparatus of claim 31, wherein:
the at least one processing device is configured to generate multiple candidate production schedules associated with the multiple sub-networks; and
the at least one processing device is further configured to iteratively reconcile the candidate production schedules to generate a final production schedule.

35. The apparatus of claim 20, wherein:
the RTN representation is associated with multiple interconnected processing targets;
the at least one processing device is configured to generate at least one optimization problem and at least one candidate production schedule for each of the processing targets; and
the at least one processing device is further configured to iteratively reconcile the candidate production schedules for the processing targets to generate a final production schedule for the processing targets.

36. The apparatus of claim 20, wherein the RTN representation is scalable and able to represent processing units in at least a portion of a single processing target up to processing units in multiple interconnected processing targets.

37. The apparatus of claim 20, wherein the templates are configured to define constraints and terms of objective functions for processing targets in multiple industries and across different scales within processing targets.

38. The apparatus of claim 20, wherein the one or more processing targets comprise one or more manufacturing or processing plants.

39. A non-transitory computer readable medium storing computer readable program code that, when executed by one or more processors, causes the one or more processors to:
use templates to identify constraints and terms of at least one objective function associated with at least a portion of one or more processing targets, wherein at least one of the templates is based on a resource-task network (RTN) representation of resource nodes and task nodes associated with at least the portion of the one or more processing targets;
generate one or more optimization problems, wherein the constraints and the at least one objective function represent at least part of the one or more optimization problems; and
generate at least one candidate production schedule for at least the portion of the one or more processing targets using the one or more optimization problems.

40. The non-transitory computer readable medium of claim 39, wherein:
one or more of the templates used to identify one or more of the constraints include at least one of: a material balance constraint template, an energy balance constraint template, a resource constraint template, a status balance constraint template, and a time balance constraint template; and
one or more of the templates used to identify one or more of the terms of the at least one objective function include at least one of: a revenue template, a cost template, a customer satisfaction template, a risk template, an intangible asset template, and an environmental footprint template.

41. The non-transitory computer readable medium of claim 39, further storing computer readable program code that, when executed by the one or more processors, causes the one or more processors to:
use information provided for at least one portion of at least one of the templates to automatically add information to at least one other portion of the at least one template based on one or more dependencies associated with the at least one template.

42. The non-transitory computer readable medium of claim 39, further storing computer readable program code that, when executed by the one or more processors, causes the one or more processors to:
use dependencies associated with the templates to identify one or more conflicts associated with two or more of the constraints or terms; and
reconcile the one or more conflicts.

43. The non-transitory computer readable medium of claim 42, wherein:
the computer readable program code that when executed causes the one or more processors to use the dependencies associated with the templates comprises:
computer readable program code that when executed causes the one or more processors to use a dependency graph associated with multiple hierarchically-arranged templates, the dependency graph identifying relationships between the hierarchically-arranged templates and dependency information for each of the hierarchically-arranged templates; and
the computer readable program code that when executed causes the one or more processors to reconcile the one or more conflicts comprises:
computer readable program code that when executed causes the one or more processors to reconcile the one or more conflicts based on dependencies of the constraints and terms and their associated variables of the hierarchically-arranged templates on input data to ensure that the constraints, terms, and associated variables are consistent.

44. The non-transitory computer readable medium of claim 39, further storing computer readable program code that, when executed by the one or more processors, causes the one or more processors to:
perform automatic dependency building using a dependency graph associated with multiple hierarchically-arranged templates, the dependency graph identifying relationships between the hierarchically-arranged templates and dependency information for each of the hierarchically-arranged templates, the automatic dependency building introducing dependencies into the generation of the one or more optimization problems.

45. The non-transitory computer readable medium of claim 39, further storing computer readable program code that, when executed by the one or more processors, causes the one or more processors to:
decompose the RTN representation into multiple sub-networks, each sub-network associated with a subset of the resource and task nodes;
wherein the computer readable program code when executed causes the one or more processors to use the templates to identify one or more constraints and terms of an objective function for each sub-network.

46. The non-transitory computer readable medium of claim 45, wherein the computer readable program code that when executed causes the one or more processors to decompose the RTN representation into the multiple sub-networks comprises:
computer readable program code that when executed causes the one or more processors to use at least one of: graph-based decomposition, time-based decomposition, space-based decomposition, or business-rule-based decomposition.

47. The non-transitory computer readable medium of claim 45, wherein the computer readable program code that when executed causes the one or more processors to generate the at least one candidate production schedule comprises:
computer readable program code that when executed causes the one or more processors to one of:
generate candidate production schedules associated with different optimization problems and combine the candidate production schedules into a combined candidate production schedule, each sub-network associated with one of the optimization problems; or
combine the objective functions for the sub-networks to produce a combined optimization problem and generate a candidate production schedule using the combined optimization problem.

48. The non-transitory computer readable medium of claim 39, wherein different ones of the templates are associated with different types of processing units in the one or more processing targets.

49. The non-transitory computer readable medium of claim 39, wherein the computer readable program code when executed causes the one or more processors to use at least one of the templates multiple times to generate multiple embodiments of a common constraint or term.

50. The non-transitory computer readable medium of claim 39, further storing computer readable program code that, when executed by the one or more processors, causes the one or more processors to:
decompose the RTN representation into multiple sub-networks, each sub-network associated with a subset of the resource and task nodes; and
use different embodiments of a single template for a constraint for different ones of the sub-networks.

51. The non-transitory computer readable medium of claim 50, wherein the different embodiments of the single template for the constraint comprise (i) a nonlinear constraint used for at least one of the sub-networks and (ii) a simplified linear version of the nonlinear constraint used for at least one other of the sub-networks.

52. The non-transitory computer readable medium of claim 50, wherein the computer readable program code when executed causes the one or more processors to use the different embodiments of the single template in one of:
a single optimization problem; or
multiple optimization problems associated with different ones of the embodiments of the single template.

53. The non-transitory computer readable medium of claim 50, wherein:
the computer readable program code when executed causes the one or more processors to generate multiple candidate production schedules associated with the multiple sub-networks; and
the non-transitory computer readable medium further stores computer readable program code that, when executed by the one or more processors, causes the one or more processors to iteratively reconcile the candidate production schedules to generate a final production schedule.

54. The non-transitory computer readable medium of claim 39, wherein:
the RTN representation is associated with multiple interconnected processing targets;
the computer readable program code when executed causes the one or more processors to generate at least one optimization problem and at least one candidate production schedule for each of the processing targets; and
the non-transitory computer readable medium further stores computer readable program code that, when executed by the one or more processors, causes the one or more processors to iteratively reconcile the candidate production schedules for the processing targets to generate a final production schedule for the processing targets.

55. The non-transitory computer readable medium of claim 39, wherein the RTN representation is scalable and able to represent processing units in at least a portion of a single processing target up to processing units in multiple interconnected processing targets.

56. The non-transitory computer readable medium of claim 39, wherein the templates are configured to define constraints and terms of objective functions for processing targets in multiple industries and across different scales within processing targets.

57. The non-transitory computer readable medium of claim 39, wherein the one or more processing targets comprise one or more manufacturing or processing plants.
